(19) United States
(12) Patent Application Publication
(10) Pub. No.: US 2008/0106355 A1
(43) Pub. Date: May 8, 2008

(54) REFLECTION-TYPE BANDPASS FILTER

(75) Inventor: Ning GUAN, Sakura-shi (JP)

Correspondence Address: SUGHRUE MION, PLLC, 2100 PENNSYLVANIA AVENUE, N.W., SUITE 800, WASHINGTON, DC, 20037, US

(73) Assignee: Fujikura Ltd., Tokyo (JP)

(21) Appl. No.: 11/867,440

(22) Filed: Oct. 4, 2007

(30) Foreign Application Priority Data
Oct. 5, 2006 (JP) 2006-274322
Nov. 29, 2006 (JP) 2006-321596

(51) Int. Cl. H01P 1/203

(52) U.S. Cl. 333/204

(57) ABSTRACT

A reflection-type bandpass filter for ultra-wideband (UWB) radio data communications is provided. The reflection-type bandpass filter includes a substrate formed by laminating a conducting layer and a dielectric layer, and a microstrip line made of a conductor of a non-uniform width and provided on the dielectric layer. The width distribution of the microstrip line in the lengthwise direction is set such that the absolute value of the difference in reflectivity at the frequency f in the regions f<3.1 GHz and f>10.6 GHz and the reflectivity in the region 3.7 GHz≦f≦10.0 GHz is not less than 10 dB, and the variation of the group delay in the region 3.7 GHz≦f≦10.0 GHz is between −0.2 and 0.2 ns.

### CROSS-REFERENCE TO RELATED PATENT APPLICATIONS

The present application claims priority from Japanese Patent Application No. 2006-274322, filed Oct. 5, 2006, and Japanese Patent Application No. 2006-321596, filed Nov. 29, 2006, the contents of which are incorporated herein by reference.

### BACKGROUND OF THE INVENTION

1. Field of the Invention

Apparatuses consistent with the present invention relate to a reflection-type bandpass filter for use in ultra-wideband (UWB) radio data communications. By using this reflection-type bandpass filter for UWB, the spectrum mask established by the Federal Communications Commission (FCC) can be satisfied.

2. Description of the Related Art

The following documents describe the related art for the current invention:

[Document 1] U.S. Pat. No. 2,411,555 Specification

[Document 2] Japanese Unexamined Patent Application, First Publication No. S56-64501

[Document 3] Japanese Unexamined Patent Application, First Publication No. H9-172318

[Document 4] Japanese Unexamined Patent Application, First Publication No. H9-232820

[Document 5] Japanese Unexamined Patent Application, First Publication No. H10-65402

[Document 6] Japanese Unexamined Patent Application, First Publication No. H10-242746

[Document 7] Japanese Unexamined Patent Application, First Publication No. 2000-4108

[Document 8] Japanese Unexamined Patent Application, First Publication No. 2000-101301

[Document 9] Japanese Unexamined Patent Application, First Publication No. 2002-43810

[Document 10] A. V. Oppenheim and R. W. Schafer, “Discrete-time signal processing,” pp. 465-478, Prenticehall, 1998

[Document 11] G-B. Xiao, K. Yashiro, N, Guan, and S. Ohokawa, “An effective method for designing non-uniformly coupled transmission-line filters,” IEEE Trans. Microwave Theory tech., vol. 49, pp. 1027-1031, June 2001.

[Document 12] C-Y. Chen and C-Y. Hsu, “Design of a UWB low insertion loss bandpass filter with spurious response suppression,” Microwave J., pp. 112-116, February 2006

In bandpass filters of the related art, the stop band rejection (difference between the reflectivity in the pass band and reflectivity in the stop band) was not set at an adequately large value in the design stage. Thus, these filters may not satisfy the FCC regulations because of manufacturing errors and the like.

For example, if a microstrip line as in FIG. 1 having a distribution as shown in FIG. 2, which is a distribution in the lengthwise direction of width of a microstrip line is used (when substrate with thickness h=0.635 mm, relative dielectric constant ∈ᵣ=10.2 is used), as shown in FIG. 3, the absolute value of the difference between the reflectivity when the frequency f is in the region 3.4 GHz≦f≦10.3 GHz, and the reflectivity when f<3.1 GHz or f>10.6 GHz, that is, the stop band rejection, becomes 10 dB approximately. Therefore, because of a small manufacturing error, the stop band rejection may drop below 10 dB. Also, as shown in FIG. 4, the variation of the group delay frequency characteristics is large near the transition frequency.

In Document 12, a bandpass filter provided with a dual mode-type microstrip is reported as wide-band bandpass filter for UWB. However, the pass band of the bandpass filter disclosed in Document 12 is between 3 GHz and 5.5 GHz approximately. Compared to the band prescribed by the FCC, the pass band is narrow, and it does not cover the entire region of the UWB. The design method for the bandpass filter disclosed in Document 12 is complicated, and difficult to realize.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An object of the present invention is to offer a high-performance reflection-type bandpass filter for UWB satisfying the FCC regulations.

The first aspect of the present invention relates to a reflection-type bandpass filter for ultra-wideband radio data communications comprising a substrate formed by laminating a conducting layer and dielectric layer, and a microstrip line made of a conductor of non-uniform width and provided on the dielectric layer, wherein the distribution in the lengthwise direction of width of the microstrip line is set such that the absolute value of the difference in reflectivity at the frequency f in the region f<3.1 GHz and f>10.6 GHz and the reflectivity in the region 3.7 GHz≦f≦10.0 GHz becomes equal or greater than 10 dB, and the variation in the group delay in the region 3.7 GHz≦f≦10.0 GHz becomes within ±0.2 ns.

The second aspect of the present invention relates to a reflection-type bandpass filter for ultra-wideband radio data communications comprising a substrate formed by laminating a conducting layer and dielectric layer, and a microstrip line made of a conductor of non-uniform width and provided on the dielectric layer, wherein the distribution in the lengthwise direction of width of the microstrip line is set such that the absolute value of the difference in reflectivity at the frequency f in the region f<3.1 GHz and f>10.6 GHz and the reflectivity in the region 4.0 GHz≦f≦9.8 GHz becomes equal or greater than 10 dB, and the variation in the group delay in the region 4.0 GHz≦f≦9.8 GHz becomes within ±0.1 ns.

The third aspect of the present invention relates to a reflection-type bandpass filter for ultra-wideband radio data communications comprising a substrate formed by laminating a conducting layer and dielectric layer, and a microstrip line made of a conductor of non-uniform width and provided on the dielectric layer, wherein the distribution in the lengthwise direction of width of the microstrip line is set such that the absolute value of the difference in reflectivity at the frequency f in the region f<3.1 GHz and f>10.6 GHz and the reflectivity in the region 3.5 GHz≦f≦10.1 GHz becomes equal or greater than 10 dB, and the variation in the group delay in the region 3.5 GHz≦f≦10.1 GHz becomes within ±0.2 ns.

The fourth aspect of the present invention relates to a reflection-type bandpass filter for ultra-wideband radio data communications comprising a substrate formed by laminating a conducting layer and dielectric layer, and a microstrip line made of a conductor of non-uniform width and provided on the dielectric layer, wherein the distribution in the lengthwise direction of width of the microstrip line is set such that the absolute value of the difference in reflectivity at the frequency f in the region f<3.1 GHz and f>10.6 GHz and the reflectivity in the region 4.0 GHz≦f≦9.6 GHz becomes equal or greater than 10 dB, and the variation in the group delay in the region 4.0 GHz≦f≦9.6 GHz becomes within ±0.07 ns.

The fifth aspect of the present invention relates to a reflection-type bandpass filter for ultra-wideband radio data communications comprising a substrate formed by laminating a conducting layer and dielectric layer, and a microstrip line made of a conductor of non-uniform width and provided on the dielectric layer, wherein the distribution in the lengthwise direction of width of the microstrip line is set such that the absolute value of the difference in reflectivity at the frequency f in the region f<3.1 GHz and f>10.6 GHz and the reflectivity in the region 4.2 GHz≦f≦9.5 GHz becomes equal or greater than 10 dB, and the variation in the group delay in the region 4.2 GHz≦f≦9.5 GHz becomes within ±0.2 ns.

In the reflection-type bandpass filter of the first to fifth aspects of the present invention, the characteristic impedance Zc of the input terminal transmission line may be such that 10Ω≦Zc≦200Ω.

In the reflection-type bandpass filter of the first to fifth aspects of the present invention, a resistance having the same impedance as the characteristic impedance, or a non-reflecting terminator, may be provided on the terminating side.

In the reflection-type bandpass filter of the first to fifth aspects of the present invention, the conducting layer and the conductor of the microstrip line may be made of a metal plate of thickness equal or greater than the skin depth at f=1 GHz.

In the reflection-type bandpass filter of the first to fifth aspects of the present invention, the dielectric layer of the substrate may have a thickness h such that 0.5 mm≦h≦5 mm, a relative dielectric constant ∈ᵣ such that 1≦∈ᵣ≦200, a width W such that 2 mm≦W≦100 mm, and a length L such that 2 mm≦L≦300 mm.

In the reflection-type bandpass filter of the first to fifth aspects of the present invention, the lengthwise distribution of width of the microstrip line may be set using a design method based on inverse problem leading to potential from spectral data in the Zakharov-Shabat equation.

In the reflection-type bandpass filter of the first to fifth aspects of the present invention, the distribution in the lengthwise direction of width of the microstrip line may be set using a window function method.

In the reflection-type bandpass filter of the first to fifth aspects of the present invention, the distribution in the lengthwise direction of width of the microstrip line may be set using the Kaiser window function method.

The sixth aspect of the present invention relates to a reflection-type bandpass filter for ultra-wideband radio data communications comprising a substrate formed by laminating a conducting layer and dielectric layer, and a microstrip line made of a conductor of non-uniform width and provided on the dielectric layer, wherein the distribution in the lengthwise direction of width of the microstrip line is set such that the absolute value of the difference in reflectivity at the frequency f in the region f<3.1 GHz and f>10.6 GHz and the reflectivity in the region 3.4 GHz≦f≦10.3 GHz becomes equal or greater than 10 dB, and the variation in the group delay in the region 3.4 GHz≦f≦10.3 GHz becomes within ±0.2 ns, and the conducting layer and the microstrip line are made of copper foil of thickness equal or greater than 2.1 μm.

The seventh aspect of the present invention relates to a reflection-type bandpass filter for ultra-wideband radio data communications comprising a substrate formed by laminating a conducting layer and dielectric layer, and a microstrip line made of a conductor of non-uniform width and provided on the dielectric layer, wherein the distribution in the lengthwise direction of width of the microstrip line is set such that the absolute value of the difference in reflectivity at the frequency f in the region f<3.1 GHz and f>10.6 GHz and the reflectivity in the region 3.6 GHz≦f≦10.1 GHz becomes equal or greater than 10 dB, and the variation in the group delay in the region 3.6 GHz≦f≦10.1 GHz becomes within ±0.2 ns, and the conducting layer and the microstrip line are made of copper foil of thickness equal or greater than 2.1 μm.

The eighth aspect of the present invention relates to a reflection-type bandpass filter for ultra-wideband radio data communications comprising a substrate formed by laminating a conducting layer and dielectric layer, and a microstrip line made of a conductor of non-uniform width and provided on the dielectric layer, wherein the distribution in the lengthwise direction of width of the microstrip line is set such that the absolute value of the difference in reflectivity at the frequency f in the region f<3.1 GHz and f>10.6 GHz and the reflectivity in the region 4.0 GHz≦f≦9.7 GHz becomes equal or greater than 10 dB, and the variation in the group delay in the region 4.0 GHz≦f≦9.7 GHz becomes within ±0.2 ns, and the conducting layer and the microstrip line are made of copper foil of thickness equal or greater than 2.1 μm.

In the reflection-type bandpass filter of the sixth to eighth aspects of the present invention, the characteristic impedance Zc of the input terminal transmission line may be such that 10Ω≦Zc≦300Ω.

In the reflection-type bandpass filter of the sixth to eighth aspects of the present invention, a resistance having the same impedance as the characteristic impedance, or a non-reflecting terminator, may be provided on the terminating side.

In the reflection-type bandpass filter of the sixth to eighth aspects of the present invention, the dielectric layer of the substrate may have a thickness h such that 0.5 mm≦h≦10 mm, and relative dielectric constant ∈ᵣ such that 1≦∈ᵣ≦500.

According to the reflection-type bandpass filter of exemplary embodiments of the present invention, a bandpass filter for UWB satisfying the FCC regulations with a stop band rejection equal or greater than 10 dB and the variation of the group delay within ±0.2 ns can be offered.

Furthermore, according to the reflection-type bandpass filter of exemplary embodiments of the present invention, by applying the window function method and designing a bandpass filter that includes a non-uniform microstrip line, even if a manufacturing error occurs, a bandpass filter with larger stop band rejection and smaller variation of the group delay within the pass band compared to related art filters can be offered. Therefore, the allowable range of manufacturing errors of the bandpass filter can be set larger compared to that of the related art bandpass filter.

### BRIEF DESCRIPTION OF THE DRAWINGS

FIG. 1 is a perspective view showing the first embodiment of the reflection-type bandpass filter of the present invention.

FIG. 2 is a graph illustrating the width distribution of a microstrip line designed based on a related art design method.

FIG. 3 is a graph showing the amplitude characteristics of the reflective wave in the microstrip line shown in FIG. 2.

FIG. 4 is a graph showing the group delay frequency characteristics of the reflective wave in the microstrip line shown in FIG. 2.

FIG. 5 is an equivalent circuit diagram of a non-uniform transmission line.

FIG. 6 is a graph showing the distribution in the width direction of the microstrip line in the reflection-type bandpass filter of the first embodiment.

FIG. 7 is a graph showing the surface form of the microstrip line in the reflection-type bandpass filter of the first embodiment.

FIG. 8 is a graph showing the amplitude characteristics of the reflective wave in the reflection-type bandpass filter of the first embodiment.

FIG. 9 is a graph showing the group delay frequency characteristics of the reflective wave in the reflection-type bandpass filter of the first embodiment.

FIG. 10 is a graph showing the distribution in the width direction of the microstrip line in the reflection-type bandpass filter of the second embodiment.

FIG. 11 is a graph showing the surface form of the microstrip line in the reflection-type bandpass filter of the second embodiment.

FIG. 12 is a graph showing the amplitude characteristics of the reflective wave in the reflection-type bandpass filter of the second embodiment.

FIG. 13 is a graph showing the group delay frequency characteristics of the reflective wave in the reflection-type bandpass filter of the second embodiment.

FIG. 14 is a graph showing the distribution in the width direction of the microstrip line in the reflection-type bandpass filter of the third embodiment.

FIG. 15 is a graph showing the surface form of the microstrip line in the reflection-type bandpass filter of the third embodiment.

FIG. 16 is a graph showing the amplitude characteristics of the reflective wave in the reflection-type bandpass filter of the third embodiment.

FIG. 17 is a graph showing the group delay frequency characteristics of the reflective wave in the reflection-type bandpass filter of the third embodiment.

FIG. 18 is a graph showing the distribution in the width direction of the microstrip line in the reflection-type bandpass filter of the fourth embodiment.

FIG. 19 is a graph showing the surface form of the microstrip line in the reflection-type bandpass filter of the fourth embodiment.

FIG. 20 is a graph showing the amplitude characteristics of the reflective wave in the reflection-type bandpass filter of the fourth embodiment.

FIG. 21 is a graph showing the group delay frequency characteristics of the reflective wave in the reflection-type bandpass filter of the fourth embodiment.

FIG. 22 is a graph showing the distribution in the width direction of the microstrip line in the reflection-type bandpass filter of the fifth embodiment.

FIG. 23 is a graph showing the surface form of the microstrip line in the reflection-type bandpass filter of the fifth embodiment.

FIG. 24 is a graph showing the amplitude characteristics of the reflective wave in the reflection-type bandpass filter of the fifth embodiment.

FIG. 25 is a graph showing the group delay frequency characteristics of the reflective wave in the reflection-type bandpass filter of the fifth embodiment.

FIG. 26 is a graph showing the distribution in the width direction of the microstrip line in the reflection-type bandpass filter of the sixth embodiment.

FIG. 27 is a graph showing the surface form of the microstrip line in the reflection-type bandpass filter of the sixth embodiment.

FIG. 28 is a graph showing the amplitude characteristics of the reflective wave in the reflection-type bandpass filter of the sixth embodiment.

FIG. 29 is a graph showing the group delay frequency characteristics of the reflective wave in the reflection-type bandpass filter of the sixth embodiment.

FIG. 30 is a graph showing the distribution in the width direction of the microstrip line in the reflection-type bandpass filter of the seventh embodiment.

FIG. 31 is a graph showing the surface form of the microstrip line in the reflection-type bandpass filter of the seventh embodiment.

FIG. 32 is a graph showing the amplitude characteristics of the reflective wave in the reflection-type bandpass filter of the seventh embodiment.

FIG. 33 is a graph showing the group delay frequency characteristics of the reflective wave in the reflection-type bandpass filter of the seventh embodiment.

FIG. 34 is a graph showing the distribution in the width direction of the microstrip line in the reflection-type bandpass filter of the eighth embodiment.

FIG. 35 is a graph showing the surface form of the microstrip line in the reflection-type bandpass filter of the eighth embodiment.

FIG. 36 is a graph showing the amplitude characteristics of the reflective wave in the reflection-type bandpass filter of the eighth embodiment.

FIG. 37 is a graph showing the group delay frequency characteristics of the reflective wave in the reflection-type bandpass filter of the eighth embodiment.

FIG. 38 is a graph showing the distribution in the width direction of the microstrip line in the reflection-type bandpass filter of the ninth embodiment.

FIG. 39 is a graph showing the surface form of the microstrip line in the reflection-type bandpass filter of the ninth embodiment.

FIG. 40 is a graph showing the amplitude characteristics of the reflective wave in the reflection-type bandpass filter of the ninth embodiment.

FIG. 41 is a graph showing the group delay frequency characteristics of the reflective wave in the reflection-type bandpass filter of the ninth embodiment.

FIG. 42 is a graph showing the distribution in the width direction of the microstrip line in the reflection-type bandpass filter of the tenth embodiment.

FIG. 43 is a graph showing the surface form of the microstrip line in the reflection-type bandpass filter of the tenth embodiment.

FIG. 44 is a graph showing the amplitude characteristics of the reflective wave in the reflection-type bandpass filter of the tenth embodiment.

FIG. 45 is a graph showing the group delay frequency characteristics of the reflective wave in the reflection-type bandpass filter of the tenth embodiment.

### DETAILED DESCRIPTION OF EXEMPLARY EMBODIMENTS OF THE PRESENT INVENTION

Exemplary embodiments of the present invention are described here, referring to the drawings.

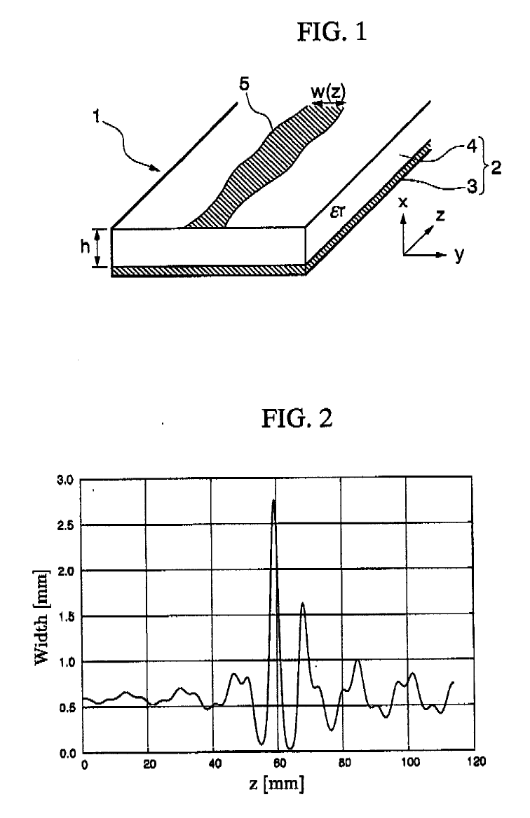

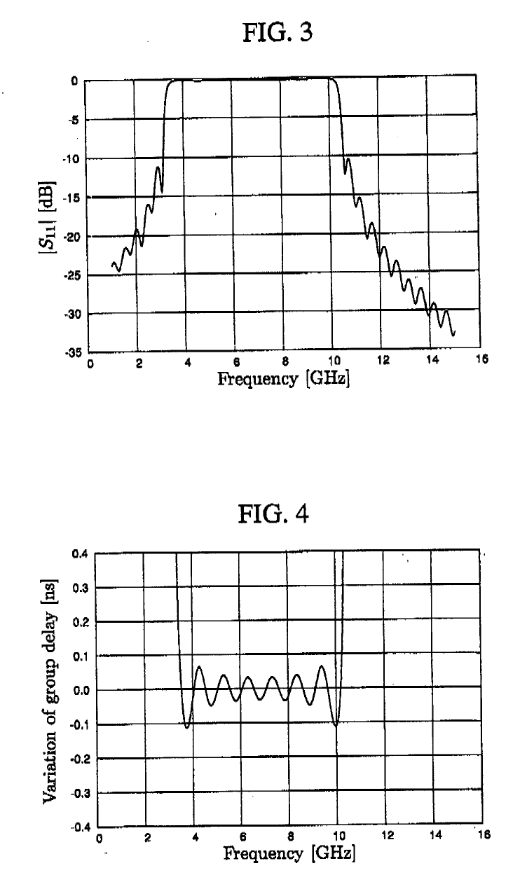

FIG. 1 is a perspective view showing the schematic configuration of the reflection-type bandpass filter of exemplary embodiments of the present invention. In the same figure, reference numeral 1 represents the reflection-type bandpass filter, 2 the substrate, 3 the conducting layer, 4 the dielectric layer, and 5 the microstrip line. Also, as shown in FIG. 1, the z axis is taken along the lengthwise direction of the microstrip line 5, the y-axis perpendicular to the z-axis and along a direction parallel to the surface of the substrate 2, and the x-axis perpendicular to both the y-axis and the z-axis. From the end face on the input side, the length along the z-axis direction is taken as z.

The reflection-type bandpass filter 1 has a substrate 2 laminated by a conducting layer 3 and dielectric layer 4, and a microstrip line 5 constituted by a conductor having non-uniform width and provided on the dielectric layer 4. The distribution in the lengthwise direction of width of the microstrip line 5 is set such that: (1) the absolute value of the difference in reflectivity at the frequency f in the region f<3.1 GHz and f>10.6 GHz and the reflectivity in the region 3.7 GHz≦f≦10.0 GHz becomes equal or greater than 10 dB, the variation of the group delay in the region 3.7 GHz≦f≦10.0 GHz becomes within ±0.2 ns; or (2) the absolute value of the difference in reflectivity at the frequency f in the region f<3.1 GHz and f>10.6 GHz and the reflectivity in the region 4.0 GHz≦f≦9.8 GHz becomes equal or greater than 10 dB, the variation of the group delay in the region 4.0 GHz≦f≦9.8 GHz becomes within ±0.1 ns; or (3) the absolute value of the difference in reflectivity at the frequency f in the region f<3.1 GHz and f>10.6 GHz and the reflectivity in the region 3.5 GHz≦f≦10.1 GHz becomes equal or greater than 10 dB, the variation of the group delay in the region 3.5 GHz≦f≦10.1 GHz becomes within ±0.2 ns; or (4) the absolute value of the difference in reflectivity at the frequency f in the region f<3.1 GHz and f>10.6 GHz and the reflectivity in the region 4.0 GHz≦f≦9.6 GHz becomes equal or greater than 10 dB, the variation of the group delay in the region 4.0 GHz≦f≦9.6 GHz becomes within ±0.07 ns; or (5) the absolute value of the difference in reflectivity at the frequency f in the region f<3.1 GHz and f>10.6 GHz and the reflectivity in the region 4.2 GHz≦f≦9.5 GHz becomes equal or greater than 10 dB, and the variation of the group delay in the region 4.2 GHz≦f≦9.5 GHz becomes within ±0.2 ns.

Also, the distribution in the lengthwise direction of width of the microstrip line 5 is set such that (1) the absolute value of the difference in reflectivity at the frequency f in the region f<3.1 GHz and f>10.6 GHz and the reflectivity in the region 3.4 GHz≦f≦10.3 GHz becomes equal or greater than 10 dB, the variation of the group delay in the region 3.4 GHz≦f≦10.3 GHz becomes within ±0.2 ns; or (2) the absolute value of the difference in reflectivity at the frequency f in the region f<3.1 GHz and f>10.6 GHz and the reflectivity in the region 3.6 GHz≦f≦10.1 GHz becomes equal or greater than 10 dB, the variation of the group delay in the region 3.6 GHz≦f≦10.1 GHz becomes within ±0.2 ns; or (3) the absolute value of the difference in reflectivity at the frequency f in the region f<3.1 GHz and f>10.6 GHz and the reflectivity in the region 4.0 GHz≦f≦9.7 GHz becomes equal or greater than 10 dB, the variation of the group delay in the region 4.0 GHz≦f≦9.7 GHz becomes within ±0.2 ns; and the conducting layer 3 and the microstrip line 5 are made of copper foil of thickness equal or greater than 2.1 μm.

The reflection-type bandpass filter of exemplary embodiments of the present invention is configured with increased stop band rejection by using the window function method (see Document 10) used in the design of digital filters. As a result, instead of an expansion in the transition frequency region (region between the boundaries of the pass band and the stop band), the stop band rejection can be increased. Therefore, manufacturing tolerances can be increased. The variation in the group delay frequency within the pass band will become small.

More specifically, an example of the implementation method is described below.

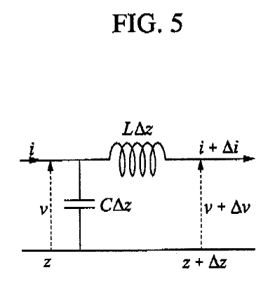

The transmission line of the reflection-type bandpass filter 1 of exemplary embodiments of the present invention can be expressed as a non-uniformly distributed parameter circuit, as shown in FIG. 5.

From FIG. 5, the following relational expression (1) can be obtained in terms of the line voltage v(z,t) and the line current i(z, t).

$$\{ \begin{matrix}- \frac{\partial u ( z , t )}{\partial z} = L ( z ) \frac{\partial i ( z , t )}{\partial t} , \\ - \frac{\partial i ( z , t )}{\partial z} = C ( z ) \frac{\partial u ( z , t )}{\partial t} .\end{matrix} \qquad [ Equation 1 ]$$

Here, L(z) and C(z) are the inductance and capacitance per unit length respectively in the transmission line. Here, the function of equation (2) is introduced.

$$\{ \begin{matrix}\frac{\partial {ϕ}_{1} ( z , t )}{\partial z} = - \frac{1}{c ( z )} \frac{\partial {ϕ}_{1} ( z , t )}{\partial t} - \frac{1}{2} \frac{ⅆ ln Z ( z )}{ⅆ z} {ϕ}_{2} ( z , t ) , \\ \frac{\partial {ϕ}_{2} ( z , t )}{\partial z} = \frac{1}{c ( z )} \frac{\partial {ϕ}_{2} ( z , t )}{\partial t} - \frac{1}{2} \frac{ⅆ ln Z ( z )}{ⅆ z} {ϕ}_{1} ( z , t ) .\end{matrix} \qquad [ Equation 2 ]$$

Here, Z(z)=√{L(z)/C(z)} is the local characteristic impedance, and φ₁, φ₂ are the power wave amplitudes propagating in the +z and −z directions respectively.

If these are substituted in equation 1, then the following equation (3) is obtained:

$$\{ \begin{matrix}\frac{\partial {ϕ}_{1} ( z , t )}{\partial z} = - \frac{1}{c ( z )} \frac{\partial {ϕ}_{1} ( z , t )}{\partial t} - \frac{1}{2} \frac{ⅆ ln Z ( z )}{ⅆ z} {ϕ}_{2} ( z , t ) , \\ \frac{\partial {ϕ}_{2} ( z , t )}{\partial z} = \frac{1}{c ( z )} \frac{\partial {ϕ}_{2} ( z , t )}{\partial t} - \frac{1}{2} \frac{ⅆ ln Z ( z )}{ⅆ z} {ϕ}_{1} ( z , t ) .\end{matrix} \qquad [ Equation 3 ]$$

Here, c(z)=1/√{L(z)/C(z)}. Here the time factor is taken as exp(jωt), and if variable transformation is performed as in the following equation (4), then the Zakharov-Shabat equation as shown in the equation (5) can be obtained.

$$x ( z ) = {\int }_{0}^{z} \frac{ds}{c ( s )} \qquad [ Equation 4 ]$$

$$\{ \begin{matrix}\frac{\partial {ϕ}_{1} ( x )}{\partial x} + {jωϕ}_{1} ( x ) = - q ( x ) {ϕ}_{2} ( x ) , \\ \frac{\partial {ϕ}_{2} ( x )}{\partial x} - {jωϕ}_{2} ( x ) = - q ( x ) {ϕ}_{1} ( x ) .\end{matrix} \qquad [ Equation 5 ]$$

Here, q(x) is as given by the following equation (6):

$$q ( x ) = \frac{1}{2} \frac{ⅆ ln Z ( x )}{ⅆ x} . \qquad [ Equation 6 ]$$

The inverse problem of Zakharov-Shabat is the synthesis of the potential q(x) from the spectral data of the solution satisfying the equation above (see Document 11). If the potential q(x) is determined, then the local characteristic impedance can be found from equation (7) below.

$$Z ( x ) = Z ( 0 ) exp [ 2 {\int }_{0}^{x} q ( s ) ⅆ s ] . \qquad [ Equation 7 ]$$

Here, generally in the process to determine the potential q(x), the reflection coefficient r(x) of x space is calculated from the spectral data reflection coefficient R(ω) using the following equation (8), and q(x) is obtained from r(x).

$$r ( x ) = \frac{1}{2 π} {\int }_{- ∞}^{∞} R ( ω ) {ⅇ}^{- jω x} ⅆ ω \qquad [ Equation 8 ]$$

In the present invention, instead of obtaining r(x) from R(ω) of the ideal spectral data, r′(x) is determined by multiplying with the window function, as given by the equation (9).
r′(x)=ω(x)r(x) [Equation 9]

Here, ω(x) is a window function. If the window function is correctly selected, the level of the stop band rejection can be appropriately controlled. The Kaiser window is used here as an example. The Kaiser window is defined as in the equation (10) below. (See Document 10).

$$w [ n ] = \{ \begin{matrix}\frac{{I}_{0} [ {β ( 1 - {[ ( n - α ) / α ]}^{2} )}^{1 / 2} ]}{{I}_{0} ( β )} , & 0 \leq n \leq M , \\ 0 , & otherwise\end{matrix} \qquad [ Equation 10 ]$$

Here α=M/2, and β is decided from experience as in equation (11) below.

$$β = \{ \begin{matrix}0.1102 ( A - 8.7 ) , & A > 50 , \\ 0.5842 {( A - 21 )}^{0.4} + 0.07886 ( A - 21 ) , & 21 \leq A \leq 50 , \\ 0 , & A < 21\end{matrix} \qquad [ Equation 11 ]$$

Here A=−20 log₁₀, δ expresses the peak approximation error in the pass band and in the stop band.

From the above, q(x) is determined, and the local characteristic impedance Z(x) is determined from equation (7). The local characteristic impedance and the width w of the microstrip line 5 are related to each other. The width w of the microstrip line 5 can be calculated from the value of the local characteristic impedance. By designing the microstrip line 5 according to the calculated width w of the microstrip line 5, a reflection-type bandpass filter having the desired pass band can be obtained.

Exemplary embodiments of the present invention are described below in further detail. Each of the exemplary embodiments described below is merely an illustrative example of the present invention, and the present invention is not limited to these embodiments.

### Embodiment 1

A Kaiser window was used for which the reflectivity is 1 at the frequency f in the region 3.4 GHz≦f≦10.3 GHz, and is 0 elsewhere, and for which A=30. Taking one wavelength at frequency f=1 GHz of the signal transmitted within the microstrip line as the waveguide length, the system characteristic impedance was taken as 50Ω, and the design was carried out. Here, the characteristic impedance should be set such that it coincides with the impedance of the system being used. Generally, in circuits that handle high frequency signals, the system impedance of 50Ω, 75Ω, 300Ω, or similar is used. The characteristic impedance Zc should preferably be in the following range: 10Ω≦Zc≦300Ω. If the characteristic impedance is less than 10Ω, the loss due to conductor or dielectric will become relatively high. If the characteristic impedance is greater than 300Ω, matching with the system impedance is not possible.

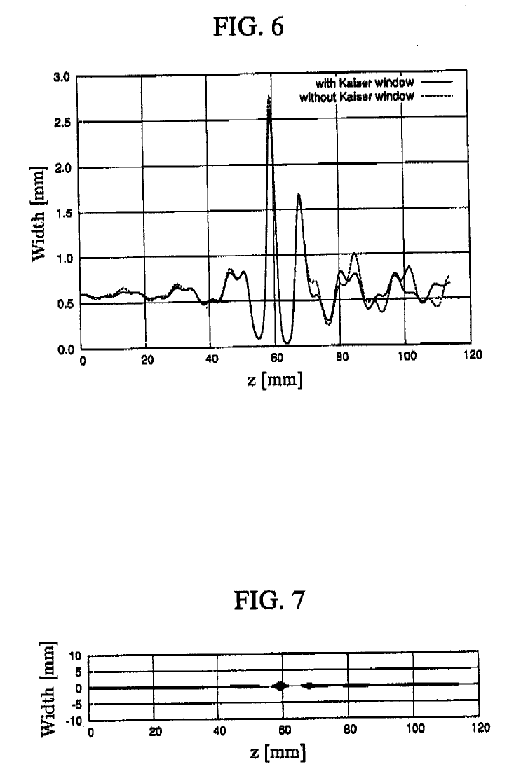

FIG. 6 shows the distribution of the width w of the microstrip line 5 in the z-axis direction when a dielectric layer 4 of thickness h=0.635 mm, and relative dielectric constant ∈ᵣ=10.2 (for example, RT/duroid (registered trademark) 6010LM) was used, together with the width when the Kaiser window was not used. Tables 1 through 3 list the widths w of the microstrip line 5 when the Kaiser window was used.

TABLE 1
Widths of the microstrip line

| | z[mm] | | | | | | | | | | | |
|---|---|---|---|---|---|---|---|---|---|---|---|---|
| | 0.00 | 0.11 | 0.23 | 0.34 | 0.46 | 0.57 | 0.68 | 0.80 | 0.91 | 1.02 | 1.14 | 1.25 |
| | w[mm] | | | | | | | | | | | |
| | 0.60 | 0.60 | 0.60 | 0.60 | 0.60 | 0.60 | 0.60 | 0.60 | 0.60 | 0.60 | 0.60 | 0.60 |
| #2 | 1.37 | 1.48 | 1.59 | 1.71 | 1.82 | 1.93 | 2.05 | 2.16 | 2.28 | 2.39 | 2.50 | 2.62 |
| — | 0.60 | 0.60 | 0.60 | 0.59 | 0.59 | 0.59 | 0.59 | 0.59 | 0.59 | 0.59 | 0.59 | 0.59 |
| #3 | 2.73 | 2.85 | 2.96 | 3.07 | 3.19 | 3.30 | 3.42 | 3.53 | 3.64 | 3.76 | 3.87 | 3.99 |
| — | 0.58 | 0.58 | 0.58 | 0.58 | 0.58 | 0.58 | 0.58 | 0.57 | 0.57 | 0.57 | 0.57 | 0.57 |
| #4 | 4.10 | 4.21 | 4.33 | 4.44 | 4.56 | 4.67 | 4.78 | 4.90 | 5.01 | 5.13 | 5.24 | 5.35 |
| — | 0.57 | 0.57 | 0.57 | 0.57 | 0.57 | 0.57 | 0.57 | 0.57 | 0.56 | 0.57 | 0.57 | 0.57 |
| #5 | 5.47 | 5.58 | 5.70 | 5.81 | 5.93 | 6.04 | 6.15 | 6.27 | 6.38 | 6.50 | 6.61 | 6.72 |
| — | 0.57 | 0.57 | 0.57 | 0.57 | 0.57 | 0.57 | 0.57 | 0.57 | 0.57 | 0.57 | 0.57 | 0.57 |
| #6 | 6.84 | 6.95 | 7.07 | 7.18 | 7.29 | 7.41 | 7.52 | 7.64 | 7.75 | 7.86 | 7.98 | 8.09 |
| — | 0.57 | 0.57 | 0.57 | 0.57 | 0.57 | 0.57 | 0.57 | 0.57 | 0.57 | 0.57 | 0.57 | 0.57 |
| #7 | 8.21 | 8.32 | 8.43 | 8.55 | 8.66 | 8.78 | 8.89 | 9.00 | 9.12 | 9.23 | 9.35 | 9.46 |
| — | 0.57 | 0.57 | 0.57 | 0.57 | 0.57 | 0.57 | 0.57 | 0.57 | 0.57 | 0.57 | 0.57 | 0.57 |
| #8 | 9.57 | 9.69 | 9.80 | 9.92 | 10.03 | 10.14 | 10.26 | 10.37 | 10.49 | 10.60 | 10.71 | 10.83 |
| — | 0.57 | 0.57 | 0.57 | 0.57 | 0.57 | 0.57 | 0.58 | 0.58 | 0.58 | 0.58 | 0.58 | 0.58 |
| #9 | 10.94 | 11.06 | 11.17 | 11.28 | 11.40 | 11.51 | 11.62 | 11.74 | 11.85 | 11.97 | 12.08 | 12.19 |
| — | 0.59 | 0.59 | 0.59 | 0.59 | 0.60 | 0.60 | 0.60 | 0.60 | 0.60 | 0.61 | 0.61 | 0.61 |
| #10 | 12.31 | 12.42 | 12.53 | 12.65 | 12.76 | 12.88 | 12.99 | 13.10 | 13.22 | 13.33 | 13.44 | 13.56 |
| — | 0.61 | 0.61 | 0.62 | 0.62 | 0.62 | 0.62 | 0.62 | 0.62 | 0.62 | 0.62 | 0.62 | 0.62 |
| #11 | 13.67 | 13.78 | 13.90 | 14.01 | 14.13 | 14.24 | 14.35 | 14.47 | 14.58 | 14.69 | 14.81 | 14.92 |
| — | 0.62 | 0.62 | 0.62 | 0.62 | 0.62 | 0.62 | 0.61 | 0.61 | 0.61 | 0.61 | 0.61 | 0.61 |
| #12 | 15.03 | 15.15 | 15.26 | 15.38 | 15.49 | 15.60 | 15.72 | 15.83 | 15.94 | 16.06 | 16.17 | 16.29 |
| — | 0.61 | 0.61 | 0.61 | 0.61 | 0.61 | 0.61 | 0.61 | 0.61 | 0.61 | 0.61 | 0.61 | 0.61 |
| #13 | 16.40 | 16.51 | 16.63 | 16.74 | 16.85 | 16.97 | 17.08 | 17.20 | 17.31 | 17.42 | 17.54 | 17.65 |
| — | 0.61 | 0.61 | 0.61 | 0.61 | 0.61 | 0.61 | 0.61 | 0.61 | 0.61 | 0.61 | 0.61 | 0.61 |
| #14 | 17.76 | 17.88 | 17.99 | 18.10 | 18.22 | 18.33 | 18.45 | 18.56 | 18.67 | 18.79 | 18.90 | 19.01 |
| — | 0.61 | 0.61 | 0.61 | 0.61 | 0.61 | 0.61 | 0.61 | 0.60 | 0.60 | 0.60 | 0.60 | 0.59 |
| #15 | 19.13 | 19.24 | 19.36 | 19.47 | 19.58 | 19.70 | 19.81 | 19.93 | 20.04 | 20.15 | 20.27 | 20.38 |
| — | 0.59 | 0.59 | 0.58 | 0.58 | 0.58 | 0.57 | 0.57 | 0.57 | 0.56 | 0.56 | 0.56 | 0.56 |
| #16 | 20.50 | 20.61 | 20.73 | 20.84 | 20.95 | 21.07 | 21.18 | 21.30 | 21.41 | 21.53 | 21.64 | 21.75 |
| — | 0.55 | 0.55 | 0.55 | 0.55 | 0.55 | 0.54 | 0.54 | 0.54 | 0.54 | 0.54 | 0.54 | 0.54 |
| #17 | 21.87 | 21.98 | 22.10 | 22.21 | 22.33 | 22.44 | 22.55 | 22.67 | 22.78 | 22.90 | 23.01 | 23.13 |
| — | 0.54 | 0.54 | 0.54 | 0.54 | 0.54 | 0.55 | 0.55 | 0.55 | 0.55 | 0.55 | 0.55 | 0.55 |
| #18 | 23.24 | 23.35 | 23.47 | 23.58 | 23.70 | 23.81 | 23.92 | 24.04 | 24.15 | 24.27 | 24.38 | 24.50 |
| — | 0.55 | 0.55 | 0.56 | 0.56 | 0.56 | 0.56 | 0.56 | 0.56 | 0.56 | 0.56 | 0.56 | 0.56 |
| #19 | 24.61 | 24.72 | 24.84 | 24.95 | 25.07 | 25.18 | 25.29 | 25.41 | 25.52 | 25.64 | 25.75 | 25.87 |
| — | 0.55 | 0.55 | 0.55 | 0.55 | 0.55 | 0.55 | 0.55 | 0.55 | 0.55 | 0.55 | 0.55 | 0.55 |
| #20 | 25.98 | 26.09 | 26.21 | 26.32 | 26.44 | 26.55 | 26.67 | 26.78 | 26.89 | 27.01 | 27.12 | 27.24 |
| — | 0.55 | 0.55 | 0.55 | 0.55 | 0.55 | 0.55 | 0.56 | 0.56 | 0.56 | 0.56 | 0.57 | 0.57 |
| #21 | 27.35 | 27.46 | 27.58 | 27.69 | 27.81 | 27.92 | 28.03 | 28.15 | 28.26 | 28.37 | 28.49 | 28.60 |
| — | 0.58 | 0.58 | 0.59 | 0.59 | 0.59 | 0.60 | 0.61 | 0.61 | 0.62 | 0.62 | 0.63 | 0.63 |
| #22 | 28.71 | 28.83 | 28.94 | 29.05 | 29.17 | 29.28 | 29.39 | 29.51 | 29.62 | 29.73 | 29.85 | 29.96 |
| — | 0.63 | 0.64 | 0.64 | 0.65 | 0.65 | 0.65 | 0.65 | 0.66 | 0.66 | 0.66 | 0.66 | 0.66 |
| #23 | 30.07 | 30.19 | 30.30 | 30.41 | 30.53 | 30.64 | 30.75 | 30.87 | 30.98 | 31.09 | 31.21 | 31.32 |
| — | 0.66 | 0.66 | 0.66 | 0.66 | 0.65 | 0.65 | 0.65 | 0.65 | 0.65 | 0.64 | 0.64 | 0.64 |
| #24 | 31.44 | 31.55 | 31.66 | 31.78 | 31.89 | 32.00 | 32.12 | 32.23 | 32.34 | 32.46 | 32.57 | 32.68 |
| — | 0.64 | 0.64 | 0.64 | 0.64 | 0.63 | 0.63 | 0.63 | 0.63 | 0.63 | 0.63 | 0.63 | 0.64 |
| #25 | 32.80 | 32.91 | 33.02 | 33.14 | 33.25 | 33.36 | 33.48 | 33.59 | 33.70 | 33.82 | 33.93 | 34.04 |
| — | 0.64 | 0.64 | 0.64 | 0.64 | 0.64 | 0.64 | 0.65 | 0.65 | 0.65 | 0.65 | 0.65 | 0.65 |
| #26 | 34.16 | 34.27 | 34.38 | 34.50 | 34.61 | 34.72 | 34.84 | 34.95 | 35.07 | 35.18 | 35.29 | 35.41 |
| — | 0.65 | 0.65 | 0.65 | 0.65 | 0.65 | 0.64 | 0.64 | 0.64 | 0.63 | 0.63 | 0.62 | 0.62 |
| #27 | 35.52 | 35.63 | 35.75 | 35.86 | 35.98 | 36.09 | 36.20 | 36.32 | 36.43 | 36.55 | 36.66 | 36.77 |
| — | 0.61 | 0.60 | 0.60 | 0.59 | 0.58 | 0.57 | 0.57 | 0.56 | 0.55 | 0.54 | 0.54 | 0.53 |
| #28 | 36.89 | 37.00 | 37.12 | 37.23 | 37.35 | 37.46 | 37.58 | 37.69 | 37.81 | 37.92 | 38.04 | 38.15 |
| — | 0.52 | 0.52 | 0.51 | 0.51 | 0.50 | 0.50 | 0.49 | 0.49 | 0.49 | 0.49 | 0.49 | 0.48 |
| #29 | 38.27 | 38.38 | 38.50 | 38.61 | 38.73 | 38.84 | 38.95 | 39.07 | 39.18 | 39.30 | 39.41 | 39.53 |
| — | 0.48 | 0.48 | 0.49 | 0.49 | 0.49 | 0.49 | 0.49 | 0.49 | 0.50 | 0.50 | 0.50 | 0.50 |
| #30 | 39.64 | 39.76 | 39.87 | 39.99 | 40.10 | 40.22 | 40.33 | 40.44 | 40.56 | 40.67 | 40.79 | 40.90 |
| — | 0.51 | 0.51 | 0.51 | 0.51 | 0.51 | 0.52 | 0.52 | 0.52 | 0.52 | 0.52 | 0.51 | 0.51 |

TABLE 2
Widths of the microstrip line

| | | | | | | | | | | | | |
|---|---|---|---|---|---|---|---|---|---|---|---|---|
| #31 | 41.02 | 41.13 | 41.25 | 41.36 | 41.48 | 41.59 | 41.71 | 41.82 | 41.93 | 42.05 | 42.16 | 42.28 |
| — | 0.51 | 0.51 | 0.51 | 0.51 | 0.50 | 0.50 | 0.50 | 0.50 | 0.49 | 0.49 | 0.49 | 0.49 |
| #32 | 42.39 | 42.51 | 42.62 | 42.74 | 42.85 | 42.97 | 43.08 | 43.20 | 43.31 | 43.43 | 43.54 | 43.66 |
| — | 0.49 | 0.49 | 0.49 | 0.49 | 0.49 | 0.50 | 0.50 | 0.51 | 0.51 | 0.52 | 0.53 | 0.53 |
| #33 | 43.77 | 43.88 | 44.00 | 44.11 | 44.23 | 44.34 | 44.45 | 44.57 | 44.68 | 44.79 | 44.91 | 45.02 |
| — | 0.54 | 0.55 | 0.57 | 0.58 | 0.59 | 0.60 | 0.62 | 0.63 | 0.65 | 0.66 | 0.68 | 0.69 |
| #34 | 45.13 | 45.24 | 45.36 | 45.47 | 45.58 | 45.70 | 45.81 | 45.92 | 46.03 | 46.14 | 46.26 | 46.37 |
| — | 0.71 | 0.72 | 0.74 | 0.75 | 0.76 | 0.77 | 0.78 | 0.79 | 0.80 | 0.80 | 0.81 | 0.81 |
| #35 | 46.48 | 46.59 | 46.71 | 46.82 | 46.93 | 47.04 | 47.15 | 47.27 | 47.38 | 47.49 | 47.60 | 47.72 |
| — | 0.81 | 0.81 | 0.81 | 0.81 | 0.81 | 0.80 | 0.80 | 0.79 | 0.79 | 0.78 | 0.77 | 0.77 |
| #36 | 47.83 | 47.94 | 48.05 | 48.17 | 48.28 | 48.39 | 48.51 | 48.62 | 48.73 | 48.84 | 48.96 | 49.07 |
| — | 0.76 | 0.76 | 0.75 | 0.75 | 0.74 | 0.74 | 0.74 | 0.74 | 0.74 | 0.74 | 0.74 | 0.74 |
| #37 | 49.18 | 49.29 | 49.41 | 49.52 | 49.63 | 49.74 | 49.86 | 49.97 | 50.08 | 50.19 | 50.31 | 50.42 |
| — | 0.75 | 0.75 | 0.76 | 0.76 | 0.77 | 0.78 | 0.79 | 0.79 | 0.80 | 0.81 | 0.81 | 0.82 |
| #38 | 50.53 | 50.64 | 50.75 | 50.87 | 50.98 | 51.09 | 51.20 | 51.32 | 51.43 | 51.54 | 51.65 | 51.77 |
| — | 0.82 | 0.82 | 0.82 | 0.82 | 0.82 | 0.81 | 0.80 | 0.78 | 0.77 | 0.75 | 0.72 | 0.70 |
| #39 | 51.88 | 51.99 | 52.11 | 52.22 | 52.34 | 52.45 | 52.56 | 52.68 | 52.80 | 52.91 | 53.03 | 53.15 |
| — | 0.67 | 0.64 | 0.61 | 0.57 | 0.54 | 0.50 | 0.47 | 0.43 | 0.39 | 0.36 | 0.33 | 0.30 |
| #40 | 53.26 | 53.38 | 53.50 | 53.62 | 53.74 | 53.86 | 53.98 | 54.10 | 54.22 | 54.34 | 54.46 | 54.58 |
| — | 0.27 | 0.24 | 0.22 | 0.19 | 0.17 | 0.16 | 0.14 | 0.13 | 0.12 | 0.11 | 0.10 | 0.09 |
| #41 | 54.70 | 54.82 | 54.94 | 55.06 | 55.18 | 55.31 | 55.43 | 55.55 | 55.67 | 55.79 | 55.91 | 56.03 |
| — | 0.09 | 0.09 | 0.09 | 0.09 | 0.09 | 0.09 | 0.10 | 0.10 | 0.11 | 0.13 | 0.14 | 0.16 |
| #42 | 56.15 | 56.26 | 56.38 | 56.50 | 56.61 | 56.73 | 56.85 | 56.96 | 57.07 | 57.19 | 57.30 | 57.41 |
| — | 0.19 | 0.21 | 0.25 | 0.29 | 0.33 | 0.39 | 0.45 | 0.52 | 0.59 | 0.68 | 0.77 | 0.87 |
| #43 | 57.52 | 57.63 | 57.74 | 57.85 | 57.96 | 58.07 | 58.18 | 58.29 | 58.39 | 58.50 | 58.61 | 58.71 |
| — | 0.97 | 1.09 | 1.21 | 1.33 | 1.46 | 1.59 | 1.72 | 1.86 | 1.98 | 2.11 | 2.22 | 2.32 |
| #44 | 58.82 | 58.92 | 59.03 | 59.14 | 59.24 | 59.35 | 59.45 | 59.56 | 59.66 | 59.77 | 59.88 | 59.98 |
| — | 2.41 | 2.48 | 2.54 | 2.58 | 2.59 | 2.58 | 2.56 | 2.51 | 2.44 | 2.35 | 2.25 | 2.14 |
| #45 | 60.09 | 60.20 | 60.31 | 60.41 | 60.52 | 60.63 | 60.74 | 60.85 | 60.96 | 61.08 | 61.19 | 61.30 |
| — | 2.01 | 1.88 | 1.74 | 1.61 | 1.47 | 1.33 | 1.20 | 1.07 | 0.94 | 0.83 | 0.72 | 0.62 |
| #46 | 61.42 | 61.53 | 61.65 | 61.76 | 61.88 | 62.00 | 62.12 | 62.24 | 62.36 | 62.48 | 62.60 | 62.72 |
| — | 0.53 | 0.45 | 0.38 | 0.32 | 0.26 | 0.22 | 0.18 | 0.15 | 0.12 | 0.10 | 0.08 | 0.07 |
| #47 | 62.85 | 62.97 | 63.09 | 63.21 | 63.34 | 63.46 | 63.58 | 63.71 | 63.83 | 63.95 | 64.08 | 64.20 |
| — | 0.06 | 0.05 | 0.04 | 0.04 | 0.03 | 0.03 | 0.03 | 0.03 | 0.03 | 0.03 | 0.04 | 0.04 |
| #48 | 64.32 | 64.44 | 64.56 | 64.69 | 64.81 | 64.93 | 65.05 | 65.17 | 65.29 | 65.40 | 65.52 | 65.64 |
| — | 0.05 | 0.06 | 0.07 | 0.08 | 0.09 | 0.11 | 0.14 | 0.17 | 0.20 | 0.24 | 0.28 | 0.33 |
| #49 | 65.75 | 65.87 | 65.98 | 66.10 | 66.21 | 66.32 | 66.43 | 66.55 | 66.66 | 66.77 | 66.88 | 66.99 |
| — | 0.39 | 0.45 | 0.52 | 0.60 | 0.68 | 0.76 | 0.84 | 0.93 | 1.02 | 1.10 | 1.19 | 1.27 |
| #50 | 67.10 | 67.21 | 67.31 | 67.42 | 67.53 | 67.64 | 67.75 | 67.86 | 67.96 | 68.07 | 68.18 | 68.29 |
| — | 1.35 | 1.42 | 1.48 | 1.54 | 1.58 | 1.62 | 1.65 | 1.67 | 1.67 | 1.67 | 1.65 | 1.63 |
| #51 | 68.40 | 68.51 | 68.61 | 68.72 | 68.83 | 68.94 | 69.05 | 69.16 | 69.27 | 69.38 | 69.49 | 69.60 |
| — | 1.60 | 1.56 | 1.51 | 1.46 | 1.41 | 1.35 | 1.29 | 1.23 | 1.17 | 1.11 | 1.06 | 1.00 |
| #52 | 69.71 | 69.83 | 69.94 | 70.05 | 70.16 | 70.28 | 70.39 | 70.50 | 70.62 | 70.73 | 70.84 | 70.96 |
| — | 0.95 | 0.90 | 0.85 | 0.81 | 0.77 | 0.74 | 0.70 | 0.67 | 0.65 | 0.62 | 0.61 | 0.59 |
| #53 | 71.07 | 71.18 | 71.30 | 71.41 | 71.53 | 71.64 | 71.76 | 71.87 | 71.98 | 72.10 | 72.21 | 72.33 |
| — | 0.57 | 0.56 | 0.55 | 0.55 | 0.54 | 0.54 | 0.54 | 0.54 | 0.54 | 0.54 | 0.54 | 0.54 |
| #54 | 72.44 | 72.56 | 72.67 | 72.78 | 72.90 | 73.01 | 73.13 | 73.24 | 73.36 | 73.47 | 73.58 | 73.70 |
| — | 0.55 | 0.55 | 0.55 | 0.55 | 0.55 | 0.55 | 0.55 | 0.55 | 0.54 | 0.54 | 0.53 | 0.52 |
| #55 | 73.81 | 73.93 | 74.04 | 74.16 | 74.27 | 74.39 | 74.50 | 74.62 | 74.73 | 74.85 | 74.97 | 75.08 |
| — | 0.51 | 0.50 | 0.49 | 0.47 | 0.46 | 0.44 | 0.43 | 0.41 | 0.40 | 0.38 | 0.37 | 0.35 |
| #56 | 75.20 | 75.32 | 75.43 | 75.55 | 75.67 | 75.78 | 75.90 | 76.02 | 76.14 | 76.25 | 76.37 | 76.49 |
| — | 0.34 | 0.33 | 0.32 | 0.31 | 0.30 | 0.29 | 0.28 | 0.28 | 0.28 | 0.27 | 0.27 | 0.27 |
| #57 | 76.61 | 76.72 | 76.84 | 76.96 | 77.07 | 77.19 | 77.31 | 77.42 | 77.54 | 77.66 | 77.77 | 77.89 |
| — | 0.28 | 0.28 | 0.28 | 0.29 | 0.30 | 0.31 | 0.32 | 0.34 | 0.35 | 0.37 | 0.39 | 0.41 |
| #58 | 78.00 | 78.12 | 78.23 | 78.35 | 78.46 | 78.58 | 78.69 | 78.80 | 78.92 | 79.03 | 79.14 | 79.26 |
| — | 0.43 | 0.45 | 0.47 | 0.50 | 0.52 | 0.55 | 0.57 | 0.60 | 0.62 | 0.65 | 0.67 | 0.69 |
| #59 | 79.37 | 79.48 | 79.60 | 79.71 | 79.82 | 79.93 | 80.05 | 80.16 | 80.27 | 80.38 | 80.49 | 80.61 |
| — | 0.72 | 0.73 | 0.75 | 0.77 | 0.78 | 0.79 | 0.80 | 0.81 | 0.81 | 0.81 | 0.81 | 0.81 |
| #60 | 80.72 | 80.83 | 80.94 | 81.06 | 81.17 | 81.28 | 81.39 | 81.51 | 81.62 | 81.73 | 81.84 | 81.96 |
| — | 0.81 | 0.80 | 0.80 | 0.79 | 0.78 | 0.77 | 0.77 | 0.76 | 0.75 | 0.74 | 0.73 | 0.73 |

TABLE 3
Widths of the microstrip line

| | | | | | | | | | | | | |
|---|---|---|---|---|---|---|---|---|---|---|---|---|
| #61 | 82.07 | 82.18 | 82.29 | 82.41 | 82.52 | 82.63 | 82.75 | 82.86 | 82.97 | 83.09 | 83.20 | 83.31 |
| — | 0.72 | 0.72 | 0.71 | 0.71 | 0.71 | 0.71 | 0.71 | 0.71 | 0.71 | 0.71 | 0.72 | 0.72 |
| #62 | 83.42 | 83.54 | 83.65 | 83.76 | 83.87 | 83.99 | 84.10 | 84.21 | 84.32 | 84.44 | 84.55 | 84.66 |
| — | 0.73 | 0.73 | 0.74 | 0.74 | 0.75 | 0.76 | 0.76 | 0.77 | 0.77 | 0.78 | 0.78 | 0.78 |
| #63 | 84.77 | 84.89 | 85.00 | 85.11 | 85.22 | 85.34 | 85.45 | 85.56 | 85.67 | 85.79 | 85.90 | 86.01 |
| — | 0.78 | 0.78 | 0.78 | 0.78 | 0.77 | 0.76 | 0.76 | 0.75 | 0.73 | 0.72 | 0.71 | 0.69 |
| #64 | 86.13 | 86.24 | 86.35 | 86.47 | 86.58 | 86.69 | 86.81 | 86.92 | 87.04 | 87.15 | 87.27 | 87.38 |
| — | 0.67 | 0.66 | 0.64 | 0.62 | 0.60 | 0.59 | 0.57 | 0.55 | 0.53 | 0.52 | 0.50 | 0.49 |
| #65 | 87.50 | 87.61 | 87.73 | 87.84 | 87.96 | 88.07 | 88.19 | 88.30 | 88.42 | 88.54 | 88.65 | 88.77 |
| — | 0.47 | 0.46 | 0.45 | 0.44 | 0.43 | 0.42 | 0.41 | 0.41 | 0.40 | 0.40 | 0.40 | 0.40 |
| #66 | 88.88 | 89.00 | 89.11 | 89.23 | 89.35 | 89.46 | 89.58 | 89.69 | 89.81 | 89.92 | 90.04 | 90.15 |
| — | 0.40 | 0.40 | 0.40 | 0.40 | 0.41 | 0.41 | 0.42 | 0.43 | 0.43 | 0.44 | 0.45 | 0.46 |
| #67 | 90.27 | 90.38 | 90.50 | 90.61 | 90.73 | 90.84 | 90.96 | 91.07 | 91.19 | 91.30 | 91.41 | 91.53 |
| — | 0.46 | 0.47 | 0.48 | 0.49 | 0.50 | 0.50 | 0.51 | 0.52 | 0.52 | 0.53 | 0.53 | 0.54 |
| #68 | 91.64 | 91.76 | 91.87 | 91.99 | 92.10 | 92.21 | 92.33 | 92.44 | 92.56 | 92.67 | 92.79 | 92.90 |
| — | 0.54 | 0.54 | 0.54 | 0.54 | 0.55 | 0.54 | 0.54 | 0.54 | 0.54 | 0.54 | 0.54 | 0.54 |
| #69 | 93.01 | 93.13 | 93.24 | 93.36 | 93.47 | 93.59 | 93.70 | 93.82 | 93.93 | 94.04 | 94.16 | 94.27 |
| — | 0.54 | 0.54 | 0.54 | 0.53 | 0.54 | 0.54 | 0.54 | 0.54 | 0.54 | 0.55 | 0.55 | 0.56 |
| #70 | 94.39 | 94.50 | 94.61 | 94.73 | 94.84 | 94.96 | 95.07 | 95.18 | 95.30 | 95.41 | 95.52 | 95.64 |
| — | 0.56 | 0.57 | 0.58 | 0.59 | 0.60 | 0.61 | 0.62 | 0.63 | 0.64 | 0.65 | 0.66 | 0.67 |
| #71 | 95.75 | 95.86 | 95.98 | 96.09 | 96.20 | 96.31 | 96.43 | 96.54 | 96.65 | 96.76 | 96.88 | 96.99 |
| — | 0.69 | 0.70 | 0.71 | 0.72 | 0.73 | 0.74 | 0.75 | 0.76 | 0.77 | 0.77 | 0.78 | 0.78 |
| #72 | 97.10 | 97.21 | 97.33 | 97.44 | 97.55 | 97.66 | 97.78 | 97.89 | 98.00 | 98.11 | 98.23 | 98.34 |
| — | 0.78 | 0.78 | 0.78 | 0.78 | 0.77 | 0.77 | 0.76 | 0.76 | 0.75 | 0.74 | 0.73 | 0.72 |
| #73 | 98.45 | 98.57 | 98.68 | 98.79 | 98.90 | 99.02 | 99.13 | 99.24 | 99.36 | 99.47 | 99.59 | 99.70 |
| — | 0.71 | 0.70 | 0.69 | 0.67 | 0.66 | 0.65 | 0.64 | 0.63 | 0.62 | 0.61 | 0.60 | 0.60 |
| #74 | 99.81 | 99.93 | 100.04 | 100.16 | 100.27 | 100.38 | 100.50 | 100.61 | 100.73 | 100.84 | 100.95 | 101.07 |
| — | 0.59 | 0.58 | 0.58 | 0.57 | 0.57 | 0.56 | 0.56 | 0.56 | 0.56 | 0.56 | 0.56 | 0.56 |
| #75 | 101.18 | 101.30 | 101.41 | 101.53 | 101.64 | 101.75 | 101.87 | 101.98 | 102.10 | 102.21 | 102.32 | 102.44 |
| — | 0.56 | 0.56 | 0.56 | 0.56 | 0.56 | 0.56 | 0.56 | 0.57 | 0.57 | 0.57 | 0.57 | 0.57 |
| #76 | 102.55 | 102.67 | 102.78 | 102.89 | 103.01 | 103.12 | 103.24 | 103.35 | 103.47 | 103.58 | 103.69 | 103.81 |
| — | 0.57 | 0.56 | 0.56 | 0.56 | 0.56 | 0.55 | 0.55 | 0.55 | 0.54 | 0.54 | 0.53 | 0.52 |
| #77 | 103.92 | 104.04 | 104.15 | 104.27 | 104.38 | 104.50 | 104.61 | 104.73 | 104.84 | 104.96 | 105.07 | 105.19 |
| — | 0.52 | 0.51 | 0.51 | 0.50 | 0.50 | 0.49 | 0.48 | 0.48 | 0.48 | 0.47 | 0.47 | 0.47 |
| #78 | 105.30 | 105.42 | 105.53 | 105.65 | 105.76 | 105.88 | 105.99 | 106.11 | 106.22 | 106.34 | 106.45 | 106.57 |
| — | 0.46 | 0.46 | 0.46 | 0.46 | 0.46 | 0.47 | 0.47 | 0.47 | 0.47 | 0.48 | 0.48 | 0.49 |
| #79 | 106.68 | 106.80 | 106.91 | 107.02 | 107.14 | 107.25 | 107.37 | 107.48 | 107.60 | 107.71 | 107.82 | 107.94 |
| — | 0.50 | 0.50 | 0.51 | 0.52 | 0.53 | 0.54 | 0.55 | 0.56 | 0.57 | 0.57 | 0.58 | 0.59 |
| #80 | 108.05 | 108.16 | 108.28 | 108.39 | 108.51 | 108.62 | 108.73 | 108.85 | 108.96 | 109.07 | 109.19 | 109.30 |
| — | 0.60 | 0.61 | 0.62 | 0.62 | 0.63 | 0.64 | 0.64 | 0.65 | 0.65 | 0.65 | 0.66 | 0.66 |
| #81 | 109.41 | 109.53 | 109.64 | 109.75 | 109.87 | 109.98 | 110.09 | 110.21 | 110.32 | 110.43 | 110.55 | 110.66 |
| — | 0.66 | 0.66 | 0.66 | 0.66 | 0.66 | 0.65 | 0.65 | 0.65 | 0.65 | 0.64 | 0.64 | 0.64 |
| #82 | 110.77 | 110.89 | 111.00 | 111.11 | 111.23 | 111.34 | 111.45 | 111.57 | 111.68 | 111.79 | 111.91 | 112.02 |
| — | 0.64 | 0.64 | 0.63 | 0.63 | 0.63 | 0.63 | 0.63 | 0.63 | 0.63 | 0.63 | 0.63 | 0.63 |
| #83 | 112.14 | 112.25 | 112.36 | 112.48 | 112.59 | 112.70 | 112.82 | 112.93 | 113.04 | 113.16 | 113.27 | 113.38 |
| — | 0.64 | 0.64 | 0.64 | 0.64 | 0.65 | 0.65 | 0.65 | 0.66 | 0.66 | 0.66 | 0.66 | 0.67 |
| #84 | 113.50 | 113.61 | 113.72 | 113.83 | 113.95 | | | | | | | |
| — | 0.67 | 0.67 | 0.67 | 0.67 | 0.67 | | | | | | | |

FIG. 7 shows the shape of the microstrip line 5 in the reflection-type bandpass filter 1 of the first embodiment. A non-reflecting terminator, or an R=50Ω resistance, is provided at the terminating side (the face at z=113.95 mm) of the reflection-type bandpass filter 1. The non-reflecting terminator or resistance may be connected in series with the terminating end of the reflection-type bandpass filter 1. The thickness of the metal films used in the conducting layer 3 and of the conductor constituting the microstrip line 5 should be adequately greater than the skin depth δs=√{2/(ωμ0σ)} at f=1 GHz. Here, ω, μ₀, and σ each represent the angular frequency, the magnetic permeability in vacuum, and the conductivity of the metal. For example if copper is used, the thickness of the conducting layer 3 and of the conductor of the microstrip line 5 should be taken as 2.1 μm or greater. This reflection-type bandpass filter is used in a system where the characteristic impedance is 50Ω.

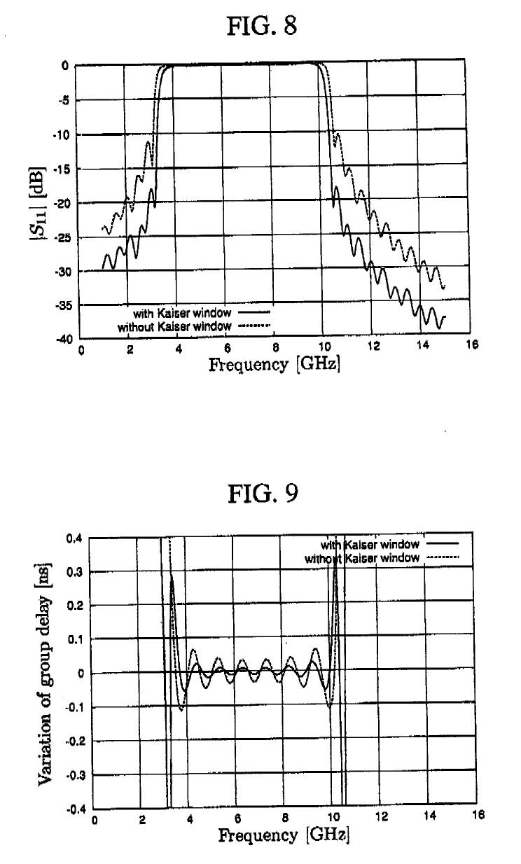

FIG. 8 and FIG. 9 express the amplitude characteristics and group delay frequency characteristics respectively of the reflective wave (S11) in the bandpass filter of the first embodiment. For comparison, the characteristics when the Kaiser window is not used, are also shown. As shown in the figures, in the region of frequency f for which 3.7 GHz≦f≦10.0 GHz, the reflectivity is −1 dB or greater and the variation of the group delay is within ±0.05 ns. In the region f<3.1 GHz and f>10.6 GHz, the reflectivity is −17 dB or lower. Compared to the case when the Kaiser window is not used, the region of transition frequency becomes wider, but the stop band rejection increases to 15 dB, and the variation of group delay within the pass band decreases.

### Embodiment 2

A Kaiser window was used for which the reflectivity is 1 at the frequency f in the region 3.6 GHz≦f≦10.1 GHz, and is 0 elsewhere, and for which A=40. Taking one wavelength at frequency f=1 GHz of the signal transmitted within the microstrip line as the waveguide length, the system characteristic impedance was taken as 50Ω, and the design was carried out.

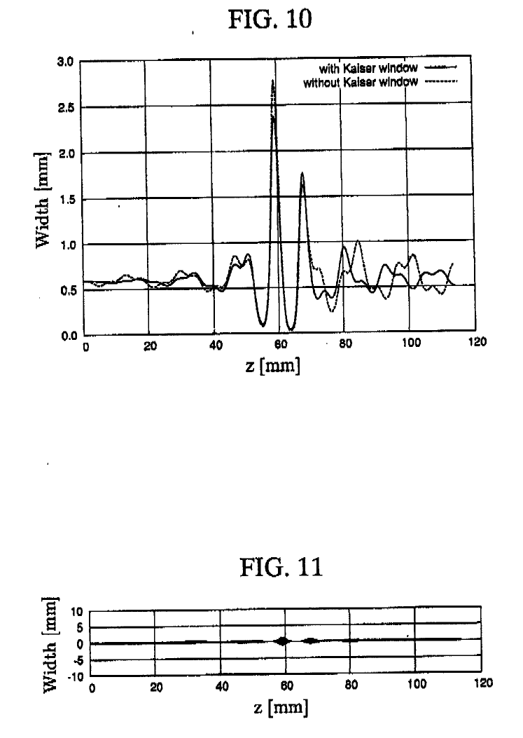

FIG. 10 shows the distribution of the width w of the microstrip line 5 in the z-axis direction when a dielectric layer 4 of thickness h=0.635 mm, and relative dielectric constant ∈ᵣ=10.2 (for example, RT/duroid (registered trademark) 6010LM) was used, together with the width when the Kaiser window was not used. Tables 4 through 6 list the widths w of the microstrip line 5 when the Kaiser window was used.

TABLE 4
Widths of the microstrip line

| | z[mm] | | | | | | | | | | | |
|---|---|---|---|---|---|---|---|---|---|---|---|---|
| | 0.00 | 0.11 | 0.23 | 0.34 | 0.46 | 0.57 | 0.68 | 0.80 | 0.91 | 1.02 | 1.14 | 1.25 |
| | w[mm] | | | | | | | | | | | |
| | 0.60 | 0.60 | 0.60 | 0.60 | 0.60 | 0.60 | 0.60 | 0.60 | 0.60 | 0.60 | 0.60 | 0.60 |
| #2 | 1.37 | 1.48 | 1.59 | 1.71 | 1.82 | 1.93 | 2.05 | 2.16 | 2.28 | 2.39 | 2.50 | 2.62 |
| — | 0.60 | 0.60 | 0.60 | 0.60 | 0.60 | 0.60 | 0.59 | 0.59 | 0.59 | 0.59 | 0.59 | 0.59 |
| #3 | 2.73 | 2.85 | 2.96 | 3.07 | 3.19 | 3.30 | 3.41 | 3.53 | 3.64 | 3.76 | 3.87 | 3.98 |
| — | 0.59 | 0.59 | 0.59 | 0.59 | 0.59 | 0.59 | 0.59 | 0.59 | 0.59 | 0.59 | 0.59 | 0.59 |
| #4 | 4.10 | 4.21 | 4.33 | 4.44 | 4.55 | 4.67 | 4.78 | 4.90 | 5.01 | 5.12 | 5.24 | 5.35 |
| — | 0.59 | 0.59 | 0.59 | 0.59 | 0.59 | 0.59 | 0.59 | 0.59 | 0.59 | 0.59 | 0.59 | 0.59 |
| #5 | 5.46 | 5.58 | 5.69 | 5.81 | 5.92 | 6.03 | 6.15 | 6.26 | 6.38 | 6.49 | 6.60 | 6.72 |
| — | 0.59 | 0.59 | 0.59 | 0.59 | 0.59 | 0.59 | 0.59 | 0.59 | 0.59 | 0.59 | 0.59 | 0.59 |
| #6 | 6.83 | 6.95 | 7.06 | 7.17 | 7.29 | 7.40 | 7.51 | 7.63 | 7.74 | 7.86 | 7.97 | 8.08 |
| — | 0.59 | 0.58 | 0.58 | 0.58 | 0.58 | 0.58 | 0.58 | 0.58 | 0.58 | 0.58 | 0.58 | 0.58 |
| #7 | 8.20 | 8.31 | 8.43 | 8.54 | 8.65 | 8.77 | 8.88 | 9.00 | 9.11 | 9.22 | 9.34 | 9.45 |
| — | 0.58 | 0.58 | 0.57 | 0.57 | 0.57 | 0.57 | 0.57 | 0.57 | 0.57 | 0.57 | 0.57 | 0.57 |
| #8 | 9.57 | 9.68 | 9.79 | 9.91 | 10.02 | 10.14 | 10.25 | 10.36 | 10.48 | 10.59 | 10.71 | 10.82 |
| — | 0.57 | 0.57 | 0.57 | 0.57 | 0.58 | 0.58 | 0.58 | 0.58 | 0.58 | 0.58 | 0.58 | 0.58 |
| #9 | 10.93 | 11.05 | 11.16 | 11.28 | 11.39 | 11.50 | 11.62 | 11.73 | 11.85 | 11.96 | 12.07 | 12.19 |
| — | 0.58 | 0.58 | 0.58 | 0.58 | 0.59 | 0.59 | 0.59 | 0.59 | 0.59 | 0.59 | 0.59 | 0.59 |
| #10 | 12.30 | 12.41 | 12.53 | 12.64 | 12.76 | 12.87 | 12.98 | 13.10 | 13.21 | 13.33 | 13.44 | 13.55 |
| — | 0.59 | 0.59 | 0.59 | 0.59 | 0.59 | 0.59 | 0.59 | 0.59 | 0.59 | 0.59 | 0.59 | 0.59 |
| #11 | 13.67 | 13.78 | 13.90 | 14.01 | 14.12 | 14.24 | 14.35 | 14.46 | 14.58 | 14.69 | 14.81 | 14.92 |
| — | 0.59 | 0.59 | 0.59 | 0.59 | 0.59 | 0.59 | 0.59 | 0.59 | 0.59 | 0.59 | 0.60 | 0.60 |
| #12 | 15.03 | 15.15 | 15.26 | 15.37 | 15.49 | 15.60 | 15.72 | 15.83 | 15.94 | 16.06 | 16.17 | 16.28 |
| — | 0.60 | 0.60 | 0.60 | 0.60 | 0.60 | 0.60 | 0.61 | 0.61 | 0.61 | 0.61 | 0.61 | 0.61 |
| #13 | 16.40 | 16.51 | 16.63 | 16.74 | 16.85 | 16.97 | 17.08 | 17.19 | 17.31 | 17.42 | 17.53 | 17.65 |
| — | 0.61 | 0.62 | 0.62 | 0.62 | 0.62 | 0.62 | 0.62 | 0.62 | 0.62 | 0.62 | 0.62 | 0.62 |
| #14 | 17.76 | 17.88 | 17.99 | 18.10 | 18.22 | 18.33 | 18.44 | 18.56 | 18.67 | 18.78 | 18.90 | 19.01 |
| — | 0.62 | 0.62 | 0.62 | 0.62 | 0.62 | 0.62 | 0.61 | 0.61 | 0.61 | 0.61 | 0.61 | 0.61 |
| #15 | 19.13 | 19.24 | 19.35 | 19.47 | 19.58 | 19.69 | 19.81 | 19.92 | 20.04 | 20.15 | 20.26 | 20.38 |
| — | 0.60 | 0.60 | 0.60 | 0.60 | 0.60 | 0.59 | 0.59 | 0.59 | 0.59 | 0.59 | 0.59 | 0.59 |
| #16 | 20.49 | 20.61 | 20.72 | 20.83 | 20.95 | 21.06 | 21.18 | 21.29 | 21.40 | 21.52 | 21.63 | 21.75 |
| — | 0.58 | 0.58 | 0.58 | 0.58 | 0.58 | 0.58 | 0.58 | 0.58 | 0.58 | 0.58 | 0.58 | 0.58 |
| #17 | 21.86 | 21.97 | 22.09 | 22.20 | 22.32 | 22.43 | 22.54 | 22.66 | 22.77 | 22.88 | 23.00 | 23.11 |
| — | 0.58 | 0.58 | 0.58 | 0.58 | 0.58 | 0.58 | 0.58 | 0.58 | 0.58 | 0.58 | 0.58 | 0.58 |
| #18 | 23.23 | 23.34 | 23.45 | 23.57 | 23.68 | 23.80 | 23.91 | 24.03 | 24.14 | 24.25 | 24.37 | 24.48 |
| — | 0.57 | 0.57 | 0.57 | 0.57 | 0.57 | 0.57 | 0.56 | 0.56 | 0.56 | 0.56 | 0.56 | 0.55 |
| #19 | 24.60 | 24.71 | 24.82 | 24.94 | 25.05 | 25.17 | 25.28 | 25.40 | 25.51 | 25.62 | 25.74 | 25.85 |
| — | 0.55 | 0.55 | 0.55 | 0.55 | 0.54 | 0.54 | 0.54 | 0.54 | 0.54 | 0.54 | 0.54 | 0.54 |
| #20 | 25.97 | 26.08 | 26.20 | 26.31 | 26.42 | 26.54 | 26.65 | 26.77 | 26.88 | 27.00 | 27.11 | 27.22 |
| — | 0.54 | 0.54 | 0.54 | 0.54 | 0.54 | 0.55 | 0.55 | 0.55 | 0.55 | 0.56 | 0.56 | 0.56 |
| #21 | 27.34 | 27.45 | 27.57 | 27.68 | 27.79 | 27.91 | 28.02 | 28.14 | 28.25 | 28.36 | 28.48 | 28.59 |
| — | 0.57 | 0.57 | 0.57 | 0.58 | 0.58 | 0.58 | 0.59 | 0.59 | 0.59 | 0.60 | 0.60 | 0.60 |
| #22 | 28.70 | 28.82 | 28.93 | 29.05 | 29.16 | 29.27 | 29.39 | 29.50 | 29.61 | 29.73 | 29.84 | 29.96 |
| — | 0.60 | 0.61 | 0.61 | 0.61 | 0.61 | 0.61 | 0.61 | 0.61 | 0.62 | 0.62 | 0.62 | 0.62 |
| #23 | 30.07 | 30.18 | 30.30 | 30.41 | 30.52 | 30.64 | 30.75 | 30.86 | 30.98 | 31.09 | 31.21 | 31.32 |
| — | 0.62 | 0.62 | 0.62 | 0.62 | 0.61 | 0.61 | 0.61 | 0.61 | 0.62 | 0.62 | 0.62 | 0.62 |
| #24 | 31.43 | 31.55 | 31.66 | 31.77 | 31.89 | 32.00 | 32.11 | 32.23 | 32.34 | 32.45 | 32.57 | 32.68 |
| — | 0.62 | 0.62 | 0.62 | 0.62 | 0.63 | 0.63 | 0.63 | 0.63 | 0.64 | 0.64 | 0.64 | 0.65 |
| #25 | 32.80 | 32.91 | 33.02 | 33.14 | 33.25 | 33.36 | 33.47 | 33.59 | 33.70 | 33.81 | 33.93 | 34.04 |
| — | 0.65 | 0.65 | 0.66 | 0.66 | 0.66 | 0.67 | 0.67 | 0.67 | 0.67 | 0.67 | 0.67 | 0.68 |
| #26 | 34.15 | 34.27 | 34.38 | 34.49 | 34.61 | 34.72 | 34.83 | 34.95 | 35.06 | 35.17 | 35.29 | 35.40 |
| — | 0.68 | 0.67 | 0.67 | 0.67 | 0.67 | 0.67 | 0.66 | 0.66 | 0.65 | 0.65 | 0.64 | 0.64 |
| #27 | 35.51 | 35.63 | 35.74 | 35.85 | 33.97 | 30.08 | 36.20 | 36.31 | 36.42 | 36.54 | 36.65 | 36.77 |
| — | 0.63 | 0.63 | 0.62 | 0.61 | 0.61 | 0.60 | 0.59 | 0.59 | 0.58 | 0.57 | 0.57 | 0.56 |
| #28 | 36.88 | 36.99 | 37.11 | 37.22 | 37.34 | 37.45 | 37.57 | 37.68 | 37.79 | 37.91 | 38.02 | 38.14 |
| — | 0.56 | 0.55 | 0.55 | 0.54 | 0.54 | 0.54 | 0.54 | 0.53 | 0.53 | 0.53 | 0.53 | 0.53 |
| #29 | 38.25 | 38.37 | 38.48 | 38.60 | 38.71 | 38.82 | 38.94 | 39.05 | 39.17 | 39.28 | 39.40 | 39.51 |
| — | 0.53 | 0.53 | 0.53 | 0.53 | 0.53 | 0.53 | 0.53 | 0.53 | 0.53 | 0.53 | 0.53 | 0.53 |
| #30 | 39.62 | 39.74 | 39.85 | 39.97 | 40.08 | 40.20 | 40.31 | 40.43 | 40.54 | 40.65 | 40.77 | 40.88 |
| — | 0.53 | 0.53 | 0.53 | 0.53 | 0.53 | 0.53 | 0.52 | 0.52 | 0.52 | 0.52 | 0.51 | 0.51 |

TABLE 5
Widths of the microstrip line

| | | | | | | | | | | | | |
|---|---|---|---|---|---|---|---|---|---|---|---|---|
| #31 | 41.00 | 41.11 | 41.23 | 41.34 | 41.46 | 41.57 | 41.69 | 41.80 | 41.92 | 42.03 | 42.15 | 42.26 |
| — | 0.50 | 0.50 | 0.49 | 0.49 | 0.49 | 0.48 | 0.48 | 0.48 | 0.47 | 0.47 | 0.47 | 0.47 |
| #32 | 42.38 | 42.49 | 42.61 | 42.72 | 42.84 | 42.95 | 43.07 | 43.18 | 43.30 | 43.41 | 43.53 | 43.64 |
| — | 0.47 | 0.47 | 0.47 | 0.47 | 0.47 | 0.48 | 0.48 | 0.48 | 0.49 | 0.50 | 0.51 | 0.51 |
| #33 | 43.75 | 43.87 | 43.98 | 44.10 | 44.21 | 44.33 | 44.44 | 44.55 | 44.67 | 44.78 | 44.89 | 45.01 |
| — | 0.52 | 0.53 | 0.55 | 0.56 | 0.57 | 0.58 | 0.59 | 0.61 | 0.62 | 0.63 | 0.65 | 0.66 |
| #34 | 45.12 | 45.23 | 45.35 | 45.46 | 45.57 | 45.68 | 45.80 | 45.91 | 46.02 | 46.14 | 46.25 | 46.36 |
| — | 0.67 | 0.69 | 0.70 | 0.71 | 0.72 | 0.73 | 0.74 | 0.74 | 0.75 | 0.75 | 0.76 | 0.76 |
| #35 | 46.47 | 46.59 | 46.70 | 46.81 | 46.92 | 47.04 | 47.15 | 47.26 | 47.37 | 47.49 | 47.60 | 47.71 |
| — | 0.76 | 0.76 | 0.76 | 0.76 | 0.76 | 0.75 | 0.75 | 0.75 | 0.74 | 0.74 | 0.74 | 0.73 |
| #36 | 47.82 | 47.94 | 48.05 | 48.16 | 48.28 | 48.39 | 48.50 | 48.61 | 48.73 | 48.84 | 48.95 | 49.06 |
| — | 0.73 | 0.73 | 0.73 | 0.73 | 0.73 | 0.73 | 0.73 | 0.73 | 0.74 | 0.74 | 0.75 | 0.76 |
| #37 | 49.18 | 49.29 | 49.40 | 49.51 | 49.63 | 49.74 | 49.85 | 49.96 | 50.08 | 50.19 | 50.30 | 50.41 |
| — | 0.77 | 0.77 | 0.78 | 0.79 | 0.80 | 0.82 | 0.83 | 0.84 | 0.85 | 0.85 | 0.86 | 0.87 |
| #38 | 50.52 | 50.63 | 50.75 | 50.86 | 50.97 | 51.08 | 51.19 | 51.31 | 51.42 | 51.53 | 51.64 | 51.76 |
| — | 0.87 | 0.87 | 0.87 | 0.87 | 0.86 | 0.85 | 0.84 | 0.83 | 0.81 | 0.79 | 0.76 | 0.73 |
| #39 | 51.87 | 51.98 | 52.10 | 52.21 | 52.32 | 52.44 | 52.55 | 52.67 | 52.78 | 52.90 | 53.02 | 53.13 |
| — | 0.70 | 0.67 | 0.64 | 0.60 | 0.57 | 0.53 | 0.49 | 0.46 | 0.42 | 0.38 | 0.35 | 0.32 |
| #40 | 53.25 | 53.37 | 53.48 | 53.60 | 53.72 | 53.84 | 53.96 | 54.08 | 54.20 | 54.32 | 54.44 | 54.56 |
| — | 0.29 | 0.26 | 0.24 | 0.21 | 0.19 | 0.17 | 0.16 | 0.14 | 0.13 | 0.12 | 0.11 | 0.11 |
| #41 | 54.68 | 54.80 | 54.92 | 55.04 | 55.16 | 55.29 | 55.41 | 55.53 | 55.65 | 55.77 | 55.88 | 56.00 |
| — | 0.10 | 0.10 | 0.10 | 0.10 | 0.10 | 0.11 | 0.11 | 0.12 | 0.13 | 0.14 | 0.16 | 0.18 |
| #42 | 56.12 | 56.24 | 56.36 | 56.47 | 56.59 | 56.71 | 56.82 | 56.94 | 57.05 | 57.16 | 57.28 | 57.39 |
| — | 0.20 | 0.23 | 0.27 | 0.30 | 0.35 | 0.40 | 0.46 | 0.52 | 0.60 | 0.67 | 0.76 | 0.85 |
| #43 | 57.50 | 57.61 | 57.72 | 57.83 | 57.94 | 58.05 | 58.16 | 58.26 | 58.37 | 58.48 | 58.59 | 58.69 |
| — | 0.95 | 1.06 | 1.16 | 1.28 | 1.39 | 1.51 | 1.63 | 1.75 | 1.86 | 1.96 | 2.06 | 2.15 |
| #44 | 58.80 | 58.90 | 59.01 | 59.12 | 59.22 | 59.33 | 59.44 | 59.54 | 59.65 | 59.75 | 59.86 | 59.97 |
| — | 2.22 | 2.29 | 2.33 | 2.36 | 2.37 | 2.36 | 2.33 | 2.28 | 2.22 | 2.14 | 2.05 | 1.95 |
| #45 | 60.08 | 60.18 | 60.29 | 60.40 | 60.51 | 60.62 | 60.73 | 60.84 | 60.95 | 61.07 | 61.18 | 61.29 |
| — | 1.84 | 1.72 | 1.60 | 1.47 | 1.35 | 1.23 | 1.11 | 0.99 | 0.88 | 0.78 | 0.68 | 0.59 |
| #46 | 61.41 | 61.52 | 61.64 | 61.76 | 61.87 | 61.99 | 62.11 | 62.23 | 62.35 | 62.47 | 62.59 | 62.71 |
| — | 0.51 | 0.44 | 0.37 | 0.31 | 0.26 | 0.22 | 0.18 | 0.15 | 0.13 | 0.11 | 0.09 | 0.08 |
| #47 | 62.84 | 62.96 | 63.08 | 63.20 | 63.33 | 63.45 | 63.57 | 63.69 | 63.82 | 63.94 | 64.06 | 64.18 |
| — | 0.07 | 0.06 | 0.05 | 0.05 | 0.04 | 0.04 | 0.04 | 0.04 | 0.04 | 0.05 | 0.05 | 0.06 |
| #48 | 64.31 | 64.43 | 64.55 | 64.67 | 64.79 | 64.91 | 65.03 | 65.15 | 65.26 | 65.38 | 65.50 | 65.61 |
| — | 0.06 | 0.07 | 0.09 | 0.10 | 0.12 | 0.14 | 0.17 | 0.20 | 0.24 | 0.28 | 0.33 | 0.39 |
| #49 | 65.73 | 65.84 | 65.96 | 66.07 | 66.18 | 66.29 | 66.41 | 66.52 | 66.63 | 66.74 | 66.85 | 66.96 |
| — | 0.45 | 0.52 | 0.59 | 0.67 | 0.75 | 0.84 | 0.92 | 1.01 | 1.10 | 1.19 | 1.28 | 1.36 |
| #50 | 67.07 | 67.17 | 67.28 | 67.39 | 67.50 | 67.61 | 67.72 | 67.82 | 67.93 | 68.04 | 68.15 | 68.25 |
| — | 1.44 | 1.51 | 1.58 | 1.63 | 1.68 | 1.71 | 1.74 | 1.75 | 1.75 | 1.74 | 1.72 | 1.69 |
| #51 | 68.36 | 68.47 | 68.58 | 68.69 | 68.80 | 68.91 | 69.02 | 69.13 | 69.24 | 69.35 | 69.46 | 69.57 |
| — | 1.65 | 1.60 | 1.55 | 1.49 | 1.43 | 1.36 | 1.29 | 1.22 | 1.15 | 1.08 | 1.02 | 0.95 |
| #52 | 69.68 | 69.79 | 69.91 | 70.02 | 70.13 | 70.25 | 70.36 | 70.47 | 70.59 | 70.70 | 70.82 | 70.93 |
| — | 0.89 | 0.83 | 0.78 | 0.73 | 0.68 | 0.64 | 0.60 | 0.56 | 0.53 | 0.50 | 0.47 | 0.45 |
| #53 | 71.05 | 71.16 | 71.28 | 71.39 | 71.51 | 71.63 | 71.74 | 71.86 | 71.97 | 72.09 | 72.21 | 72.32 |
| — | 0.43 | 0.42 | 0.40 | 0.39 | 0.38 | 0.38 | 0.37 | 0.37 | 0.37 | 0.37 | 0.37 | 0.38 |
| #54 | 72.44 | 72.55 | 72.67 | 72.79 | 72.90 | 73.02 | 73.13 | 73.25 | 73.36 | 73.48 | 73.59 | 73.71 |
| — | 0.38 | 0.39 | 0.39 | 0.40 | 0.41 | 0.41 | 0.42 | 0.43 | 0.43 | 0.44 | 0.44 | 0.45 |
| #55 | 73.82 | 73.94 | 74.05 | 74.17 | 74.29 | 74.40 | 74.52 | 74.63 | 74.75 | 74.86 | 74.98 | 75.09 |
| — | 0.45 | 0.45 | 0.46 | 0.46 | 0.46 | 0.45 | 0.45 | 0.45 | 0.44 | 0.44 | 0.43 | 0.43 |
| #56 | 75.21 | 75.32 | 75.44 | 75.55 | 75.67 | 75.79 | 75.90 | 76.02 | 76.13 | 76.25 | 76.37 | 76.48 |
| — | 0.42 | 0.42 | 0.41 | 0.40 | 0.40 | 0.39 | 0.39 | 0.39 | 0.38 | 0.38 | 0.38 | 0.38 |
| #57 | 76.60 | 76.71 | 76.83 | 76.94 | 77.06 | 77.18 | 77.29 | 77.41 | 77.52 | 77.64 | 77.75 | 77.87 |
| — | 0.38 | 0.39 | 0.39 | 0.40 | 0.41 | 0.41 | 0.42 | 0.44 | 0.45 | 0.47 | 0.48 | 0.50 |
| #58 | 77.98 | 78.10 | 78.21 | 78.32 | 78.44 | 78.55 | 78.66 | 78.78 | 78.89 | 79.00 | 79.11 | 79.23 |
| — | 0.52 | 0.54 | 0.56 | 0.59 | 0.61 | 0.64 | 0.66 | 0.69 | 0.71 | 0.74 | 0.77 | 0.79 |
| #59 | 79.34 | 79.45 | 79.56 | 79.68 | 79.79 | 79.90 | 80.01 | 80.12 | 80.23 | 80.34 | 80.46 | 80.57 |
| — | 0.81 | 0.84 | 0.86 | 0.87 | 0.89 | 0.90 | 0.92 | 0.92 | 0.93 | 0.93 | 0.94 | 0.93 |
| #60 | 80.68 | 80.79 | 80.90 | 81.01 | 81.13 | 81.24 | 81.35 | 81.46 | 81.57 | 81.69 | 81.80 | 81.91 |
| — | 0.93 | 0.92 | 0.91 | 0.90 | 0.89 | 0.87 | 0.86 | 0.84 | 0.82 | 0.80 | 0.78 | 0.76 |

TABLE 6
Widths of the microstrip line

| | | | | | | | | | | | | |
|---|---|---|---|---|---|---|---|---|---|---|---|---|
| #61 | 82.02 | 82.14 | 82.25 | 82.36 | 82.47 | 82.59 | 82.70 | 82.82 | 82.93 | 83.04 | 83.16 | 83.27 |
| — | 0.75 | 0.73 | 0.71 | 0.69 | 0.67 | 0.66 | 0.64 | 0.63 | 0.62 | 0.60 | 0.59 | 0.59 |
| #62 | 83.38 | 83.50 | 83.61 | 83.73 | 83.84 | 83.95 | 84.07 | 84.18 | 84.30 | 84.41 | 84.53 | 84.64 |
| — | 0.58 | 0.57 | 0.56 | 0.56 | 0.56 | 0.55 | 0.55 | 0.55 | 0.55 | 0.55 | 0.55 | 0.55 |
| #63 | 84.75 | 84.87 | 84.98 | 85.10 | 85.21 | 85.33 | 85.44 | 85.55 | 85.67 | 85.78 | 85.90 | 86.01 |
| — | 0.55 | 0.55 | 0.56 | 0.56 | 0.56 | 0.56 | 0.56 | 0.56 | 0.56 | 0.56 | 0.56 | 0.56 |
| #64 | 86.12 | 86.24 | 86.35 | 86.47 | 86.58 | 86.70 | 86.81 | 86.92 | 87.04 | 87.15 | 87.27 | 87.38 |
| — | 0.55 | 0.55 | 0.55 | 0.54 | 0.54 | 0.53 | 0.52 | 0.52 | 0.51 | 0.50 | 0.50 | 0.49 |
| #65 | 87.50 | 87.61 | 87.73 | 87.84 | 87.96 | 88.07 | 88.19 | 88.30 | 88.42 | 88.53 | 88.65 | 88.77 |
| — | 0.48 | 0.47 | 0.47 | 0.46 | 0.46 | 0.45 | 0.44 | 0.44 | 0.44 | 0.43 | 0.43 | 0.43 |
| #66 | 88.88 | 89.00 | 89.11 | 89.23 | 89.34 | 89.46 | 89.57 | 89.69 | 89.80 | 89.92 | 90.03 | 90.15 |
| — | 0.43 | 0.43 | 0.43 | 0.44 | 0.44 | 0.45 | 0.45 | 0.46 | 0.47 | 0.48 | 0.49 | 0.50 |
| #67 | 90.26 | 90.38 | 90.49 | 90.60 | 90.72 | 90.83 | 90.95 | 91.06 | 91.17 | 91.29 | 91.40 | 91.51 |
| — | 0.51 | 0.52 | 0.53 | 0.54 | 0.56 | 0.57 | 0.59 | 0.60 | 0.61 | 0.63 | 0.64 | 0.65 |
| #68 | 91.63 | 91.74 | 91.85 | 91.97 | 92.08 | 92.19 | 92.31 | 92.42 | 92.53 | 92.64 | 92.76 | 92.87 |
| — | 0.67 | 0.68 | 0.69 | 0.70 | 0.71 | 0.72 | 0.72 | 0.73 | 0.73 | 0.74 | 0.74 | 0.74 |
| #69 | 92.98 | 93.09 | 93.21 | 93.32 | 93.43 | 93.55 | 93.66 | 93.77 | 93.88 | 94.00 | 94.11 | 94.22 |
| — | 0.74 | 0.74 | 0.73 | 0.73 | 0.73 | 0.72 | 0.72 | 0.71 | 0.70 | 0.70 | 0.69 | 0.68 |
| #70 | 94.34 | 94.45 | 94.56 | 94.68 | 94.79 | 94.90 | 95.02 | 95.13 | 95.24 | 95.36 | 95.47 | 95.58 |
| — | 0.68 | 0.67 | 0.66 | 0.66 | 0.65 | 0.65 | 0.64 | 0.64 | 0.63 | 0.63 | 0.63 | 0.62 |
| #71 | 95.70 | 95.81 | 95.93 | 96.04 | 96.15 | 96.27 | 96.38 | 96.49 | 96.61 | 96.72 | 96.83 | 96.95 |
| — | 0.62 | 0.62 | 0.62 | 0.62 | 0.62 | 0.62 | 0.62 | 0.62 | 0.62 | 0.62 | 0.63 | 0.63 |
| #72 | 97.06 | 97.18 | 97.29 | 97.40 | 97.52 | 97.63 | 97.74 | 97.86 | 97.97 | 98.08 | 98.20 | 98.31 |
| — | 0.63 | 0.63 | 0.63 | 0.63 | 0.63 | 0.63 | 0.63 | 0.63 | 0.62 | 0.62 | 0.62 | 0.61 |
| #73 | 98.42 | 98.54 | 98.65 | 98.77 | 98.88 | 98.99 | 99.11 | 99.22 | 99.34 | 99.45 | 99.57 | 99.68 |
| — | 0.61 | 0.60 | 0.60 | 0.59 | 0.58 | 0.58 | 0.57 | 0.56 | 0.55 | 0.55 | 0.54 | 0.53 |
| #74 | 99.79 | 99.91 | 100.02 | 100.14 | 100.25 | 100.37 | 100.48 | 100.60 | 100.71 | 100.83 | 100.94 | 101.06 |
| — | 0.52 | 0.51 | 0.51 | 0.50 | 0.49 | 0.49 | 0.48 | 0.48 | 0.48 | 0.47 | 0.47 | 0.47 |
| #75 | 101.17 | 101.29 | 101.40 | 101.52 | 101.63 | 101.75 | 101.86 | 101.98 | 102.09 | 102.21 | 102.32 | 102.44 |
| — | 0.47 | 0.47 | 0.47 | 0.47 | 0.47 | 0.47 | 0.48 | 0.48 | 0.49 | 0.49 | 0.50 | 0.50 |
| #76 | 102.55 | 102.66 | 102.78 | 102.89 | 103.01 | 103.12 | 103.24 | 103.35 | 103.46 | 103.58 | 103.69 | 103.81 |
| — | 0.51 | 0.52 | 0.53 | 0.53 | 0.54 | 0.55 | 0.56 | 0.57 | 0.58 | 0.58 | 0.59 | 0.60 |
| #77 | 103.92 | 104.03 | 104.15 | 104.26 | 104.37 | 104.49 | 104.60 | 104.71 | 104.83 | 104.94 | 105.05 | 105.17 |
| — | 0.61 | 0.61 | 0.62 | 0.62 | 0.63 | 0.63 | 0.64 | 0.64 | 0.64 | 0.64 | 0.64 | 0.65 |
| #78 | 105.28 | 105.39 | 105.51 | 105.62 | 105.74 | 105.85 | 105.96 | 106.08 | 106.19 | 106.30 | 106.42 | 106.53 |
| — | 0.65 | 0.65 | 0.64 | 0.64 | 0.64 | 0.64 | 0.64 | 0.64 | 0.63 | 0.63 | 0.63 | 0.63 |
| #79 | 106.64 | 106.76 | 106.87 | 106.98 | 107.10 | 107.21 | 107.32 | 107.44 | 107.55 | 107.67 | 107.78 | 107.89 |
| — | 0.63 | 0.63 | 0.62 | 0.62 | 0.62 | 0.62 | 0.62 | 0.62 | 0.63 | 0.63 | 0.63 | 0.63 |
| #80 | 108.01 | 108.12 | 108.23 | 108.35 | 108.46 | 108.57 | 108.69 | 108.80 | 108.91 | 109.03 | 109.14 | 109.25 |
| — | 0.63 | 0.64 | 0.64 | 0.64 | 0.64 | 0.65 | 0.65 | 0.65 | 0.66 | 0.66 | 0.66 | 0.66 |
| #81 | 109.37 | 109.48 | 109.59 | 109.71 | 109.82 | 109.93 | 110.05 | 110.16 | 110.27 | 110.39 | 110.50 | 110.61 |
| — | 0.66 | 0.67 | 0.67 | 0.67 | 0.67 | 0.66 | 0.66 | 0.66 | 0.66 | 0.66 | 0.65 | 0.65 |
| #82 | 110.73 | 110.84 | 110.95 | 111.07 | 111.18 | 111.29 | 111.41 | 111.52 | 111.64 | 111.75 | 111.86 | 111.98 |
| — | 0.64 | 0.64 | 0.63 | 0.62 | 0.62 | 0.61 | 0.60 | 0.60 | 0.59 | 0.58 | 0.57 | 0.57 |
| #83 | 112.09 | 112.21 | 112.32 | 112.43 | 112.55 | 112.66 | 112.78 | 112.89 | 113.01 | 113.12 | 113.24 | 113.35 |
| — | 0.56 | 0.55 | 0.55 | 0.54 | 0.54 | 0.53 | 0.53 | 0.52 | 0.52 | 0.52 | 0.51 | 0.51 |
| #84 | 113.46 | 113.58 | 113.69 | 113.81 | 113.92 | | | | | | | |
| — | 0.51 | 0.51 | 0.51 | 0.51 | 0.51 | | | | | | | |

FIG. 11 shows the shape of the microstrip line 5 in the reflection-type bandpass filter 1 of the second embodiment. A non-reflecting terminator, or an R=50Ω resistance, is provided at the terminating side (the face at z=113.92 mm) of the reflection-type bandpass filter 1. The thickness of the metal films used in the conducting layer 3 and of the conductor constituting the microstrip line 5 should be adequately greater than the skin depth δs=√{2/(ωμ0σ)} at f=1 GHz. For example if copper is used, the thickness of the conducting layer 3 and of the conductor of the microstrip line 5 should be taken as 2.1 μm or greater. This reflection-type bandpass filter is used in a system where the characteristic impedance is 50Ω.

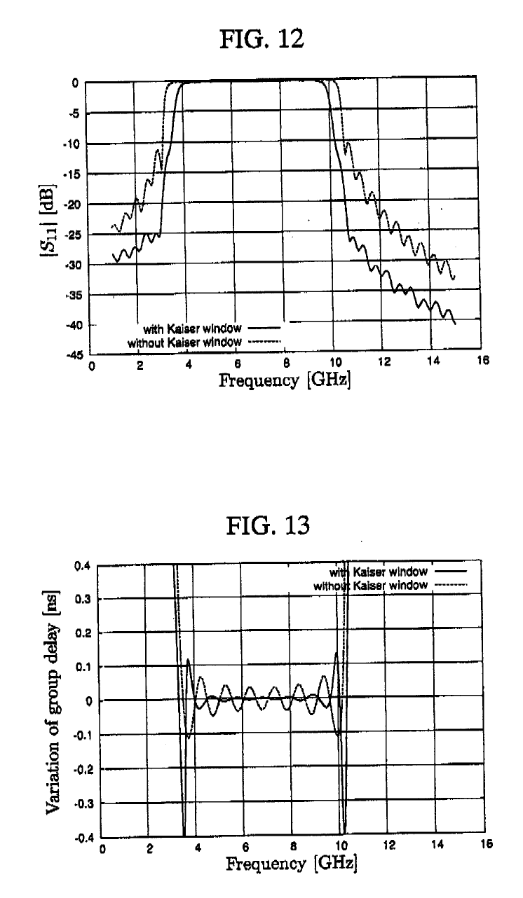

FIG. 12 and FIG. 13 express the amplitude characteristics and group delay frequency characteristics respectively of the reflective wave (S11) in the bandpass filter of the second embodiment. For comparison, the characteristics when the Kaiser window is not used, are also shown. As shown in the figures, in the region of frequency f for which 4.0 GHz≦f≦9.8 GHz, the reflectivity is −2 dB or greater and the variation of the group delay is within ±0.03 ns. In the region f<3.1 GHz and f>10.6 GHz, the reflectivity is −20 dB or lower. Compared to the case when the Kaiser window is not used, the region of transition frequency becomes wider, but the stop band rejection increases to 18 dB, and the variation of group delay within the pass band decreases.

### Embodiment 3

A Kaiser window was used for which the reflectivity is 1 at the frequency f in the region 3.4 GHz≦f≦10.3 GHz, and is 0 elsewhere, and for which A=25. Taking one wavelength at frequency f=1 GHz of the signal transmitted within the microstrip line as the waveguide length, the system characteristic impedance was taken as 30Ω, and the design was carried out.

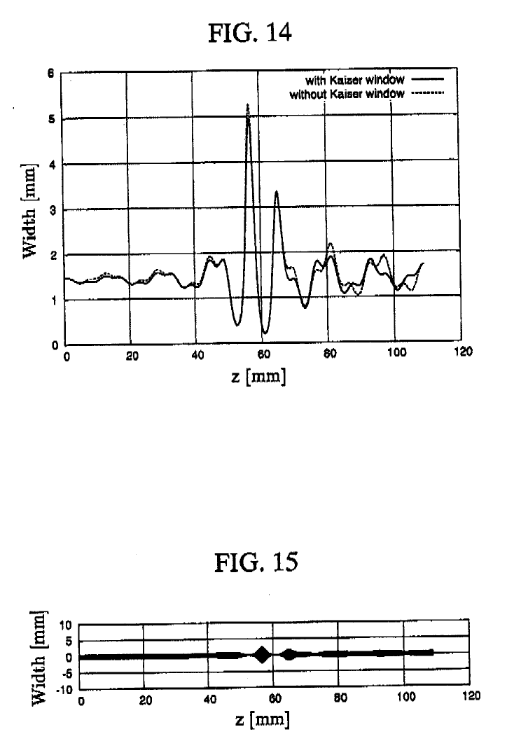

FIG. 14 shows the distribution of the width w of the microstrip line 5 in the z-axis direction when a dielectric layer 4 of thickness h=0.635 mm, and relative dielectric constant ∈ᵣ=10.2 (for example, RT/duroid (registered trademark) 6010LM) was used, together with the width when the Kaiser window was not used. Tables 7 through 9 list the widths w of the microstrip line 5 when the Kaiser window was used.

TABLE 7
Widths of the microstrip line

| | z[mm] | | | | | | | | | | | |
|---|---|---|---|---|---|---|---|---|---|---|---|---|
| | 0.00 | 0.11 | 0.22 | 0.33 | 0.44 | 0.54 | 0.65 | 0.76 | 0.87 | 0.98 | 1.09 | 1.20 |
| | w[mm] | | | | | | | | | | | |
| | 1.47 | 1.47 | 1.47 | 1.47 | 1.47 | 1.47 | 1.47 | 1.47 | 1.47 | 1.47 | 1.47 | 1.47 |
| #2 | 1.31 | 1.42 | 1.52 | 1.63 | 1.74 | 1.85 | 1.96 | 2.07 | 2.18 | 2.29 | 2.40 | 2.50 |
| — | 1.47 | 1.47 | 1.47 | 1.47 | 1.47 | 1.46 | 1.46 | 1.46 | 1.45 | 1.45 | 1.45 | 1.44 |
| #3 | 2.61 | 2.72 | 2.83 | 2.94 | 3.05 | 3.16 | 3.27 | 3.38 | 3.49 | 3.59 | 3.70 | 3.81 |
| — | 1.44 | 1.44 | 1.43 | 1.43 | 1.42 | 1.42 | 1.42 | 1.41 | 1.41 | 1.40 | 1.40 | 1.40 |
| #4 | 3.92 | 4.03 | 4.14 | 4.25 | 4.36 | 4.47 | 4.58 | 4.69 | 4.80 | 4.90 | 5.01 | 5.12 |
| — | 1.40 | 1.39 | 1.39 | 1.39 | 1.39 | 1.39 | 1.39 | 1.39 | 1.39 | 1.39 | 1.39 | 1.39 |
| #5 | 5.23 | 5.34 | 5.45 | 5.56 | 5.67 | 5.78 | 5.89 | 6.00 | 6.11 | 6.21 | 6.32 | 6.43 |
| — | 1.39 | 1.39 | 1.39 | 1.39 | 1.39 | 1.39 | 1.40 | 1.40 | 1.40 | 1.40 | 1.40 | 1.40 |
| #6 | 6.54 | 6.65 | 6.76 | 6.87 | 6.98 | 7.09 | 7.20 | 7.31 | 7.42 | 7.52 | 7.63 | 7.74 |
| — | 1.40 | 1.41 | 1.41 | 1.41 | 1.41 | 1.41 | 1.41 | 1.41 | 1.41 | 1.41 | 1.41 | 1.40 |
| #7 | 7.85 | 7.96 | 8.07 | 8.18 | 8.29 | 8.40 | 8.51 | 8.62 | 8.72 | 8.83 | 8.94 | 9.05 |
| — | 1.40 | 1.40 | 1.40 | 1.40 | 1.40 | 1.40 | 1.40 | 1.40 | 1.40 | 1.40 | 1.40 | 1.40 |
| #8 | 9.16 | 9.27 | 9.38 | 9.49 | 9.60 | 9.71 | 9.82 | 9.93 | 10.03 | 10.14 | 10.25 | 10.36 |
| — | 1.40 | 1.40 | 1.40 | 1.41 | 1.41 | 1.41 | 1.41 | 1.42 | 1.42 | 1.43 | 1.43 | 1.43 |
| #9 | 10.47 | 10.58 | 10.69 | 10.80 | 10.91 | 11.02 | 11.12 | 11.23 | 11.34 | 11.45 | 11.56 | 11.67 |
| — | 1.44 | 1.44 | 1.45 | 1.46 | 1.46 | 1.47 | 1.47 | 1.48 | 1.48 | 1.49 | 1.49 | 1.50 |
| #10 | 11.78 | 11.89 | 11.99 | 12.10 | 12.21 | 12.32 | 12.43 | 12.54 | 12.65 | 12.75 | 12.86 | 12.97 |
| — | 1.50 | 1.50 | 1.51 | 1.51 | 1.51 | 1.52 | 1.52 | 1.52 | 1.52 | 1.52 | 1.52 | 1.52 |
| #11 | 13.08 | 13.19 | 13.30 | 13.41 | 13.52 | 13.62 | 13.73 | 13.84 | 13.95 | 14.06 | 14.17 | 14.28 |
| — | 1.52 | 1.52 | 1.51 | 1.51 | 1.51 | 1.51 | 1.51 | 1.50 | 1.50 | 1.50 | 1.50 | 1.50 |
| #12 | 14.39 | 14.49 | 14.60 | 14.71 | 14.82 | 14.93 | 15.04 | 15.15 | 15.26 | 15.36 | 15.47 | 15.58 |
| — | 1.49 | 1.49 | 1.49 | 1.49 | 1.49 | 1.49 | 1.49 | 1.49 | 1.49 | 1.49 | 1.49 | 1.49 |
| #13 | 15.69 | 15.80 | 15.91 | 16.02 | 16.13 | 16.23 | 16.34 | 16.45 | 16.56 | 16.67 | 16.78 | 16.89 |
| — | 1.49 | 1.50 | 1.50 | 1.50 | 1.50 | 1.50 | 1.50 | 1.50 | 1.50 | 1.50 | 1.50 | 1.50 |
| #14 | 17.00 | 17.10 | 17.21 | 17.32 | 17.43 | 17.54 | 17.65 | 17.76 | 17.87 | 17.97 | 18.08 | 18.19 |
| — | 1.50 | 1.50 | 1.50 | 1.50 | 1.49 | 1.49 | 1.49 | 1.48 | 1.48 | 1.47 | 1.47 | 1.46 |
| #15 | 18.30 | 18.41 | 18.52 | 18.53 | 18.74 | 18.85 | 18.96 | 19.06 | 19.17 | 19.28 | 19.39 | 19.50 |
| — | 1.45 | 1.45 | 1.44 | 1.43 | 1.42 | 1.42 | 1.41 | 1.40 | 1.40 | 1.39 | 1.38 | 1.38 |
| #16 | 19.61 | 19.72 | 19.83 | 19.94 | 20.05 | 20.16 | 20.27 | 20.38 | 20.49 | 20.60 | 20.70 | 20.81 |
| — | 1.37 | 1.37 | 1.36 | 1.36 | 1.35 | 1.35 | 1.35 | 1.35 | 1.35 | 1.35 | 1.35 | 1.35 |
| #17 | 20.92 | 21.03 | 21.14 | 21.25 | 21.36 | 21.47 | 21.58 | 21.69 | 21.80 | 21.91 | 22.02 | 22.13 |
| — | 1.35 | 1.35 | 1.35 | 1.35 | 1.35 | 1.36 | 1.36 | 1.36 | 1.36 | 1.37 | 1.37 | 1.37 |
| #18 | 22.23 | 22.34 | 22.45 | 22.56 | 22.67 | 22.78 | 22.89 | 23.00 | 23.11 | 23.22 | 23.33 | 23.44 |
| — | 1.37 | 1.37 | 1.38 | 1.38 | 1.38 | 1.38 | 1.38 | 1.38 | 1.38 | 1.38 | 1.38 | 1.38 |
| #19 | 23.55 | 23.66 | 23.76 | 23.87 | 23.98 | 24.09 | 24.20 | 24.31 | 24.42 | 24.53 | 24.64 | 24.75 |
| — | 1.37 | 1.37 | 1.37 | 1.37 | 1.37 | 1.37 | 1.36 | 1.36 | 1.36 | 1.36 | 1.36 | 1.36 |
| #20 | 24.86 | 24.97 | 25.08 | 25.19 | 25.29 | 25.40 | 25.51 | 25.62 | 25.73 | 25.84 | 25.95 | 26.06 |
| — | 1.36 | 1.36 | 1.36 | 1.37 | 1.37 | 1.37 | 1.38 | 1.38 | 1.39 | 1.39 | 1.40 | 1.41 |
| #21 | 26.17 | 26.28 | 26.39 | 26.49 | 26.60 | 26.71 | 26.82 | 26.93 | 27.04 | 27.15 | 27.26 | 27.37 |
| — | 1.42 | 1.43 | 1.44 | 1.45 | 1.46 | 1.47 | 1.48 | 1.49 | 1.50 | 1.51 | 1.52 | 1.53 |
| #22 | 27.47 | 27.58 | 27.69 | 27.80 | 27.91 | 28.02 | 28.12 | 28.23 | 28.34 | 28.45 | 28.56 | 28.67 |
| — | 1.53 | 1.54 | 1.55 | 1.56 | 1.56 | 1.57 | 1.57 | 1.58 | 1.58 | 1.58 | 1.58 | 1.58 |
| #23 | 28.78 | 28.88 | 28.99 | 29.10 | 29.21 | 29.32 | 29.43 | 29.53 | 29.64 | 29.75 | 29.86 | 29.97 |
| — | 1.58 | 1.58 | 1.58 | 1.58 | 1.57 | 1.57 | 1.57 | 1.56 | 1.56 | 1.56 | 1.55 | 1.55 |
| #24 | 30.08 | 30.19 | 30.29 | 30.40 | 30.51 | 30.62 | 30.73 | 30.84 | 30.95 | 31.05 | 31.16 | 31.27 |
| — | 1.55 | 1.54 | 1.54 | 1.54 | 1.54 | 1.53 | 1.53 | 1.53 | 1.53 | 1.54 | 1.54 | 1.54 |
| #25 | 31.38 | 31.49 | 31.60 | 31.71 | 31.81 | 31.92 | 32.03 | 32.14 | 32.25 | 32.36 | 32.47 | 32.57 |
| — | 1.54 | 1.54 | 1.55 | 1.55 | 1.55 | 1.56 | 1.56 | 1.56 | 1.56 | 1.57 | 1.57 | 1.57 |
| #26 | 32.68 | 32.79 | 32.90 | 33.01 | 33.12 | 33.23 | 33.33 | 33.44 | 33.55 | 33.66 | 33.77 | 33.88 |
| — | 1.57 | 1.57 | 1.56 | 1.56 | 1.56 | 1.55 | 1.55 | 1.54 | 1.53 | 1.52 | 1.51 | 1.50 |
| #27 | 33.99 | 34.10 | 34.20 | 34.31 | 34.42 | 34.53 | 34.64 | 34.75 | 34.86 | 34.97 | 35.08 | 35.19 |
| — | 1.49 | 1.47 | 1.46 | 1.45 | 1.43 | 1.42 | 1.40 | 1.39 | 1.38 | 1.36 | 1.35 | 1.33 |
| #28 | 35.30 | 35.41 | 35.52 | 35.62 | 35.73 | 35.84 | 35.95 | 36.06 | 36.17 | 36.28 | 36.39 | 36.50 |
| — | 1.32 | 1.31 | 1.30 | 1.29 | 1.28 | 1.27 | 1.27 | 1.26 | 1.26 | 1.25 | 1.25 | 1.25 |
| #29 | 36.61 | 36.72 | 36.83 | 36.94 | 37.05 | 37.16 | 37.27 | 37.38 | 37.49 | 37.60 | 37.71 | 37.82 |
| — | 1.25 | 1.25 | 1.25 | 1.25 | 1.26 | 1.26 | 1.26 | 1.27 | 1.27 | 1.28 | 1.28 | 1.29 |
| #30 | 37.93 | 38.04 | 38.15 | 38.26 | 38.37 | 38.48 | 38.59 | 38.70 | 38.81 | 38.92 | 39.02 | 39.13 |
| — | 1.29 | 1.30 | 1.30 | 1.30 | 1.31 | 1.31 | 1.31 | 1.31 | 1.31 | 1.31 | 1.31 | 1.30 |

TABLE 8
Widths of the microstrip line

| | | | | | | | | | | | | |
|---|---|---|---|---|---|---|---|---|---|---|---|---|
| #31 | 39.24 | 39.35 | 39.46 | 39.57 | 39.68 | 39.79 | 39.90 | 40.01 | 40.12 | 40.23 | 40.34 | 40.45 |
| — | 1.30 | 1.30 | 1.29 | 1.29 | 1.28 | 1.28 | 1.28 | 1.27 | 1.27 | 1.26 | 1.26 | 1.26 |
| #32 | 40.56 | 40.67 | 40.78 | 40.89 | 41.00 | 41.11 | 41.22 | 41.33 | 41.44 | 41.55 | 41.66 | 41.77 |
| — | 1.26 | 1.26 | 1.26 | 1.26 | 1.27 | 1.27 | 1.28 | 1.29 | 1.30 | 1.31 | 1.33 | 1.34 |
| #33 | 41.88 | 41.98 | 42.09 | 42.20 | 42.31 | 42.42 | 42.53 | 42.64 | 42.75 | 42.85 | 42.96 | 43.07 |
| — | 1.36 | 1.38 | 1.40 | 1.42 | 1.45 | 1.47 | 1.50 | 1.52 | 1.55 | 1.58 | 1.61 | 1.63 |
| #34 | 43.18 | 43.29 | 43.40 | 43.50 | 43.61 | 43.72 | 43.83 | 43.93 | 44.04 | 44.15 | 44.26 | 44.36 |
| — | 1.66 | 1.69 | 1.71 | 1.73 | 1.76 | 1.78 | 1.79 | 1.81 | 1.82 | 1.83 | 1.84 | 1.85 |
| #35 | 44.47 | 44.58 | 44.69 | 44.79 | 44.90 | 45.01 | 45.12 | 45.23 | 45.33 | 45.44 | 45.55 | 45.66 |
| — | 1.85 | 1.85 | 1.85 | 1.85 | 1.84 | 1.83 | 1.83 | 1.82 | 1.80 | 1.79 | 1.78 | 1.77 |
| #36 | 45.76 | 45.87 | 45.98 | 46.09 | 46.20 | 46.30 | 46.41 | 46.52 | 46.63 | 46.74 | 46.84 | 46.95 |
| — | 1.76 | 1.75 | 1.74 | 1.73 | 1.72 | 1.72 | 1.71 | 1.71 | 1.71 | 1.71 | 1.72 | 1.72 |
| #37 | 47.06 | 47.17 | 47.27 | 47.38 | 47.49 | 47.60 | 47.71 | 47.81 | 47.92 | 48.03 | 48.14 | 48.24 |
| — | 1.73 | 1.74 | 1.75 | 1.76 | 1.77 | 1.79 | 1.80 | 1.81 | 1.83 | 1.84 | 1.85 | 1.86 |
| #38 | 48.35 | 48.46 | 48.57 | 48.67 | 48.78 | 48.89 | 49.00 | 49.10 | 49.21 | 49.32 | 49.43 | 49.54 |
| — | 1.87 | 1.87 | 1.87 | 1.86 | 1.85 | 1.84 | 1.82 | 1.80 | 1.77 | 1.73 | 1.69 | 1.64 |
| #39 | 49.64 | 49.75 | 49.86 | 49.97 | 50.08 | 50.19 | 50.30 | 50.41 | 50.52 | 50.63 | 50.74 | 50.85 |
| — | 1.59 | 1.54 | 1.48 | 1.42 | 1.35 | 1.29 | 1.22 | 1.15 | 1.09 | 1.02 | 0.96 | 0.89 |
| #40 | 50.97 | 51.08 | 51.19 | 51.30 | 51.42 | 51.53 | 51.65 | 51.76 | 51.88 | 51.99 | 52.11 | 52.22 |
| — | 0.84 | 0.78 | 0.72 | 0.67 | 0.63 | 0.59 | 0.55 | 0.52 | 0.49 | 0.46 | 0.44 | 0.43 |
| #41 | 52.34 | 52.45 | 52.57 | 52.68 | 52.80 | 52.92 | 53.03 | 53.15 | 53.26 | 53.38 | 53.49 | 53.60 |
| — | 0.41 | 0.41 | 0.40 | 0.40 | 0.41 | 0.42 | 0.44 | 0.46 | 0.48 | 0.52 | 0.56 | 0.60 |
| #42 | 53.72 | 53.83 | 53.94 | 54.05 | 54.16 | 54.28 | 54.39 | 54.49 | 54.60 | 54.71 | 54.82 | 54.93 |
| — | 0.66 | 0.72 | 0.79 | 0.88 | 0.97 | 1.07 | 1.18 | 1.31 | 1.45 | 1.60 | 1.76 | 1.94 |
| #43 | 55.03 | 55.14 | 55.25 | 55.35 | 55.46 | 55.56 | 55.66 | 55.77 | 55.87 | 55.97 | 56.08 | 56.18 |
| — | 2.12 | 2.32 | 2.53 | 2.75 | 2.97 | 3.20 | 3.43 | 3.66 | 3.88 | 4.09 | 4.29 | 4.47 |
| #44 | 56.28 | 56.38 | 56.49 | 56.59 | 56.69 | 56.79 | 56.89 | 57.00 | 57.10 | 57.20 | 57.30 | 57.41 |
| — | 4.62 | 4.75 | 4.85 | 4.91 | 4.94 | 4.93 | 4.88 | 4.79 | 4.68 | 4.53 | 4.36 | 4.16 |
| #45 | 57.51 | 57.61 | 57.72 | 57.82 | 57.93 | 58.03 | 58.14 | 58.24 | 58.35 | 58.46 | 58.57 | 58.68 |
| — | 3.94 | 3.71 | 3.48 | 3.23 | 2.99 | 2.75 | 2.52 | 2.29 | 2.08 | 1.88 | 1.69 | 1.51 |
| #46 | 58.78 | 58.89 | 59.01 | 59.12 | 59.23 | 59.34 | 59.46 | 59.57 | 59.68 | 59.80 | 59.92 | 60.03 |
| — | 1.35 | 1.20 | 1.06 | 0.94 | 0.83 | 0.73 | 0.64 | 0.56 | 0.49 | 0.44 | 0.39 | 0.34 |
| #47 | 60.15 | 60.27 | 60.38 | 60.50 | 60.62 | 60.74 | 60.86 | 60.97 | 61.09 | 61.21 | 61.33 | 61.45 |
| — | 0.31 | 0.28 | 0.26 | 0.24 | 0.23 | 0.22 | 0.22 | 0.22 | 0.22 | 0.23 | 0.24 | 0.26 |
| #48 | 61.56 | 61.68 | 61.80 | 61.91 | 62.03 | 62.14 | 62.26 | 62.37 | 62.48 | 62.60 | 62.71 | 62.82 |
| — | 0.28 | 0.30 | 0.34 | 0.38 | 0.42 | 0.47 | 0.53 | 0.60 | 0.68 | 0.76 | 0.86 | 0.96 |
| #49 | 62.93 | 63.04 | 63.15 | 63.26 | 63.37 | 63.48 | 63.58 | 63.69 | 63.80 | 63.90 | 64.01 | 64.11 |
| — | 1.07 | 1.19 | 1.32 | 1.45 | 1.59 | 1.74 | 1.89 | 2.04 | 2.19 | 2.35 | 2.49 | 2.64 |
| #50 | 64.22 | 64.32 | 64.43 | 64.53 | 64.64 | 64.74 | 64.85 | 64.95 | 65.05 | 65.16 | 65.26 | 65.37 |
| — | 2.77 | 2.90 | 3.01 | 3.11 | 3.19 | 3.26 | 3.31 | 3.34 | 3.35 | 3.34 | 3.32 | 3.28 |
| #51 | 65.47 | 65.58 | 65.68 | 65.78 | 65.89 | 65.99 | 66.10 | 66.21 | 66.31 | 66.42 | 66.52 | 66.63 |
| — | 3.22 | 3.16 | 3.08 | 2.99 | 2.90 | 2.80 | 2.70 | 2.59 | 2.49 | 2.39 | 2.29 | 2.20 |
| #52 | 66.74 | 66.84 | 66.95 | 67.06 | 67.17 | 67.27 | 67.38 | 67.49 | 67.60 | 67.71 | 67.82 | 67.93 |
| — | 2.11 | 2.02 | 1.94 | 1.87 | 1.80 | 1.73 | 1.68 | 1.63 | 1.58 | 1.54 | 1.51 | 1.48 |
| #53 | 68.03 | 68.14 | 68.25 | 68.36 | 68.47 | 68.58 | 68.69 | 68.80 | 68.91 | 69.02 | 69.13 | 69.23 |
| — | 1.46 | 1.44 | 1.42 | 1.41 | 1.40 | 1.40 | 1.40 | 1.40 | 1.40 | 1.40 | 1.40 | 1.41 |
| #54 | 69.34 | 69.45 | 69.56 | 69.67 | 69.78 | 69.89 | 70.00 | 70.11 | 70.22 | 70.33 | 70.43 | 70.54 |
| — | 1.41 | 1.41 | 1.42 | 1.42 | 1.42 | 1.41 | 1.41 | 1.40 | 1.39 | 1.37 | 1.35 | 1.33 |
| #55 | 70.65 | 70.76 | 70.87 | 70.98 | 71.09 | 71.20 | 71.31 | 71.42 | 71.53 | 71.65 | 71.76 | 71.87 |
| — | 1.31 | 1.29 | 1.26 | 1.23 | 1.20 | 1.17 | 1.14 | 1.11 | 1.07 | 1.04 | 1.01 | 0.98 |
| #56 | 71.98 | 72.09 | 72.20 | 72.31 | 72.43 | 72.54 | 72.65 | 72.76 | 72.87 | 72.99 | 73.10 | 73.21 |
| — | 0.95 | 0.93 | 0.90 | 0.88 | 0.86 | 0.84 | 0.83 | 0.82 | 0.81 | 0.81 | 0.81 | 0.81 |
| #57 | 73.32 | 73.44 | 73.55 | 73.66 | 73.77 | 73.88 | 73.99 | 74.11 | 74.22 | 74.33 | 74.44 | 74.55 |
| — | 0.81 | 0.82 | 0.83 | 0.85 | 0.86 | 0.89 | 0.91 | 0.94 | 0.97 | 1.00 | 1.04 | 1.08 |
| #58 | 74.66 | 74.77 | 74.88 | 74.99 | 75.10 | 75.21 | 75.32 | 75.43 | 75.54 | 75.64 | 75.75 | 75.86 |
| — | 1.12 | 1.16 | 1.21 | 1.25 | 1.30 | 1.35 | 1.39 | 1.44 | 1.48 | 1.53 | 1.57 | 1.61 |
| #59 | 75.97 | 76.08 | 76.19 | 76.29 | 76.40 | 76.51 | 76.62 | 76.72 | 76.83 | 76.94 | 77.05 | 77.16 |
| — | 1.64 | 1.68 | 1.71 | 1.73 | 1.76 | 1.77 | 1.79 | 1.80 | 1.81 | 1.81 | 1.81 | 1.81 |
| #60 | 77.26 | 77.37 | 77.48 | 77.59 | 77.69 | 77.80 | 77.91 | 78.02 | 78.13 | 78.23 | 78.34 | 78.45 |
| — | 1.80 | 1.79 | 1.79 | 1.77 | 1.76 | 1.75 | 1.74 | 1.73 | 1.72 | 1.70 | 1.70 | 1.69 |

TABLE 9
Widths of the microstrip line

| | | | | | | | | | | | | |
|---|---|---|---|---|---|---|---|---|---|---|---|---|
| #61 | 78.56 | 78.67 | 78.77 | 78.88 | 78.99 | 79.10 | 79.21 | 79.31 | 79.42 | 79.53 | 79.64 | 79.75 |
| — | 1.68 | 1.68 | 1.67 | 1.67 | 1.68 | 1.68 | 1.69 | 1.69 | 1.70 | 1.72 | 1.73 | 1.74 |
| #62 | 79.85 | 79.96 | 80.07 | 80.18 | 80.28 | 80.39 | 80.50 | 80.61 | 80.71 | 80.82 | 80.93 | 81.04 |
| — | 1.76 | 1.78 | 1.79 | 1.81 | 1.83 | 1.84 | 1.86 | 1.87 | 1.88 | 1.89 | 1.90 | 1.90 |
| #63 | 81.14 | 81.25 | 81.36 | 81.47 | 81.57 | 81.68 | 81.79 | 81.90 | 82.00 | 82.11 | 82.22 | 82.33 |
| — | 1.90 | 1.90 | 1.89 | 1.89 | 1.87 | 1.86 | 1.84 | 1.81 | 1.79 | 1.76 | 1.73 | 1.69 |
| #64 | 82.44 | 82.54 | 82.65 | 82.76 | 82.87 | 82.98 | 83.09 | 83.20 | 83.31 | 83.42 | 83.53 | 83.64 |
| — | 1.66 | 1.62 | 1.59 | 1.55 | 1.51 | 1.47 | 1.43 | 1.40 | 1.36 | 1.33 | 1.30 | 1.26 |
| #65 | 83.75 | 83.85 | 83.97 | 84.08 | 84.19 | 84.30 | 84.41 | 84.52 | 84.63 | 84.74 | 84.85 | 84.96 |
| — | 1.24 | 1.21 | 1.19 | 1.17 | 1.15 | 1.13 | 1.12 | 1.11 | 1.10 | 1.09 | 1.09 | 1.09 |
| #66 | 85.07 | 85.18 | 85.29 | 85.40 | 85.51 | 85.62 | 85.73 | 85.84 | 85.95 | 86.06 | 86.17 | 86.28 |
| — | 1.09 | 1.09 | 1.09 | 1.10 | 1.11 | 1.12 | 1.13 | 1.14 | 1.15 | 1.16 | 1.18 | 1.19 |
| #67 | 86.39 | 86.50 | 86.61 | 86.72 | 86.83 | 86.94 | 87.05 | 87.16 | 87.27 | 87.38 | 87.49 | 87.60 |
| — | 1.20 | 1.22 | 1.23 | 1.24 | 1.25 | 1.26 | 1.27 | 1.28 | 1.28 | 1.29 | 1.29 | 1.29 |
| #68 | 87.71 | 87.82 | 87.93 | 88.04 | 88.15 | 88.26 | 88.37 | 88.48 | 88.59 | 88.70 | 88.81 | 88.92 |
| — | 1.29 | 1.29 | 1.29 | 1.29 | 1.28 | 1.28 | 1.27 | 1.27 | 1.26 | 1.26 | 1.26 | 1.25 |
| #69 | 89.03 | 89.14 | 89.25 | 89.36 | 89.47 | 89.58 | 89.69 | 89.80 | 89.90 | 90.01 | 90.12 | 90.23 |
| — | 1.25 | 1.25 | 1.25 | 1.25 | 1.25 | 1.25 | 1.26 | 1.27 | 1.28 | 1.29 | 1.30 | 1.31 |
| #70 | 90.34 | 90.45 | 90.56 | 90.67 | 90.78 | 90.89 | 91.00 | 91.11 | 91.22 | 91.32 | 91.43 | 91.54 |
| — | 1.33 | 1.35 | 1.37 | 1.39 | 1.42 | 1.44 | 1.47 | 1.49 | 1.52 | 1.55 | 1.58 | 1.61 |
| #71 | 91.65 | 91.76 | 91.86 | 91.97 | 92.08 | 92.19 | 92.30 | 92.40 | 92.51 | 92.62 | 92.73 | 92.83 |
| — | 1.64 | 1.66 | 1.69 | 1.71 | 1.74 | 1.76 | 1.78 | 1.80 | 1.81 | 1.82 | 1.83 | 1.84 |
| #72 | 92.94 | 93.05 | 93.16 | 93.26 | 93.37 | 93.48 | 93.59 | 93.70 | 93.80 | 93.91 | 94.02 | 94.13 |
| — | 1.84 | 1.84 | 1.84 | 1.83 | 1.83 | 1.82 | 1.80 | 1.79 | 1.77 | 1.76 | 1.74 | 1.72 |
| #73 | 94.23 | 94.34 | 94.45 | 94.56 | 94.67 | 94.78 | 94.88 | 94.99 | 95.10 | 95.21 | 95.32 | 95.43 |
| — | 1.70 | 1.68 | 1.66 | 1.64 | 1.62 | 1.61 | 1.59 | 1.57 | 1.56 | 1.55 | 1.53 | 1.52 |
| #74 | 95.54 | 95.64 | 95.75 | 95.86 | 95.97 | 96.08 | 96.19 | 96.30 | 96.41 | 96.51 | 96.62 | 96.73 |
| — | 1.51 | 1.51 | 1.50 | 1.50 | 1.49 | 1.49 | 1.49 | 1.49 | 1.49 | 1.49 | 1.49 | 1.50 |
| #75 | 96.84 | 96.95 | 97.06 | 97.17 | 97.28 | 97.38 | 97.49 | 97.60 | 97.71 | 97.82 | 97.93 | 98.04 |
| — | 1.50 | 1.50 | 1.50 | 1.51 | 1.51 | 1.51 | 1.51 | 1.50 | 1.50 | 1.50 | 1.49 | 1.49 |
| #76 | 98.15 | 98.25 | 98.36 | 98.47 | 98.58 | 98.69 | 98.80 | 98.91 | 99.02 | 99.13 | 99.24 | 99.35 |
| — | 1.48 | 1.47 | 1.46 | 1.44 | 1.43 | 1.41 | 1.40 | 1.38 | 1.37 | 1.35 | 1.33 | 1.31 |
| #77 | 99.46 | 99.57 | 99.68 | 99.79 | 99.90 | 100.01 | 100.12 | 100.23 | 100.34 | 100.45 | 100.56 | 100.67 |
| — | 1.29 | 1.28 | 1.26 | 1.24 | 1.23 | 1.21 | 1.20 | 1.19 | 1.17 | 1.16 | 1.16 | 1.15 |
| #78 | 100.78 | 100.89 | 101.00 | 101.11 | 101.22 | 101.33 | 101.44 | 101.55 | 101.66 | 101.77 | 101.88 | 101.99 |
| — | 1.15 | 1.14 | 1.14 | 1.14 | 1.15 | 1.15 | 1.16 | 1.16 | 1.17 | 1.18 | 1.19 | 1.21 |
| #79 | 102.10 | 102.21 | 102.32 | 102.43 | 102.54 | 102.65 | 102.76 | 102.87 | 102.98 | 103.09 | 103.19 | 103.30 |
| — | 1.22 | 1.24 | 1.25 | 1.27 | 1.28 | 1.30 | 1.32 | 1.33 | 1.35 | 1.36 | 1.38 | 1.39 |
| #80 | 103.41 | 103.52 | 103.63 | 103.74 | 103.85 | 103.96 | 104.07 | 104.18 | 104.28 | 104.39 | 104.50 | 104.61 |
| — | 1.41 | 1.42 | 1.43 | 1.44 | 1.45 | 1.45 | 1.46 | 1.46 | 1.47 | 1.47 | 1.47 | 1.47 |
| #81 | 104.72 | 104.83 | 104.94 | 105.05 | 105.16 | 105.26 | 105.37 | 105.48 | 105.59 | 105.70 | 105.81 | 105.92 |
| — | 1.47 | 1.47 | 1.47 | 1.46 | 1.46 | 1.46 | 1.46 | 1.46 | 1.45 | 1.45 | 1.45 | 1.46 |
| #82 | 106.03 | 106.14 | 106.24 | 106.35 | 106.46 | 106.57 | 106.68 | 106.79 | 106.90 | 107.01 | 107.11 | 107.22 |
| — | 1.46 | 1.46 | 1.47 | 1.47 | 1.48 | 1.48 | 1.49 | 1.50 | 1.51 | 1.53 | 1.54 | 1.55 |
| #83 | 107.33 | 107.44 | 107.55 | 107.66 | 107.76 | 107.87 | 107.98 | 108.09 | 108.20 | 108.31 | 108.41 | 108.52 |
| — | 1.57 | 1.58 | 1.60 | 1.61 | 1.63 | 1.64 | 1.65 | 1.67 | 1.68 | 1.69 | 1.70 | 1.71 |
| #84 | 108.63 | 108.74 | 108.85 | 108.95 | 109.06 | | | | | | | |
| — | 1.71 | 1.72 | 1.72 | 1.72 | 1.72 | | | | | | | |

FIG. 15 shows the shape of the microstrip line 5 in the reflection-type bandpass filter 1 of the third embodiment. A non-reflecting terminator, or an R=30Ω resistance, is provided at the terminating side (the face at z=109.06 mm) of the reflection-type bandpass filter 1. The thickness of the metal films used in the conducting layer 3 and of the conductor constituting the microstrip line 5 should be adequately greater than the skin depth δs=√{2/(ωμ0σ)} at f=1 GHz. For example if copper is used, the thickness of the conducting layer 3 and of the conductor of the microstrip line 5 should be taken as 2.1 μm or greater. This reflection-type bandpass filter is used in a system where the characteristic impedance is 30Ω.

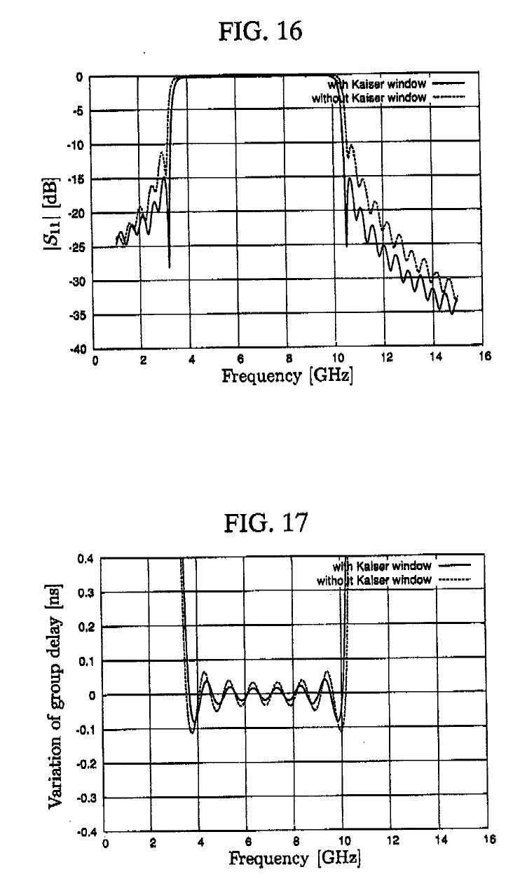

FIG. 16 and FIG. 17 express the amplitude characteristics and group delay frequency characteristics respectively of the reflective wave (S11) in the bandpass filter of the third embodiment. For comparison, the characteristics when the Kaiser window is not used, are also shown. As shown in the figures, in the region of frequency f for which 3.5 GHz≦f≦10.1 GHz, the reflectivity is −1 dB or greater and the variation of the group delay is within ±0.1 ns. In the region f<3.1 GHz and f>10.6 GHz, the reflectivity is −15 dB or lower. Compared to the case when the Kaiser window is not used, the region of transition frequency becomes wider, but the stop band rejection increases to 13 dB, and the variation of group delay within the pass band decreases.

### Embodiment 4

A Kaiser window was used for which the reflectivity is 1 at the frequency f in the region 3.6 GHz≦f≦10.1 GHz, and is 0 elsewhere, and for which A=35. Taking one wavelength at frequency f=1 GHz of the signal transmitted within the microstrip line as the waveguide length, the system characteristic impedance was taken as 30Ω, and the design was carried out.

FIG. 18 shows the distribution of the width w of the microstrip line 5 in the z-axis direction when a dielectric layer 4 of thickness h=0.635 mm, and relative dielectric constant ∈ᵣ=10.2 (for example, RT/duroid (registered trademark) 6010LM) was used, together with the width when the Kaiser window was not used. Tables 10 through 12 list the widths w of the microstrip line 5 when the Kaiser window was used.

TABLE 10
Widths of the microstrip line

| | z[mm] | | | | | | | | | | | |
|---|---|---|---|---|---|---|---|---|---|---|---|---|
| | 0.00 | 0.11 | 0.22 | 0.33 | 0.44 | 0.54 | 0.65 | 0.76 | 0.87 | 0.98 | 1.09 | 1.20 |
| | w[mm] | | | | | | | | | | | |
| | 1.47 | 1.47 | 1.47 | 1.47 | 1.47 | 1.47 | 1.47 | 1.47 | 1.47 | 1.47 | 1.47 | 1.47 |
| #2 | 1.31 | 1.42 | 1.52 | 1.63 | 1.74 | 1.85 | 1.96 | 2.07 | 2.18 | 2.29 | 2.39 | 2.50 |
| — | 1.47 | 1.47 | 1.47 | 1.47 | 1.47 | 1.47 | 1.47 | 1.47 | 1.47 | 1.47 | 1.46 | 1.46 |
| #3 | 2.61 | 2.72 | 2.83 | 2.94 | 3.05 | 3.16 | 3.27 | 3.37 | 3.48 | 3.59 | 3.70 | 3.81 |
| — | 1.46 | 1.46 | 1.46 | 1.46 | 1.46 | 1.46 | 1.46 | 1.46 | 1.46 | 1.46 | 1.46 | 1.46 |
| #4 | 3.92 | 4.03 | 4.14 | 4.25 | 4.36 | 4.46 | 4.57 | 4.68 | 4.79 | 4.90 | 5.01 | 5.12 |
| — | 1.46 | 1.45 | 1.45 | 1.45 | 1.45 | 1.45 | 1.45 | 1.45 | 1.45 | 1.45 | 1.45 | 1.45 |
| #5 | 5.23 | 5.34 | 5.44 | 5.55 | 5.66 | 5.77 | 5.88 | 5.99 | 6.10 | 6.21 | 6.32 | 6.42 |
| — | 1.45 | 1.45 | 1.45 | 1.45 | 1.45 | 1.45 | 1.45 | 1.45 | 1.45 | 1.45 | 1.45 | 1.44 |
| #6 | 6.53 | 6.64 | 6.75 | 6.86 | 6.97 | 7.08 | 7.19 | 7.30 | 7.41 | 7.51 | 7.62 | 7.73 |
| — | 1.44 | 1.44 | 1.44 | 1.44 | 1.44 | 1.43 | 1.43 | 1.43 | 1.43 | 1.43 | 1.42 | 1.42 |
| #7 | 7.84 | 7.95 | 8.06 | 8.17 | 8.28 | 8.39 | 8.50 | 8.61 | 8.71 | 8.82 | 8.93 | 9.04 |
| — | 1.42 | 1.42 | 1.42 | 1.42 | 1.41 | 1.41 | 1.41 | 1.41 | 1.41 | 1.41 | 1.41 | 1.41 |
| #8 | 9.15 | 9.26 | 9.37 | 9.48 | 9.59 | 9.70 | 9.81 | 9.91 | 10.02 | 10.13 | 10.24 | 10.35 |
| — | 1.41 | 1.41 | 1.42 | 1.42 | 1.42 | 1.42 | 1.42 | 1.42 | 1.43 | 1.43 | 1.43 | 1.43 |
| #9 | 10.46 | 10.57 | 10.68 | 10.79 | 10.90 | 11.00 | 11.11 | 11.22 | 11.33 | 11.44 | 11.55 | 11.66 |
| — | 1.43 | 1.44 | 1.44 | 1.44 | 1.44 | 1.44 | 1.45 | 1.45 | 1.45 | 1.45 | 1.45 | 1.45 |
| #10 | 11.77 | 11.88 | 11.99 | 12.09 | 12.20 | 12.31 | 12.42 | 12.53 | 12.64 | 12.75 | 12.86 | 12.97 |
| — | 1.45 | 1.45 | 1.45 | 1.46 | 1.46 | 1.46 | 1.46 | 1.46 | 1.46 | 1.46 | 1.46 | 1.46 |
| #11 | 13.07 | 13.18 | 13.29 | 13.40 | 13.51 | 13.62 | 13.73 | 13.84 | 13.95 | 14.05 | 14.16 | 14.27 |
| — | 1.46 | 1.46 | 1.46 | 1.46 | 1.46 | 1.46 | 1.46 | 1.46 | 1.46 | 1.46 | 1.47 | 1.47 |
| #12 | 14.38 | 14.49 | 14.60 | 14.71 | 14.82 | 14.93 | 15.03 | 15.14 | 15.25 | 15.36 | 15.47 | 15.58 |
| — | 1.47 | 1.47 | 1.47 | 1.48 | 1.48 | 1.48 | 1.49 | 1.49 | 1.49 | 1.50 | 1.50 | 1.50 |
| #13 | 15.69 | 15.80 | 15.90 | 16.01 | 16.12 | 16.23 | 16.34 | 16.45 | 16.56 | 16.66 | 16.77 | 16.88 |
| — | 1.51 | 1.51 | 1.51 | 1.51 | 1.52 | 1.52 | 1.52 | 1.52 | 1.52 | 1.52 | 1.52 | 1.52 |
| #14 | 16.99 | 17.10 | 17.21 | 17.32 | 17.43 | 17.53 | 17.64 | 17.75 | 17.86 | 17.97 | 18.08 | 18.19 |
| — | 1.52 | 1.52 | 1.52 | 1.51 | 1.51 | 1.51 | 1.51 | 1.50 | 1.50 | 1.50 | 1.49 | 1.49 |
| #15 | 18.30 | 18.40 | 18.51 | 18.62 | 18.73 | 18.84 | 18.95 | 19.06 | 19.17 | 19.28 | 19.38 | 19.49 |
| — | 1.48 | 1.48 | 1.48 | 1.47 | 1.47 | 1.46 | 1.46 | 1.46 | 1.45 | 1.45 | 1.45 | 1.45 |
| #16 | 19.60 | 19.71 | 19.82 | 19.93 | 20.04 | 20.15 | 20.26 | 20.37 | 20.47 | 20.58 | 20.69 | 20.80 |
| — | 1.44 | 1.44 | 1.44 | 1.44 | 1.44 | 1.44 | 1.44 | 1.44 | 1.43 | 1.43 | 1.43 | 1.43 |
| #17 | 20.91 | 21.02 | 21.13 | 21.24 | 21.35 | 21.46 | 21.56 | 21.67 | 21.78 | 21.89 | 22.00 | 22.11 |
| — | 1.43 | 1.43 | 1.43 | 1.43 | 1.43 | 1.43 | 1.43 | 1.43 | 1.43 | 1.43 | 1.43 | 1.43 |
| #18 | 22.22 | 22.33 | 22.44 | 22.55 | 22.65 | 22.76 | 22.87 | 22.98 | 23.09 | 23.20 | 23.31 | 23.42 |
| — | 1.42 | 1.42 | 1.42 | 1.41 | 1.41 | 1.41 | 1.40 | 1.40 | 1.39 | 1.39 | 1.39 | 1.38 |
| #19 | 23.53 | 23.64 | 23.75 | 23.86 | 23.97 | 24.07 | 24.18 | 24.29 | 24.40 | 24.51 | 24.62 | 24.73 |
| — | 1.38 | 1.37 | 1.37 | 1.36 | 1.36 | 1.36 | 1.36 | 1.35 | 1.35 | 1.35 | 1.35 | 1.35 |
| #20 | 24.84 | 24.95 | 25.06 | 25.17 | 25.28 | 25.39 | 25.50 | 25.61 | 25.71 | 25.82 | 25.93 | 26.04 |
| — | 1.35 | 1.35 | 1.35 | 1.36 | 1.36 | 1.36 | 1.37 | 1.37 | 1.38 | 1.38 | 1.39 | 1.40 |
| #21 | 26.15 | 26.26 | 26.37 | 26.48 | 26.59 | 26.70 | 26.81 | 26.91 | 27.02 | 27.13 | 27.24 | 27.35 |
| — | 1.40 | 1.41 | 1.42 | 1.42 | 1.43 | 1.44 | 1.44 | 1.45 | 1.46 | 1.46 | 1.47 | 1.47 |
| #22 | 27.46 | 27.57 | 27.68 | 27.78 | 27.89 | 28.00 | 28.11 | 28.22 | 28.33 | 28.44 | 28.55 | 28.65 |
| — | 1.48 | 1.48 | 1.49 | 1.49 | 1.49 | 1.50 | 1.50 | 1.50 | 1.50 | 1.50 | 1.50 | 1.50 |
| #23 | 28.76 | 28.87 | 28.98 | 29.09 | 29.20 | 29.31 | 29.42 | 29.52 | 29.63 | 29.74 | 29.85 | 29.96 |
| — | 1.50 | 1.50 | 1.50 | 1.50 | 1.50 | 1.50 | 1.50 | 1.50 | 1.50 | 1.50 | 1.50 | 1.51 |
| #24 | 30.07 | 30.18 | 30.29 | 30.39 | 30.50 | 30.61 | 30.72 | 30.83 | 30.94 | 31.05 | 31.15 | 31.26 |
| — | 1.51 | 1.51 | 1.51 | 1.52 | 1.52 | 1.53 | 1.53 | 1.54 | 1.54 | 1.55 | 1.55 | 1.56 |
| #25 | 31.37 | 31.48 | 31.59 | 31.70 | 31.81 | 31.91 | 32.02 | 32.13 | 32.24 | 32.35 | 32.46 | 32.56 |
| — | 1.57 | 1.57 | 1.58 | 1.59 | 1.59 | 1.60 | 1.60 | 1.61 | 1.61 | 1.61 | 1.62 | 1.62 |
| #26 | 32.67 | 32.78 | 32.89 | 33.00 | 33.11 | 33.21 | 33.32 | 33.43 | 33.54 | 33.65 | 33.76 | 33.86 |
| — | 1.62 | 1.61 | 1.61 | 1.61 | 1.60 | 1.60 | 1.59 | 1.58 | 1.58 | 1.57 | 1.56 | 1.55 |
| #27 | 33.97 | 34.08 | 34.19 | 34.30 | 34.41 | 34.52 | 34.63 | 34.73 | 34.84 | 34.95 | 35.06 | 35.17 |
| — | 1.53 | 1.52 | 1.51 | 1.50 | 1.48 | 1.47 | 1.46 | 1.45 | 1.43 | 1.42 | 1.41 | 1.40 |
| #28 | 35.28 | 35.39 | 35.50 | 35.61 | 35.72 | 35.83 | 35.94 | 36.05 | 36.15 | 36.26 | 36.37 | 36.48 |
| — | 1.39 | 1.38 | 1.38 | 1.37 | 1.36 | 1.36 | 1.35 | 1.35 | 1.35 | 1.34 | 1.34 | 1.34 |
| #29 | 36.59 | 36.70 | 36.81 | 36.92 | 37.03 | 37.14 | 37.25 | 37.36 | 37.47 | 37.58 | 37.69 | 37.80 |
| — | 1.34 | 1.34 | 1.34 | 1.34 | 1.34 | 1.35 | 1.35 | 1.35 | 1.35 | 1.35 | 1.35 | 1.35 |
| #30 | 37.90 | 38.01 | 38.12 | 38.23 | 38.34 | 38.45 | 38.56 | 38.67 | 38.78 | 38.89 | 39.00 | 39.11 |
| — | 1.35 | 1.35 | 1.35 | 1.34 | 1.34 | 1.34 | 1.33 | 1.33 | 1.32 | 1.31 | 1.31 | 1.30 |

TABLE 11
Widths of the microstrip line

| | | | | | | | | | | | | |
|---|---|---|---|---|---|---|---|---|---|---|---|---|
| #31 | 39.22 | 39.33 | 39.44 | 39.55 | 39.66 | 39.77 | 39.88 | 39.99 | 40.10 | 40.21 | 40.32 | 40.43 |
| — | 1.29 | 1.28 | 1.28 | 1.27 | 1.26 | 1.25 | 1.25 | 1.24 | 1.23 | 1.23 | 1.23 | 1.22 |
| #32 | 40.54 | 40.65 | 40.76 | 40.87 | 40.98 | 41.09 | 41.20 | 41.31 | 41.41 | 41.52 | 41.63 | 41.74 |
| — | 1.22 | 1.22 | 1.22 | 1.23 | 1.23 | 1.24 | 1.25 | 1.26 | 1.27 | 1.28 | 1.30 | 1.31 |
| #33 | 41.85 | 41.96 | 42.07 | 42.18 | 42.29 | 42.40 | 42.51 | 42.62 | 42.73 | 42.83 | 42.94 | 43.05 |
| — | 1.33 | 1.35 | 1.37 | 1.39 | 1.41 | 1.44 | 1.46 | 1.48 | 1.51 | 1.53 | 1.56 | 1.58 |
| #34 | 43.16 | 43.27 | 43.38 | 43.48 | 43.59 | 43.70 | 43.81 | 43.92 | 44.02 | 44.13 | 44.24 | 44.35 |
| — | 1.61 | 1.63 | 1.65 | 1.67 | 1.69 | 1.70 | 1.72 | 1.73 | 1.74 | 1.75 | 1.75 | 1.76 |
| #35 | 44.46 | 44.56 | 44.67 | 44.78 | 44.89 | 44.99 | 45.10 | 45.21 | 45.32 | 45.43 | 45.53 | 45.64 |
| — | 1.76 | 1.76 | 1.76 | 1.76 | 1.75 | 1.75 | 1.74 | 1.74 | 1.73 | 1.73 | 1.72 | 1.71 |
| #36 | 45.7.5 | 45.86 | 45.97 | 46.07 | 46.18 | 46.29 | 46.40 | 46.51 | 46.61 | 46.72 | 46.83 | 46.94 |
| — | 1.71 | 1.71 | 1.70 | 1.70 | 1.70 | 1.70 | 1.71 | 1.71 | 1.72 | 1.73 | 1.74 | 1.75 |
| #37 | 47.04 | 47.15 | 47.26 | 47.37 | 47.48 | 47.58 | 47.69 | 47.80 | 47.91 | 48.01 | 48.12 | 48.23 |
| — | 1.77 | 1.78 | 1.80 | 1.82 | 1.84 | 1.86 | 1.88 | 1.89 | 1.91 | 1.93 | 1.94 | 1.95 |
| #38 | 48.33 | 48.44 | 48.55 | 48.66 | 48.76 | 48.87 | 48.98 | 49.08 | 49.19 | 49.30 | 49.41 | 49.52 |
| — | 1.96 | 1.96 | 1.96 | 1.95 | 1.94 | 1.93 | 1.91 | 1.88 | 1.85 | 1.81 | 1.76 | 1.72 |
| #39 | 49.62 | 49.73 | 49.84 | 49.95 | 50.06 | 50.17 | 50.28 | 50.39 | 50.50 | 50.61 | 50.72 | 50.83 |
| — | 1.66 | 1.60 | 1.54 | 1.48 | 1.41 | 1.35 | 1.28 | 1.21 | 1.14 | 1.07 | 1.01 | 0.94 |
| #40 | 50.94 | 51.06 | 51.17 | 51.28 | 51.39 | 51.51 | 51.62 | 51.74 | 51.85 | 51.96 | 52.08 | 52.19 |
| — | 0.88 | 0.83 | 0.77 | 0.72 | 0.68 | 0.63 | 0.59 | 0.56 | 0.53 | 0.51 | 0.49 | 0.47 |
| #41 | 52.31 | 52.42 | 52.54 | 52.65 | 52.77 | 52.88 | 53.00 | 53.11 | 53.23 | 53.34 | 53.46 | 53.57 |
| — | 0.46 | 0.45 | 0.45 | 0.45 | 0.45 | 0.46 | 0.48 | 0.50 | 0.53 | 0.56 | 0.60 | 0.65 |
| #42 | 53.68 | 53.80 | 53.91 | 54.02 | 54.13 | 54.24 | 54.35 | 54.46 | 54.57 | 54.68 | 54.79 | 54.89 |
| — | 0.70 | 0.76 | 0.83 | 0.91 | 1.00 | 1.10 | 1.21 | 1.33 | 1.46 | 1.60 | 1.76 | 1.92 |
| #43 | 55.00 | 55.11 | 55.21 | 55.32 | 55.42 | 55.53 | 55.63 | 55.73 | 55.84 | 55.94 | 56.04 | 56.15 |
| — | 2.09 | 2.28 | 2.47 | 2.66 | 2.87 | 3.07 | 3.28 | 3.48 | 3.67 | 3.86 | 4.03 | 4.18 |
| #44 | 56.25 | 56.35 | 56.46 | 56.56 | 56.66 | 56.76 | 56.87 | 56.97 | 57.07 | 57.17 | 57.28 | 57.38 |
| — | 4.31 | 4.41 | 4.49 | 4.54 | 4.55 | 4.54 | 4.49 | 4.41 | 4.30 | 4.17 | 4.01 | 3.83 |
| #45 | 57.48 | 57.59 | 57.69 | 57.80 | 57.90 | 58.01 | 58.11 | 58.22 | 58.33 | 58.44 | 58.54 | 58.65 |
| — | 3.64 | 3.44 | 3.22 | 3.01 | 2.79 | 2.58 | 2.37 | 2.16 | 1.97 | 1.79 | 1.62 | 1.45 |
| #46 | 58.76 | 58.87 | 58.98 | 59.09 | 59.21 | 59.32 | 59.43 | 59.55 | 59.66 | 59.78 | 59.89 | 60.01 |
| — | 1.31 | 1.17 | 1.04 | 0.93 | 0.83 | 0.73 | 0.65 | 0.58 | 0.52 | 0.46 | 0.41 | 0.38 |
| #47 | 60.12 | 60.24 | 60.36 | 60.48 | 60.59 | 60.71 | 60.83 | 60.95 | 61.06 | 61.18 | 61.30 | 61.41 |
| — | 0.34 | 0.32 | 0.29 | 0.28 | 0.27 | 0.26 | 0.26 | 0.26 | 0.27 | 0.28 | 0.29 | 0.31 |
| #48 | 61.53 | 61.65 | 61.76 | 61.88 | 61.99 | 62.11 | 62.22 | 62.33 | 62.45 | 62.56 | 62.67 | 62.78 |
| — | 0.34 | 0.37 | 0.40 | 0.45 | 0.50 | 0.56 | 0.62 | 0.70 | 0.78 | 0.87 | 0.97 | 1.08 |
| #49 | 62.89 | 63.00 | 63.11 | 63.22 | 63.32 | 63.43 | 63.54 | 63.64 | 63.75 | 63.86 | 63.96 | 64.07 |
| — | 1.19 | 1.32 | 1.45 | 1.59 | 1.74 | 1.89 | 2.05 | 2.20 | 2.36 | 2.52 | 2.67 | 2.82 |
| #50 | 64.17 | 64.28 | 64.38 | 64.49 | 64.59 | 64.69 | 64.80 | 64.90 | 65.00 | 65.11 | 65.21 | 65.32 |
| — | 2.95 | 3.08 | 3.19 | 3.29 | 3.37 | 3.43 | 3.48 | 3.50 | 3.50 | 3.49 | 3.45 | 3.40 |
| #51 | 65.42 | 65.53 | 65.63 | 65.73 | 65.84 | 65.94 | 66.05 | 66.16 | 66.26 | 66.37 | 66.47 | 66.58 |
| — | 3.33 | 3.25 | 3.16 | 3.05 | 2.94 | 2.83 | 2.71 | 2.58 | 2.46 | 2.34 | 2.23 | 2.11 |
| #52 | 66.69 | 66.79 | 66.90 | 67.01 | 67.12 | 67.23 | 67.34 | 67.45 | 67.55 | 67.66 | 67.77 | 67.88 |
| — | 2.00 | 1.90 | 1.80 | 1.71 | 1.63 | 1.55 | 1.48 | 1.41 | 1.35 | 1.30 | 1.25 | 1.21 |
| #53 | 67.99 | 68.10 | 68.21 | 68.33 | 68.44 | 68.55 | 68.66 | 68.77 | 68.88 | 68.99 | 69.10 | 69.21 |
| — | 1.18 | 1.15 | 1.12 | 1.10 | 1.09 | 1.08 | 1.07 | 1.06 | 1.06 | 1.06 | 1.07 | 1.07 |
| #54 | 69.32 | 69.43 | 69.54 | 69.65 | 69.76 | 69.87 | 69.98 | 70.09 | 70.20 | 70.31 | 70.42 | 70.53 |
| — | 1.08 | 1.09 | 1.10 | 1.12 | 1.13 | 1.14 | 1.15 | 1.16 | 1.17 | 1.18 | 1.19 | 1.20 |
| #55 | 70.64 | 70.75 | 70.86 | 70.97 | 71.08 | 71.19 | 71.30 | 71.41 | 71.52 | 71.64 | 71.75 | 71.86 |
| — | 1.20 | 1.20 | 1.20 | 1.20 | 1.20 | 1.19 | 1.18 | 1.18 | 1.17 | 1.15 | 1.14 | 1.13 |
| #56 | 71.97 | 72.08 | 72.19 | 72.30 | 72.41 | 72.52 | 72.63 | 72.74 | 72.85 | 72.96 | 73.07 | 73.18 |
| — | 1.12 | 1.10 | 1.09 | 1.08 | 1.07 | 1.06 | 1.05 | 1.04 | 1.03 | 1.03 | 1.03 | 1.03 |
| #57 | 73.30 | 73.41 | 73.52 | 73.63 | 73.74 | 73.85 | 73.96 | 74.07 | 74.18 | 74.29 | 74.40 | 74.51 |
| — | 1.04 | 1.04 | 1.05 | 1.06 | 1.08 | 1.10 | 1.12 | 1.14 | 1.17 | 1.20 | 1.23 | 1.27 |
| #58 | 74.62 | 74.73 | 74.84 | 74.95 | 75.06 | 75.16 | 75.27 | 75.38 | 75.49 | 75.60 | 75.70 | 75.81 |
| — | 1.31 | 1.35 | 1.39 | 1.44 | 1.48 | 1.53 | 1.58 | 1.63 | 1.68 | 1.72 | 1.77 | 1.82 |
| #59 | 75.92 | 76.03 | 76.13 | 76.24 | 76.35 | 76.46 | 76.56 | 76.67 | 76.78 | 76.88 | 76.99 | 77.10 |
| — | 1.86 | 1.90 | 1.94 | 1.97 | 2.00 | 2.03 | 2.05 | 2.06 | 2.08 | 2.08 | 2.08 | 2.08 |
| #60 | 77.20 | 77.31 | 77.42 | 77.52 | 77.63 | 77.74 | 77.85 | 77.95 | 78.06 | 78.17 | 78.28 | 78.38 |
| — | 2.07 | 2.06 | 2.04 | 2.02 | 2.00 | 1.97 | 1.94 | 1.91 | 1.88 | 1.85 | 1.82 | 1.78 |

TABLE 12
Widths of the microstrip line

| | | | | | | | | | | | | |
|---|---|---|---|---|---|---|---|---|---|---|---|---|
| #61 | 78.49 | 78.60 | 78.71 | 78.82 | 78.92 | 79.03 | 79.14 | 79.25 | 79.36 | 79.47 | 79.58 | 79.68 |
| — | 1.75 | 1.72 | 1.68 | 1.65 | 1.63 | 1.60 | 1.57 | 1.55 | 1.53 | 1.51 | 1.49 | 1.48 |
| #62 | 79.79 | 79.90 | 80.01 | 80.12 | 80.23 | 80.34 | 80.45 | 80.56 | 80.66 | 80.77 | 80.88 | 80.99 |
| — | 1.46 | 1.45 | 1.44 | 1.44 | 1.43 | 1.43 | 1.43 | 1.42 | 1.42 | 1.43 | 1.43 | 1.43 |
| #63 | 81.10 | 81.21 | 81.32 | 81.43 | 81.54 | 81.65 | 81.76 | 81.86 | 81.97 | 82.08 | 82.19 | 82.30 |
| — | 1.43 | 1.43 | 1.44 | 1.44 | 1.44 | 1.44 | 1.44 | 1.44 | 1.43 | 1.43 | 1.42 | 1.42 |
| #64 | 82.41 | 82.52 | 82.63 | 82.74 | 82.85 | 82.96 | 83.07 | 83.17 | 83.28 | 83.39 | 83.50 | 83.61 |
| — | 1.41 | 1.40 | 1.39 | 1.37 | 1.36 | 1.35 | 1.33 | 1.31 | 1.30 | 1.28 | 1.26 | 1.25 |
| #65 | 83.72 | 83.83 | 83.94 | 84.05 | 84.16 | 84.27 | 84.38 | 84.49 | 84.60 | 84.72 | 84.83 | 84.94 |
| — | 1.23 | 1.21 | 1.20 | 1.19 | 1.17 | 1.16 | 1.15 | 1.14 | 1.13 | 1.13 | 1.12 | 1.12 |
| #66 | 85.05 | 85.16 | 85.27 | 85.38 | 85.49 | 85.60 | 85.71 | 85.82 | 85.93 | 86.04 | 86.15 | 86.26 |
| — | 1.12 | 1.12 | 1.13 | 1.13 | 1.14 | 1.15 | 1.16 | 1.18 | 1.19 | 1.21 | 1.23 | 1.25 |
| #67 | 86.37 | 86.48 | 86.59 | 86.70 | 86.81 | 86.91 | 87.02 | 87.13 | 87.24 | 87.35 | 87.46 | 87.57 |
| — | 1.27 | 1.30 | 1.32 | 1.35 | 1.37 | 1.40 | 1.43 | 1.45 | 1.48 | 1.50 | 1.53 | 1.55 |
| #68 | 87.68 | 87.78 | 87.89 | 88.00 | 88.11 | 88.22 | 88.33 | 88.43 | 88.54 | 88.65 | 88.76 | 88.87 |
| — | 1.57 | 1.60 | 1.61 | 1.63 | 1.65 | 1.66 | 1.67 | 1.68 | 1.69 | 1.69 | 1.70 | 1.70 |
| #69 | 88.97 | 89.08 | 89.19 | 89.30 | 89.41 | 89.51 | 89.62 | 89.73 | 89.84 | 89.95 | 90.05 | 90.16 |
| — | 1.70 | 1.69 | 1.69 | 1.68 | 1.68 | 1.67 | 1.66 | 1.65 | 1.64 | 1.63 | 1.62 | 1.61 |
| #70 | 90.27 | 90.38 | 90.49 | 90.60 | 90.71 | 90.81 | 90.92 | 91.03 | 91.14 | 91.25 | 91.36 | 91.47 |
| — | 1.60 | 1.59 | 1.58 | 1.58 | 1.57 | 1.56 | 1.56 | 1.55 | 1.55 | 1.55 | 1.55 | 1.55 |
| #71 | 91.57 | 91.68 | 91.79 | 91.90 | 92.01 | 92.12 | 92.22 | 92.33 | 92.44 | 92.55 | 92.66 | 92.77 |
| — | 1.55 | 1.55 | 1.55 | 1.55 | 1.56 | 1.56 | 1.57 | 1.57 | 1.57 | 1.58 | 1.58 | 1.58 |
| #72 | 92.88 | 92.98 | 93.09 | 93.20 | 93.31 | 93.42 | 93.53 | 93.63 | 93.74 | 93.85 | 93.96 | 94.07 |
| — | 1.59 | 1.59 | 1.59 | 1.59 | 1.59 | 1.58 | 1.58 | 1.57 | 1.57 | 1.56 | 1.55 | 1.54 |
| #73 | 94.18 | 94.29 | 94.39 | 94.50 | 94.61 | 94.72 | 94.83 | 94.94 | 95.05 | 95.16 | 95.27 | 95.38 |
| — | 1.52 | 1.51 | 1.50 | 1.48 | 1.46 | 1.45 | 1.43 | 1.41 | 1.39 | 1.38 | 1.36 | 1.34 |
| #74 | 95.49 | 95.60 | 95.71 | 95.82 | 95.92 | 96.03 | 96.14 | 96.25 | 96.36 | 96.47 | 96.58 | 96.69 |
| — | 1.33 | 1.31 | 1.30 | 1.28 | 1.27 | 1.26 | 1.25 | 1.24 | 1.23 | 1.22 | 1.22 | 1.21 |
| #75 | 96.80 | 96.91 | 97.02 | 97.13 | 97.24 | 97.35 | 97.46 | 97.57 | 97.68 | 97.79 | 97.90 | 98.01 |
| — | 1.21 | 1.21 | 1.21 | 1.22 | 1.22 | 1.22 | 1.23 | 1.24 | 1.25 | 1.26 | 1.27 | 1.28 |
| #76 | 98.12 | 98.23 | 98.34 | 98.45 | 98.56 | 98.67 | 98.78 | 98.89 | 99.00 | 99.11 | 99.21 | 99.32 |
| — | 1.29 | 1.31 | 1.32 | 1.34 | 1.35 | 1.36 | 1.38 | 1.39 | 1.41 | 1.42 | 1.43 | 1.44 |
| #77 | 99.43 | 99.54 | 99.65 | 99.76 | 99.87 | 99.98 | 100.09 | 100.19 | 100.30 | 100.41 | 100.52 | 100.63 |
| — | 1.45 | 1.46 | 1.47 | 1.48 | 1.48 | 1.49 | 1.49 | 1.50 | 1.50 | 1.50 | 1.50 | 1.50 |
| #78 | 100.74 | 100.85 | 100.96 | 101.06 | 101.17 | 101.28 | 101.39 | 101.50 | 101.61 | 101.72 | 101.83 | 101.93 |
| — | 1.50 | 1.50 | 1.50 | 1.50 | 1.50 | 1.49 | 1.49 | 1.49 | 1.49 | 1.49 | 1.49 | 1.49 |
| #79 | 102.04 | 102.15 | 102.26 | 102.37 | 102.48 | 102.59 | 102.70 | 102.80 | 102.91 | 103.02 | 103.13 | 103.24 |
| — | 1.49 | 1.49 | 1.49 | 1.49 | 1.50 | 1.50 | 1.51 | 1.51 | 1.52 | 1.53 | 1.53 | 1.54 |
| #80 | 103.35 | 103.46 | 103.56 | 103.67 | 103.78 | 103.89 | 104.00 | 104.11 | 104.21 | 104.32 | 104.43 | 104.54 |
| — | 1.55 | 1.56 | 1.57 | 1.58 | 1.59 | 1.60 | 1.60 | 1.61 | 1.62 | 1.63 | 1.63 | 1.64 |
| #81 | 104.65 | 104.76 | 104.86 | 104.97 | 105.08 | 105.19 | 105.30 | 105.41 | 105.51 | 105.62 | 105.73 | 105.84 |
| — | 1.64 | 1.64 | 1.64 | 1.64 | 1.64 | 1.64 | 1.64 | 1.63 | 1.62 | 1.62 | 1.61 | 1.60 |
| #82 | 105.95 | 106.06 | 106.16 | 106.27 | 106.38 | 106.49 | 106.60 | 106.71 | 106.82 | 106.93 | 107.03 | 107.14 |
| — | 1.59 | 1.57 | 1.56 | 1.55 | 1.53 | 1.52 | 1.50 | 1.49 | 1.47 | 1.46 | 1.45 | 1.43 |
| #83 | 107.25 | 107.36 | 107.47 | 107.58 | 107.69 | 107.80 | 107.91 | 108.02 | 108.13 | 108.24 | 108.35 | 108.45 |
| — | 1.42 | 1.41 | 1.39 | 1.38 | 1.37 | 1.36 | 1.36 | 1.35 | 1.34 | 1.34 | 1.33 | 1.33 |
| #84 | 108.56 | 108.67 | 108.78 | 108.89 | 109.00 | | | | | | | |
| — | 1.33 | 1.33 | 1.32 | 1.33 | 1.33 | | | | | | | |

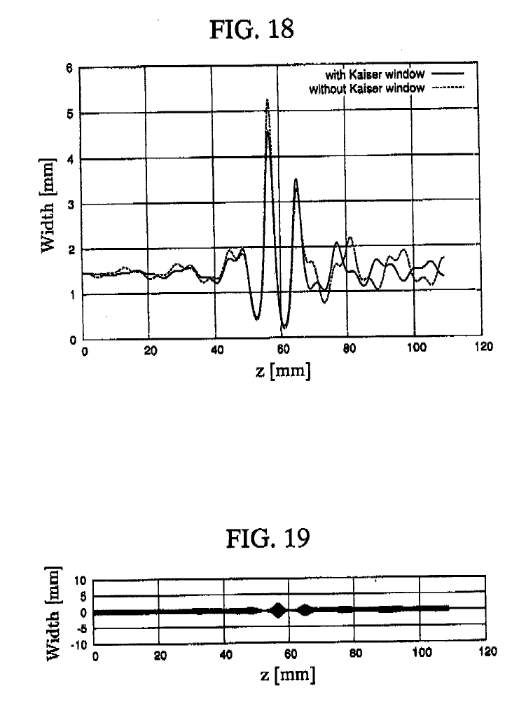

FIG. 19 shows the shape of the microstrip line 5 in the reflection-type bandpass filter 1 of the fourth embodiment. A non-reflecting terminator, or an R=30Ω resistance, is provided at the terminating side (the face at z=109.00 mm) of the reflection-type bandpass filter 1. The thickness of the metal films used in the conducting layer 3 and of the conductor constituting the microstrip line 5 should be adequately greater than the skin depth δs=√{2/(ωμ0σ)} at f=1 GHz. For example if copper is used, the thickness of the conducting layer 3 and of the conductor of the microstrip line 5 should be taken as 2.1 μm or greater. This reflection-type bandpass filter is used in a system where the characteristic impedance is 30Ω.

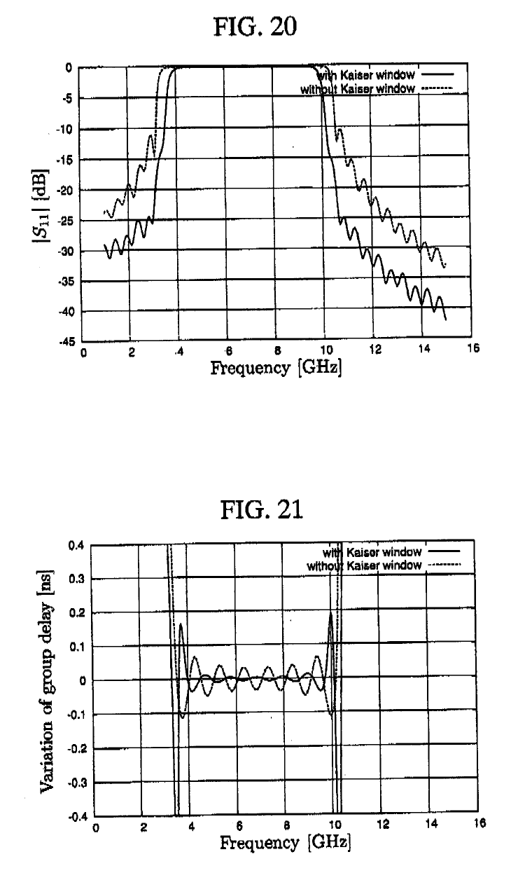

FIG. 20 and FIG. 21 express the amplitude characteristics and group delay frequency characteristics respectively of the reflective wave (S11) in the bandpass filter of the fourth embodiment. For comparison, the characteristics when the Kaiser window is not used, are also shown. As shown in the figures, in the region of frequency f for which 4.0 GHz≦f≦9.7 GHz, the reflectivity is −2 dB or greater and the variation of the group delay is within ±0.1 ns. In the region f<3.1 GHz and f>10.6 GHz, the reflectivity is −20 dB or lower. Compared to the case when the Kaiser window is not used, the region of transition frequency becomes wider, but the stop band rejection increases to 18 dB, and the variation of group delay within the pass band decreases.

### Embodiment 5

A Kaiser window was used for which the reflectivity is 0.95 at the frequency f in the region 3.6 GHz≦f≦10.1 GHz, and is 0 elsewhere, and for which A=40. Taking one wavelength at frequency f=1 GHz of the signal transmitted within the microstrip line as the waveguide length, the system characteristic impedance was taken as 50Ω, and the design was carried out.

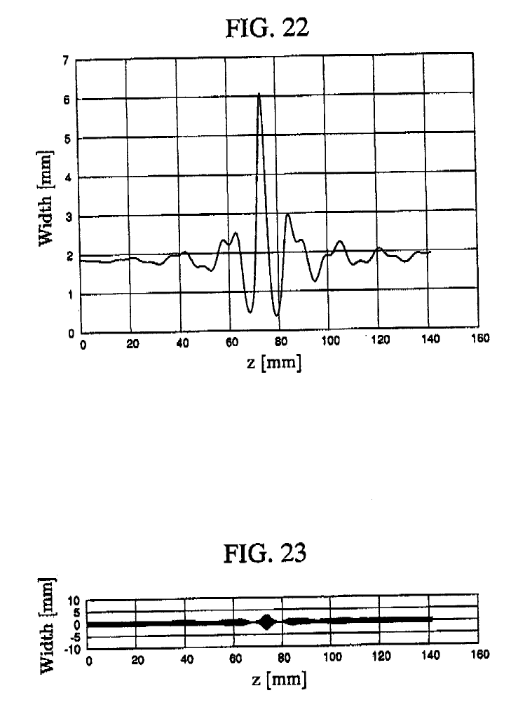

FIG. 22 shows the distribution of the width w of the microstrip line 5 in the z-axis direction when a dielectric layer 4 of thickness h=1.27 mm, and relative dielectric constant ∈ᵣ=6.15 was used, together with the width when the Kaiser window was not used. Tables 13 through 15 list the widths w of the microstrip line 5 when the Kaiser window was used.

TABLE 13
Widths of the microstrip line
z[mm]

| | 0.00 | 0.14 | 0.28 | 0.42 | 0.57 | 0.71 | 0.85 | 0.99 | 1.13 | 1.27 | 1.41 | 1.56 |
|---|---|---|---|---|---|---|---|---|---|---|---|---|
| | w[mm] | | | | | | | | | | | |
| | 1.87 | 1.87 | 1.87 | 1.87 | 1.87 | 1.87 | 1.87 | 1.87 | 1.87 | 1.87 | 1.87 | 1.87 |
| #2 | 1.70 | 1.84 | 1.98 | 2.12 | 2.26 | 2.40 | 2.55 | 2.69 | 2.83 | 2.97 | 3.11 | 3.25 |
| — | 1.87 | 1.87 | 1.87 | 1.86 | 1.86 | 1.86 | 1.86 | 1.86 | 1.86 | 1.86 | 1.86 | 1.85 |
| #3 | 3.40 | 3.54 | 3.68 | 3.82 | 3.96 | 4.10 | 4.24 | 4.39 | 4.53 | 4.67 | 4.81 | 4.95 |
| — | 1.85 | 1.85 | 1.85 | 1.85 | 1.85 | 1.85 | 1.85 | 1.85 | 1.84 | 1.84 | 1.84 | 1.84 |
| #4 | 5.09 | 5.24 | 5.38 | 5.52 | 5.66 | 5.80 | 5.94 | 6.08 | 6.23 | 6.37 | 6.51 | 6.65 |
| — | 1.84 | 1.84 | 1.84 | 1.84 | 1.84 | 1.84 | 1.84 | 1.84 | 1.84 | 1.84 | 1.84 | 1.84 |
| #5 | 6.79 | 6.93 | 7.08 | 7.22 | 7.36 | 7.50 | 7.64 | 7.78 | 7.93 | 8.07 | 8.21 | 8.35 |
| — | 1.84 | 1.84 | 1.84 | 1.84 | 1.84 | 1.84 | 1.84 | 1.84 | 1.84 | 1.84 | 1.84 | 1.84 |
| #6 | 8.49 | 8.53 | 8.77 | 8.92 | 9.06 | 9.20 | 9.34 | 9.48 | 9.62 | 9.77 | 9.91 | 10.05 |
| — | 1.83 | 1.83 | 1.83 | 1.83 | 1.83 | 1.83 | 1.83 | 1.82 | 1.82 | 1.82 | 1.82 | 1.82 |
| #7 | 10.19 | 10.33 | 10.47 | 10.62 | 10.76 | 10.90 | 11.04 | 11.18 | 11.32 | 11.47 | 11.61 | 11.75 |
| — | 1.82 | 1.82 | 1.82 | 1.82 | 1.81 | 1.81 | 1.81 | 1.81 | 1.82 | 1.82 | 1.82 | 1.82 |
| #8 | 11.89 | 12.03 | 12.17 | 12.32 | 12.46 | 12.60 | 12.74 | 12.88 | 13.02 | 13.10 | 13.31 | 13.45 |
| — | 1.82 | 1.82 | 1.82 | 1.83 | 1.83 | 1.83 | 1.83 | 1.84 | 1.84 | 1.84 | 1.84 | 1.85 |
| #9 | 13.59 | 13.73 | 13.87 | 14.01 | 14.16 | 14.30 | 14.44 | 14.58 | 14.72 | 14.86 | 15.00 | 15.15 |
| — | 1.85 | 1.85 | 1.86 | 1.86 | 1.86 | 1.86 | 1.87 | 1.87 | 1.87 | 1.87 | 1.87 | 1.87 |
| #10 | 15.29 | 15.43 | 15.57 | 15.71 | 15.85 | 15.99 | 16.14 | 16.28 | 16.42 | 16.56 | 16.70 | 16.84 |
| — | 1.88 | 1.88 | 1.88 | 1.88 | 1.88 | 1.88 | 1.88 | 1.88 | 1.88 | 1.88 | 1.88 | 1.88 |
| #11 | 16.98 | 17.13 | 17.27 | 17.41 | 17.55 | 17.69 | 17.83 | 17.97 | 18.12 | 18.26 | 18.40 | 18.54 |
| — | 1.88 | 1.88 | 1.88 | 1.88 | 1.88 | 1.88 | 1.88 | 1.88 | 1.88 | 1.88 | 1.88 | 1.88 |
| #12 | 18.68 | 18.82 | 18.96 | 19.11 | 19.25 | 19.39 | 19.53 | 19.67 | 19.81 | 19.95 | 20.10 | 20.24 |
| — | 1.89 | 1.89 | 1.89 | 1.89 | 1.90 | 1.90 | 1.90 | 1.90 | 1.91 | 1.91 | 1.91 | 1.91 |
| #13 | 20.38 | 20.52 | 20.66 | 20.80 | 20.94 | 21.08 | 21.23 | 21.37 | 21.51 | 21.65 | 21.79 | 21.93 |
| — | 1.92 | 1.92 | 1.92 | 1.92 | 1.92 | 1.92 | 1.93 | 1.93 | 1.93 | 1.92 | 1.92 | 1.92 |
| #14 | 22.07 | 22.21 | 22.36 | 22.50 | 22.64 | 22.78 | 22.92 | 23.06 | 23.20 | 23.35 | 23.49 | 23.63 |
| — | 1.92 | 1.92 | 1.91 | 1.91 | 1.91 | 1.90 | 1.90 | 1.89 | 1.89 | 1.88 | 1.88 | 1.87 |
| #15 | 23.77 | 23.91 | 24.05 | 24.19 | 24.34 | 24.48 | 24.62 | 24.76 | 24.90 | 25.04 | 25.19 | 25.33 |
| — | 1.87 | 1.86 | 1.85 | 1.85 | 1.84 | 1.84 | 1.83 | 1.83 | 1.82 | 1.82 | 1.82 | 1.81 |
| #16 | 25.47 | 25.61 | 25.75 | 25.89 | 26.04 | 26.18 | 26.32 | 26.46 | 26.60 | 26.74 | 26.89 | 27.03 |
| — | 1.81 | 1.81 | 1.81 | 1.80 | 1.80 | 1.80 | 1.80 | 1.80 | 1.80 | 1.80 | 1.80 | 1.80 |
| #17 | 27.17 | 27.31 | 27.45 | 27.59 | 27.74 | 27.88 | 28.02 | 28.16 | 28.30 | 28.44 | 28.59 | 28.73 |
| — | 1.80 | 1.80 | 1.80 | 1.80 | 1.81 | 1.81 | 1.81 | 1.80 | 1.80 | 1.80 | 1.80 | 1.80 |
| #18 | 28.87 | 29.01 | 29.15 | 29.29 | 29.44 | 29.58 | 29.72 | 29.86 | 30.00 | 30.15 | 30.29 | 30.43 |
| — | 1.80 | 1.80 | 1.79 | 1.79 | 1.79 | 1.78 | 1.78 | 1.78 | 1.77 | 1.77 | 1.76 | 1.76 |
| #19 | 30.57 | 30.71 | 30.85 | 31.00 | 31.14 | 31.28 | 31.42 | 31.56 | 31.71 | 31.85 | 31.99 | 32.13 |
| — | 1.76 | 1.75 | 1.75 | 1.75 | 1.74 | 1.74 | 1.74 | 1.74 | 1.74 | 1.74 | 1.74 | 1.74 |
| #20 | 32.27 | 32.42 | 32.56 | 32.70 | 32.84 | 32.98 | 33.12 | 33.27 | 33.41 | 33.55 | 33.69 | 33.83 |
| — | 1.74 | 1.75 | 1.75 | 1.75 | 1.76 | 1.76 | 1.77 | 1.78 | 1.79 | 1.80 | 1.80 | 1.81 |
| #21 | 33.97 | 34.12 | 34.26 | 34.40 | 34.54 | 34.68 | 34.82 | 34.97 | 35.11 | 35.25 | 35.39 | 35.53 |
| — | 1.82 | 1.83 | 1.84 | 1.85 | 1.86 | 1.87 | 1.88 | 1.89 | 1.90 | 1.91 | 1.92 | 1.92 |
| #22 | 35.67 | 35.81 | 35.95 | 36.10 | 36.24 | 36.38 | 36.52 | 36.66 | 36.80 | 36.94 | 37.08 | 37.22 |
| — | 1.93 | 1.94 | 1.94 | 1.95 | 1.95 | 1.95 | 1.95 | 1.96 | 1.96 | 1.96 | 1.96 | 1.96 |
| #23 | 37.37 | 37.51 | 37.65 | 37.79 | 37.93 | 38.07 | 38.21 | 38.35 | 38.50 | 38.64 | 38.78 | 38.92 |
| — | 1.95 | 1.95 | 1.95 | 1.95 | 1.95 | 1.95 | 1.95 | 1.95 | 1.95 | 1.94 | 1.95 | 1.95 |
| #24 | 39.06 | 39.20 | 39.34 | 39.48 | 39.63 | 39.77 | 39.91 | 40.05 | 40.19 | 40.33 | 40.47 | 40.61 |
| — | 1.95 | 1.95 | 1.95 | 1.95 | 1.96 | 1.96 | 1.97 | 1.97 | 1.98 | 1.99 | 1.99 | 2.00 |
| #25 | 40.75 | 40.89 | 41.04 | 41.18 | 41.32 | 41.46 | 41.60 | 41.74 | 41.88 | 42.02 | 42.16 | 42.30 |
| — | 2.01 | 2.01 | 2.02 | 2.02 | 2.03 | 2.04 | 2.04 | 2.04 | 2.05 | 2.05 | 2.05 | 2.05 |
| #26 | 42.44 | 42.59 | 42.73 | 42.87 | 43.01 | 43.15 | 43.29 | 43.43 | 43.57 | 43.71 | 43.86 | 44.00 |
| — | 2.04 | 2.04 | 2.04 | 2.03 | 2.02 | 2.01 | 2.00 | 1.99 | 1.98 | 1.97 | 1.95 | 1.94 |
| #27 | 44.14 | 44.28 | 44.42 | 44.56 | 44.70 | 44.85 | 44.99 | 45.13 | 45.27 | 45.41 | 45.55 | 45.70 |
| — | 1.92 | 1.90 | 1.88 | 1.87 | 1.85 | 1.83 | 1.82 | 1.80 | 1.78 | 1.77 | 1.75 | 1.74 |
| #28 | 45.84 | 45.98 | 46.12 | 46.26 | 46.41 | 46.55 | 46.69 | 46.83 | 46.97 | 47.12 | 47.26 | 47.40 |
| — | 1.73 | 1.71 | 1.70 | 1.69 | 1.69 | 1.68 | 1.67 | 1.67 | 1.66 | 1.66 | 1.66 | 1.66 |
| #29 | 47.54 | 47.69 | 47.83 | 47.97 | 48.11 | 48.25 | 48.40 | 48.54 | 48.68 | 48.82 | 48.96 | 49.11 |
| — | 1.66 | 1.66 | 1.67 | 1.67 | 1.67 | 1.67 | 1.68 | 1.68 | 1.68 | 1.69 | 1.69 | 1.69 |
| #30 | 49.25 | 49.39 | 49.53 | 49.68 | 49.82 | 49.96 | 50.10 | 50.24 | 50.39 | 50.53 | 50.67 | 50.81 |
| — | 1.69 | 1.69 | 1.69 | 1.69 | 1.69 | 1.68 | 1.68 | 1.67 | 1.67 | 1.66 | 1.65 | 1.64 |

TABLE 14
Widths of the microstrip line

| | | | | | | | | | | | | |
|---|---|---|---|---|---|---|---|---|---|---|---|---|
| #31 | 50.96 | 51.10 | 51.24 | 51.38 | 51.52 | 51.67 | 51.81 | 51.95 | 52.09 | 52.24 | 52.38 | 52.52 |
| — | 1.64 | 1.63 | 1.62 | 1.61 | 1.60 | 1.59 | 1.58 | 1.58 | 1.57 | 1.57 | 1.56 | 1.56 |
| #32 | 52.66 | 52.81 | 52.95 | 53.09 | 53.24 | 53.38 | 53.52 | 53.66 | 53.80 | 53.95 | 54.09 | 54.23 |
| — | 1.56 | 1.56 | 1.57 | 1.57 | 1.58 | 1.59 | 1.61 | 1.62 | 1.64 | 1.66 | 1.68 | 1.70 |
| #33 | 54.37 | 54.51 | 54.66 | 54.80 | 54.94 | 55.08 | 55.22 | 55.36 | 55.50 | 55.65 | 55.79 | 55.93 |
| — | 1.73 | 1.76 | 1.79 | 1.82 | 1.85 | 1.88 | 1.92 | 1.95 | 1.99 | 2.02 | 2.06 | 2.09 |
| #34 | 56.07 | 56.21 | 56.35 | 56.49 | 56.63 | 56.77 | 56.91 | 57.05 | 57.19 | 57.33 | 57.47 | 57.61 |
| — | 2.12 | 2.16 | 2.18 | 2.21 | 2.24 | 2.26 | 2.28 | 2.30 | 2.31 | 2.32 | 2.33 | 2.33 |
| #35 | 57.75 | 57.89 | 58.03 | 58.17 | 58.31 | 58.45 | 58.59 | 58.73 | 58.87 | 59.01 | 59.15 | 59.29 |
| — | 2.33 | 2.33 | 2.33 | 2.32 | 2.32 | 2.31 | 2.30 | 2.29 | 2.28 | 2.27 | 2.25 | 2.24 |
| #36 | 59.43 | 59.57 | 59.71 | 59.85 | 59.99 | 60.13 | 60.27 | 60.41 | 60.56 | 60.70 | 60.84 | 60.98 |
| — | 2.24 | 2.23 | 2.22 | 2.22 | 2.22 | 2.22 | 2.22 | 2.22 | 2.23 | 2.24 | 2.25 | 2.27 |
| #37 | 61.12 | 61.26 | 61.40 | 61.54 | 61.68 | 61.82 | 61.96 | 62.10 | 62.24 | 62.37 | 62.51 | 62.65 |
| — | 2.29 | 2.31 | 2.33 | 2.35 | 2.37 | 2.40 | 2.42 | 2.44 | 2.46 | 2.48 | 2.50 | 2.51 |
| #38 | 62.79 | 62.93 | 63.07 | 63.21 | 63.35 | 63.49 | 63.63 | 63.77 | 63.91 | 64.05 | 64.19 | 64.33 |
| — | 2.52 | 2.52 | 2.52 | 2.51 | 2.49 | 2.47 | 2.43 | 2.39 | 2.35 | 2.29 | 2.23 | 2.16 |
| #39 | 64.47 | 64.61 | 64.76 | 64.90 | 65.04 | 65.18 | 65.32 | 65.47 | 65.61 | 65.75 | 65.90 | 66.04 |
| — | 2.09 | 2.01 | 1.92 | 1.83 | 1.74 | 1.65 | 1.55 | 1.46 | 1.37 | 1.27 | 1.18 | 1.10 |
| #40 | 66.19 | 66.33 | 66.48 | 66.63 | 66.77 | 66.92 | 67.07 | 67.21 | 67.36 | 67.51 | 67.66 | 67.81 |
| — | 1.02 | 0.94 | 0.87 | 0.80 | 0.74 | 0.69 | 0.64 | 0.60 | 0.56 | 0.53 | 0.51 | 0.49 |
| #41 | 67.96 | 68.11 | 68.25 | 68.40 | 68.55 | 68.70 | 68.85 | 69.00 | 69.15 | 69.29 | 69.44 | 69.59 |
| — | 0.47 | 0.47 | 0.46 | 0.46 | 0.47 | 0.49 | 0.51 | 0.54 | 0.57 | 0.62 | 0.67 | 0.73 |
| #42 | 69.73 | 69.88 | 70.03 | 70.17 | 70.31 | 70.46 | 70.60 | 70.74 | 70.88 | 71.02 | 71.16 | 71.30 |
| — | 0.80 | 0.89 | 0.99 | 1.10 | 1.22 | 1.36 | 1.51 | 1.68 | 1.87 | 2.07 | 2.28 | 2.51 |
| #43 | 71.44 | 71.58 | 71.72 | 71.86 | 71.99 | 72.13 | 72.27 | 72.40 | 72.54 | 72.67 | 72.80 | 72.94 |
| — | 2.75 | 3.01 | 3.27 | 3.54 | 3.82 | 4.10 | 4.38 | 4.65 | 4.91 | 5.16 | 5.39 | 5.59 |
| #44 | 73.07 | 73.21 | 73.34 | 73.47 | 73.61 | 73.74 | 73.88 | 74.01 | 74.14 | 74.28 | 74.41 | 74.55 |
| — | 5.76 | 5.90 | 6.00 | 6.06 | 6.08 | 6.05 | 5.99 | 5.88 | 5.74 | 5.56 | 5.36 | 5.13 |
| #45 | 74.68 | 74.82 | 74.95 | 75.09 | 75.23 | 75.36 | 75.50 | 75.64 | 75.78 | 75.92 | 76.06 | 76.20 |
| — | 4.87 | 4.60 | 4.33 | 4.04 | 3.75 | 3.47 | 3.19 | 2.92 | 2.66 | 2.42 | 2.19 | 1.97 |
| #46 | 76.34 | 76.49 | 76.63 | 76.77 | 76.92 | 77.06 | 77.21 | 77.35 | 77.50 | 77.65 | 77.80 | 77.94 |
| — | 1.77 | 1.58 | 1.41 | 1.26 | 1.12 | 1.00 | 0.89 | 0.79 | 0.71 | 0.63 | 0.57 | 0.52 |
| #47 | 78.09 | 78.24 | 78.39 | 78.54 | 78.69 | 78.84 | 78.99 | 79.14 | 79.29 | 79.44 | 79.59 | 79.74 |
| — | 0.48 | 0.45 | 0.42 | 0.40 | 0.39 | 0.38 | 0.38 | 0.38 | 0.39 | 0.40 | 0.42 | 0.44 |
| #48 | 79.89 | 80.04 | 80.18 | 80.33 | 80.48 | 80.63 | 80.77 | 80.92 | 81.06 | 81.21 | 81.35 | 81.50 |
| — | 0.48 | 0.51 | 0.56 | 0.61 | 0.67 | 0.73 | 0.81 | 0.89 | 0.98 | 1.07 | 1.17 | 1.28 |
| #49 | 81.64 | 81.78 | 81.92 | 82.07 | 82.21 | 82.35 | 82.49 | 82.63 | 82.77 | 82.91 | 83.05 | 83.19 |
| — | 1.39 | 1.51 | 1.63 | 1.75 | 1.87 | 1.99 | 2.11 | 2.23 | 2.34 | 2.45 | 2.54 | 2.63 |
| #50 | 83.33 | 83.47 | 83.60 | 83.74 | 83.88 | 84.02 | 84.16 | 84.30 | 84.44 | 84.57 | 84.71 | 84.85 |
| — | 2.72 | 2.79 | 2.85 | 2.90 | 2.93 | 2.96 | 2.98 | 2.98 | 2.98 | 2.97 | 2.95 | 2.92 |
| #51 | 84.99 | 85.13 | 85.27 | 85.41 | 85.55 | 85.68 | 85.82 | 85.96 | 86.10 | 86.24 | 86.38 | 86.52 |
| — | 2.89 | 2.85 | 2.81 | 2.76 | 2.72 | 2.67 | 2.62 | 2.58 | 2.53 | 2.49 | 2.45 | 2.42 |
| #52 | 86.66 | 86.80 | 86.94 | 87.08 | 87.22 | 87.36 | 87.50 | 87.64 | 87.78 | 87.92 | 88.06 | 88.20 |
| — | 2.38 | 2.35 | 2.33 | 2.31 | 2.29 | 2.28 | 2.26 | 2.26 | 2.25 | 2.25 | 2.25 | 2.26 |
| #53 | 88.34 | 88.48 | 88.62 | 88.76 | 88.90 | 89.04 | 89.18 | 89.32 | 89.46 | 89.60 | 89.74 | 89.88 |
| — | 2.26 | 2.27 | 2.28 | 2.29 | 2.30 | 2.30 | 2.31 | 2.31 | 2.32 | 2.32 | 2.31 | 2.31 |
| #54 | 90.03 | 90.17 | 90.31 | 90.45 | 90.59 | 90.73 | 90.87 | 91.01 | 91.15 | 91.29 | 91.43 | 91.57 |
| — | 2.30 | 2.28 | 2.27 | 2.25 | 2.22 | 2.19 | 2.16 | 2.12 | 2.08 | 2.04 | 2.00 | 1.95 |
| #55 | 91.71 | 91.85 | 92.00 | 92.14 | 92.28 | 92.42 | 92.56 | 92.71 | 92.85 | 92.99 | 93.14 | 93.28 |
| — | 1.90 | 1.86 | 1.81 | 1.76 | 1.71 | 1.66 | 1.61 | 1.57 | 1.53 | 1.49 | 1.45 | 1.41 |
| #56 | 93.42 | 93.57 | 93.71 | 93.85 | 94.00 | 94.14 | 94.28 | 94.43 | 94.57 | 94.72 | 94.86 | 95.00 |
| — | 1.38 | 1.35 | 1.33 | 1.30 | 1.29 | 1.27 | 1.26 | 1.25 | 1.25 | 1.24 | 1.25 | 1.25 |
| #57 | 95.15 | 95.29 | 95.44 | 95.58 | 95.72 | 95.87 | 96.01 | 96.15 | 96.30 | 96.44 | 96.58 | 96.72 |
| — | 1.26 | 1.27 | 1.29 | 1.30 | 1.32 | 1.35 | 1.37 | 1.40 | 1.42 | 1.45 | 1.48 | 1.51 |
| #58 | 96.87 | 97.01 | 97.15 | 97.29 | 97.44 | 97.58 | 97.72 | 97.86 | 98.00 | 98.15 | 98.29 | 98.43 |
| — | 1.55 | 1.58 | 1.61 | 1.64 | 1.67 | 1.70 | 1.73 | 1.75 | 1.78 | 1.80 | 1.82 | 1.84 |
| #59 | 98.57 | 98.71 | 98.85 | 99.00 | 99.14 | 99.28 | 99.42 | 99.56 | 99.70 | 99.84 | 99.98 | 100.13 |
| — | 1.85 | 1.87 | 1.88 | 1.89 | 1.90 | 1.90 | 1.91 | 1.91 | 1.91 | 1.91 | 1.91 | 1.91 |
| #60 | 100.27 | 100.41 | 100.55 | 100.69 | 100.83 | 100.97 | 101.12 | 101.26 | 101.40 | 101.54 | 101.68 | 101.82 |
| — | 1.91 | 1.91 | 1.90 | 1.90 | 1.90 | 1.90 | 1.91 | 1.91 | 1.91 | 1.92 | 1.92 | 1.93 |

TABLE 15
Widths of the microstrip line

| | | | | | | | | | | | | |
|---|---|---|---|---|---|---|---|---|---|---|---|---|
| #61 | 101.96 | 102.10 | 102.25 | 102.39 | 102.53 | 102.67 | 102.81 | 102.95 | 103.09 | 103.23 | 103.37 | 103.51 |
| — | 1.94 | 1.95 | 1.97 | 1.98 | 1.99 | 2.01 | 2.03 | 2.05 | 2.07 | 2.08 | 2.10 | 2.12 |
| #62 | 103.65 | 103.79 | 103.93 | 104.08 | 104.22 | 104.36 | 104.50 | 104.64 | 104.78 | 104.92 | 105.06 | 105.20 |
| — | 2.14 | 2.16 | 2.18 | 2.20 | 2.21 | 2.22 | 2.24 | 2.25 | 2.25 | 2.26 | 2.26 | 2.26 |
| #63 | 105.34 | 105.48 | 105.62 | 105.76 | 105.90 | 106.04 | 106.18 | 106.32 | 106.46 | 106.60 | 106.74 | 106.88 |
| — | 2.26 | 2.25 | 2.25 | 2.24 | 2.22 | 2.21 | 2.19 | 2.17 | 2.15 | 2.13 | 2.10 | 2.08 |
| #64 | 107.02 | 107.16 | 107.31 | 107.45 | 107.59 | 107.73 | 107.87 | 108.01 | 108.15 | 108.30 | 108.44 | 108.58 |
| — | 2.05 | 2.02 | 2.00 | 1.97 | 1.94 | 1.91 | 1.89 | 1.86 | 1.84 | 1.82 | 1.79 | 1.77 |
| #65 | 108.72 | 108.86 | 109.01 | 109.15 | 109.29 | 109.43 | 109.57 | 109.72 | 109.86 | 110.00 | 110.14 | 110.28 |
| — | 1.75 | 1.74 | 1.72 | 1.71 | 1.70 | 1.69 | 1.68 | 1.67 | 1.67 | 1.66 | 1.66 | 1.66 |
| #66 | 110.43 | 110.57 | 110.71 | 110.85 | 111.00 | 111.14 | 111.28 | 111.42 | 111.56 | 111.71 | 111.85 | 111.99 |
| — | 1.66 | 1.66 | 1.66 | 1.67 | 1.67 | 1.68 | 1.68 | 1.69 | 1.70 | 1.70 | 1.71 | 1.71 |
| #67 | 112.13 | 112.27 | 112.42 | 112.56 | 112.70 | 112.84 | 112.98 | 113.13 | 113.27 | 113.41 | 113.55 | 113.69 |
| — | 1.72 | 1.72 | 1.73 | 1.73 | 1.74 | 1.74 | 1.74 | 1.74 | 1.74 | 1.74 | 1.74 | 1.74 |
| #68 | 113.83 | 113.08 | 114.12 | 114.26 | 114.40 | 114.54 | 114.69 | 114.83 | 114.97 | 115.11 | 115.25 | 115.40 |
| — | 1.74 | 1.74 | 1.73 | 1.73 | 1.73 | 1.72 | 1.72 | 1.72 | 1.71 | 1.71 | 1.71 | 1.71 |
| #69 | 115.54 | 115.68 | 115.82 | 115.96 | 116.11 | 116.25 | 116.39 | 116.53 | 116.67 | 116.82 | 116.96 | 117.10 |
| — | 1.71 | 1.71 | 1.71 | 1.71 | 1.71 | 1.72 | 1.72 | 1.73 | 1.74 | 1.74 | 1.75 | 1.76 |
| #70 | 117.24 | 117.38 | 117.53 | 117.67 | 117.81 | 117.95 | 118.09 | 118.23 | 118.37 | 118.52 | 118.66 | 118.80 |
| — | 1.78 | 1.79 | 1.80 | 1.82 | 1.83 | 1.85 | 1.86 | 1.88 | 1.89 | 1.91 | 1.93 | 1.94 |
| #71 | 118.94 | 119.08 | 119.22 | 119.36 | 119.50 | 119.64 | 119.79 | 119.93 | 120.07 | 120.21 | 120.35 | 120.49 |
| — | 1.96 | 1.97 | 1.99 | 2.00 | 2.01 | 2.02 | 2.03 | 2.04 | 2.05 | 2.06 | 2.06 | 2.06 |
| #72 | 120.63 | 120.77 | 120.91 | 121.05 | 121.19 | 121.33 | 121.48 | 121.62 | 121.76 | 121.90 | 122.04 | 122.18 |
| — | 2.07 | 2.07 | 2.06 | 2.06 | 2.06 | 2.05 | 2.05 | 2.04 | 2.03 | 2.02 | 2.01 | 2.00 |
| #73 | 122.32 | 122.46 | 122.60 | 122.75 | 122.89 | 123.03 | 123.17 | 123.31 | 123.45 | 123.59 | 123.73 | 123.88 |
| — | 1.99 | 1.98 | 1.97 | 1.96 | 1.95 | 1.94 | 1.93 | 1.92 | 1.91 | 1.90 | 1.90 | 1.89 |
| #74 | 124.02 | 124.16 | 124.30 | 124.44 | 124.58 | 124.72 | 124.87 | 125.01 | 125.15 | 125.29 | 125.43 | 125.57 |
| — | 1.88 | 1.88 | 1.87 | 1.87 | 1.86 | 1.86 | 1.86 | 1.85 | 1.85 | 1.85 | 1.85 | 1.85 |
| #75 | 125.71 | 125.86 | 126.00 | 126.14 | 126.28 | 126.42 | 126.56 | 126.71 | 126.85 | 126.99 | 127.13 | 127.27 |
| — | 1.85 | 1.85 | 1.85 | 1.85 | 1.85 | 1.85 | 1.85 | 1.85 | 1.85 | 1.85 | 1.85 | 1.85 |
| #76 | 127.41 | 127.55 | 127.70 | 127.84 | 127.98 | 128.12 | 128.26 | 128.40 | 128.55 | 128.69 | 128.83 | 128.97 |
| — | 1.84 | 1.84 | 1.84 | 1.83 | 1.83 | 1.82 | 1.82 | 1.81 | 1.80 | 1.80 | 1.79 | 1.78 |
| #77 | 129.11 | 129.25 | 129.40 | 129.54 | 129.68 | 129.82 | 129.96 | 130.11 | 130.25 | 130.39 | 130.53 | 130.67 |
| — | 1.78 | 1.77 | 1.76 | 1.75 | 1.75 | 1.74 | 1.73 | 1.73 | 1.72 | 1.72 | 1.71 | 1.71 |
| #78 | 130.82 | 130.96 | 131.10 | 131.24 | 131.38 | 131.53 | 131.67 | 131.81 | 131.95 | 132.09 | 132.24 | 132.38 |
| — | 1.71 | 1.71 | 1.71 | 1.71 | 1.71 | 1.71 | 1.71 | 1.72 | 1.72 | 1.73 | 1.73 | 1.74 |
| #79 | 132.52 | 132.66 | 132.80 | 132.95 | 133.09 | 133.23 | 133.37 | 133.51 | 133.65 | 133.80 | 133.94 | 134.08 |
| — | 1.75 | 1.76 | 1.76 | 1.77 | 1.78 | 1.79 | 1.80 | 1.81 | 1.82 | 1.83 | 1.84 | 1.85 |
| #80 | 134.22 | 134.36 | 134.50 | 134.64 | 134.79 | 134.93 | 135.07 | 135.21 | 135.35 | 135.49 | 135.63 | 135.77 |
| — | 1.86 | 1.87 | 1.88 | 1.89 | 1.90 | 1.90 | 1.91 | 1.92 | 1.92 | 1.93 | 1.93 | 1.93 |
| #81 | 135.92 | 136.06 | 136.20 | 136.34 | 136.48 | 136.62 | 136.76 | 136.90 | 137.05 | 137.19 | 137.33 | 137.47 |
| — | 1.93 | 1.94 | 1.94 | 1.94 | 1.94 | 1.94 | 1.93 | 1.93 | 1.93 | 1.93 | 1.93 | 1.92 |
| #82 | 137.61 | 137.75 | 137.89 | 138.04 | 138.18 | 138.32 | 138.46 | 138.60 | 138.74 | 138.88 | 139.02 | 139.17 |
| — | 1.92 | 1.92 | 1.92 | 1.92 | 1.91 | 1.91 | 1.91 | 1.91 | 1.91 | 1.91 | 1.91 | 1.91 |
| #83 | 139.31 | 139.45 | 139.59 | 139.73 | 139.87 | 140.01 | 140.15 | 140.30 | 140.44 | 140.58 | 140.72 | 140.86 |
| — | 1.91 | 1.91 | 1.91 | 1.91 | 1.92 | 1.92 | 1.92 | 1.92 | 1.93 | 1.93 | 1.93 | 1.93 |
| #84 | 141.00 | 141.14 | 141.29 | 141.43 | 141.57 | | | | | | | |
| — | 1.93 | 1.93 | 1.93 | 1.94 | 1.94 | | | | | | | |

FIG. 23 shows the shape of the microstrip line 5 in the reflection-type bandpass filter 1 of the fifth embodiment. A non-reflecting terminator, or an R=50Ω resistance, is provided at the terminating side (the face at z=141.57 mm) of the reflection-type bandpass filter 1. The thickness of the metal films used in the conducting layer 3 and of the conductor constituting the microstrip line 5 should be adequately greater than the skin depth δs=√{2/(ωμ0σ)} at f=1 GHz. For example if copper is used, the thickness of the conducting layer 3 and of the conductor of the microstrip line 5 should be taken as 2.1 μm or greater. This reflection-type bandpass filter is used in a system where the characteristic impedance is 50Ω.

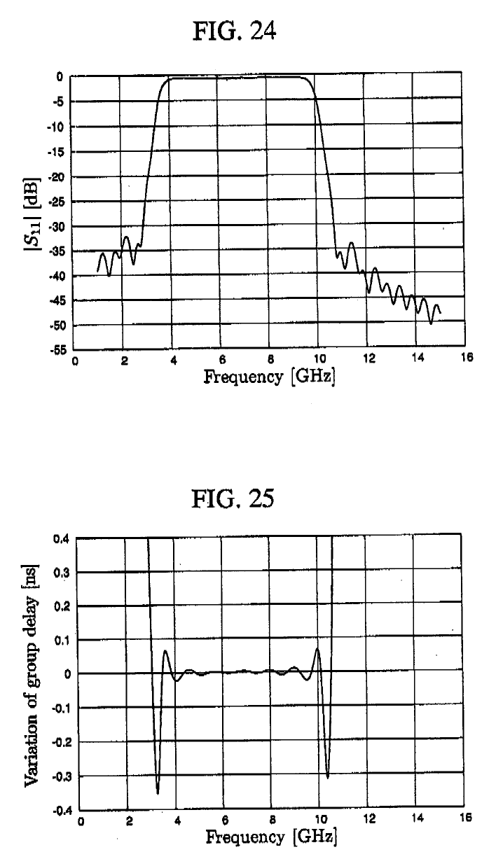

FIG. 24 and FIG. 25 express the amplitude characteristics and group delay frequency characteristics respectively of the reflective wave (S11) in the bandpass filter of the fifth embodiment. For comparison, the characteristics when the Kaiser window is not used, are also shown. As shown in the figures, in the region of frequency f for which 4.0 GHz≦f≦9.6 GHz, the reflectivity is −1 dB or greater and the variation of the group delay is within ±0.05 ns.

### Embodiment 6

A Kaiser window was used for which the reflectivity is 1 at the frequency f in the region 3.7 GHz≦f≦10.0 GHz, and is 0 elsewhere, and for which A=30. Taking 0.3 wavelength at frequency f=1 GHz of the signal transmitted within the microstrip line as the waveguide length, the system characteristic impedance was taken as 50Ω, and the design was carried out.

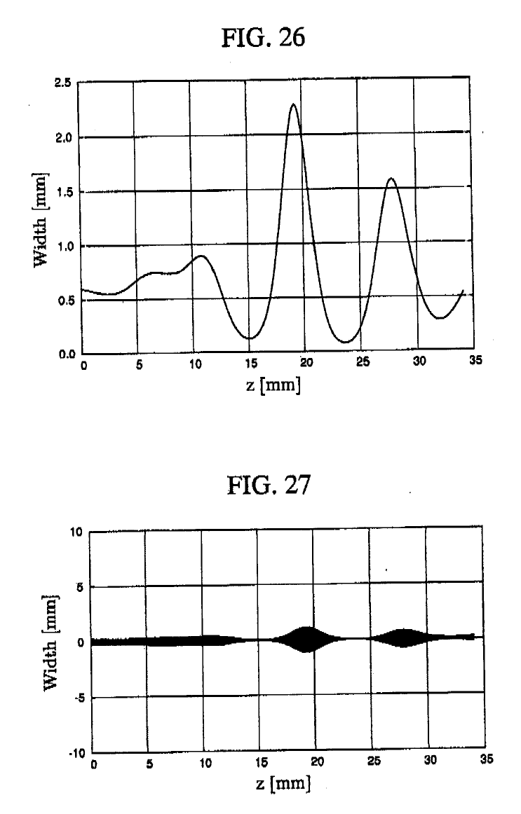

FIG. 26 shows the distribution of the width w of the microstrip line 5 in the z-axis direction when a dielectric layer 4 of thickness h=0.635 mm, and relative dielectric constant ∈ᵣ=10.2 was used. Table 16 lists the widths w of the microstrip line 5.

TABLE 16
Widths of the microstrip line
z[mm]

| | 0.00 | 0.11 | 0.23 | 0.34 | 0.46 | 0.57 | 0.68 | 0.80 | 0.91 | 1.03 | 1.14 | 1.25 |
|---|---|---|---|---|---|---|---|---|---|---|---|---|
| | w[mm] | | | | | | | | | | | |
| | 0.60 | 0.60 | 0.59 | 0.59 | 0.59 | 0.59 | 0.58 | 0.58 | 0.58 | 0.58 | 0.57 | 0.57 |
| #2 | 1.37 | 1.48 | 1.60 | 1.71 | 1.82 | 1.94 | 2.05 | 2.17 | 2.28 | 2.39 | 2.51 | 2.62 |
| — | 0.57 | 0.56 | 0.56 | 0.56 | 0.56 | 0.55 | 0.55 | 0.55 | 0.55 | 0.55 | 0.55 | 0.55 |
| #3 | 2.74 | 2.85 | 2.97 | 3.08 | 3.19 | 3.31 | 3.42 | 3.54 | 3.65 | 3.76 | 3.88 | 3.99 |
| — | 0.55 | 0.55 | 0.55 | 0.55 | 0.56 | 0.56 | 0.57 | 0.57 | 0.58 | 0.58 | 0.59 | 0.60 |
| #4 | 4.11 | 4.22 | 4.33 | 4.45 | 4.56 | 4.67 | 4.79 | 4.90 | 5.01 | 5.13 | 5.24 | 5.35 |
| — | 0.60 | 0.61 | 0.62 | 0.63 | 0.64 | 0.65 | 0.66 | 0.67 | 0.67 | 0.68 | 0.69 | 0.70 |
| #5 | 5.47 | 5.58 | 5.69 | 5.80 | 5.92 | 6.03 | 6.14 | 6.25 | 6.37 | 6.48 | 6.59 | 6.71 |
| — | 0.71 | 0.71 | 0.72 | 0.73 | 0.73 | 0.74 | 0.74 | 0.74 | 0.75 | 0.75 | 0.75 | 0.75 |
| #6 | 6.82 | 6.93 | 7.04 | 7.16 | 7.27 | 7.38 | 7.49 | 7.61 | 7.72 | 7.83 | 7.94 | 8.06 |
| — | 0.75 | 0.75 | 0.75 | 0.74 | 0.74 | 0.74 | 0.74 | 0.74 | 0.73 | 0.73 | 0.73 | 0.73 |
| #7 | 8.17 | 8.28 | 8.40 | 8.51 | 8.62 | 8.73 | 8.85 | 8.96 | 9.07 | 9.18 | 9.30 | 9.41 |
| — | 0.73 | 0.73 | 0.74 | 0.74 | 0.74 | 0.75 | 0.75 | 0.76 | 0.77 | 0.78 | 0.79 | 0.79 |
| #8 | 9.52 | 9.63 | 9.75 | 9.86 | 9.97 | 10.08 | 10.19 | 10.30 | 10.42 | 10.53 | 10.64 | 10.75 |
| — | 0.81 | 0.82 | 0.83 | 0.84 | 0.85 | 0.86 | 0.87 | 0.88 | 0.88 | 0.89 | 0.89 | 0.89 |
| #9 | 10.86 | 10.98 | 11.09 | 11.20 | 11.31 | 11.42 | 11.53 | 11.65 | 11.76 | 11.87 | 11.98 | 12.10 |
| — | 0.89 | 0.89 | 0.88 | 0.87 | 0.86 | 0.85 | 0.83 | 0.81 | 0.78 | 0.76 | 0.73 | 0.70 |
| #10 | 12.21 | 12.32 | 12.44 | 12.55 | 12.67 | 12.78 | 12.90 | 13.01 | 13.13 | 13.24 | 13.36 | 13.48 |
| — | 0.66 | 0.63 | 0.59 | 0.56 | 0.52 | 0.48 | 0.45 | 0.41 | 0.38 | 0.35 | 0.32 | 0.29 |
| #11 | 13.60 | 13.71 | 13.83 | 13.95 | 14.07 | 14.19 | 14.31 | 14.43 | 14.55 | 14.67 | 14.79 | 14.91 |
| — | 0.20 | 0.24 | 0.22 | 0.20 | 0.18 | 0.17 | 0.16 | 0.15 | 0.14 | 0.13 | 0.13 | 0.12 |
| #12 | 15.03 | 15.15 | 15.27 | 15.39 | 15.51 | 15.63 | 15.75 | 15.87 | 15.98 | 16.10 | 16.22 | 16.34 |
| — | 0.12 | 0.12 | 0.13 | 0.13 | 0.14 | 0.15 | 0.16 | 0.17 | 0.19 | 0.21 | 0.24 | 0.27 |
| #13 | 16.45 | 16.57 | 16.69 | 16.80 | 16.92 | 17.03 | 17.14 | 17.26 | 17.37 | 17.48 | 17.59 | 17.70 |
| — | 0.30 | 0.34 | 0.39 | 0.44 | 0.50 | 0.56 | 0.63 | 0.71 | 0.80 | 0.89 | 0.98 | 1.08 |
| #14 | 17.81 | 17.92 | 18.03 | 18.14 | 18.25 | 18.36 | 18.46 | 18.57 | 18.68 | 18.79 | 18.89 | 19.00 |
| — | 1.19 | 1.29 | 1.40 | 1.51 | 1.62 | 1.73 | 1.83 | 1.93 | 2.01 | 2.09 | 2.16 | 2.21 |
| #15 | 19.11 | 19.21 | 19.32 | 19.42 | 19.53 | 19.64 | 19.74 | 19.85 | 19.96 | 20.07 | 20.17 | 20.28 |
| — | 2.25 | 2.27 | 2.27 | 2.26 | 2.23 | 2.19 | 2.13 | 2.05 | 1.97 | 1.88 | 1.77 | 1.67 |
| #16 | 20.39 | 20.50 | 20.61 | 20.72 | 20.83 | 20.94 | 21.05 | 21.16 | 21.28 | 21.39 | 21.50 | 21.62 |
| — | 1.55 | 1.44 | 1.33 | 1.21 | 1.10 | 1.00 | 0.90 | 0.80 | 0.71 | 0.63 | 0.55 | 0.48 |
| #17 | 21.74 | 21.85 | 21.97 | 22.09 | 22.20 | 22.32 | 22.44 | 22.56 | 22.68 | 22.80 | 22.92 | 23.04 |
| — | 0.42 | 0.36 | 0.31 | 0.27 | 0.23 | 0.20 | 0.17 | 0.15 | 0.13 | 0.12 | 0.10 | 0.10 |
| #18 | 23.16 | 23.28 | 23.41 | 23.53 | 23.65 | 23.77 | 23.89 | 24.01 | 24.13 | 24.25 | 24.37 | 24.49 |
| — | 0.09 | 0.08 | 0.08 | 0.08 | 0.08 | 0.08 | 0.08 | 0.09 | 0.09 | 0.10 | 0.11 | 0.13 |
| #19 | 24.61 | 24.73 | 24.85 | 24.97 | 25.09 | 25.21 | 25.32 | 25.44 | 25.55 | 25.67 | 25.78 | 25.90 |
| — | 0.14 | 0.16 | 0.19 | 0.21 | 0.25 | 0.28 | 0.32 | 0.37 | 0.42 | 0.47 | 0.53 | 0.59 |
| #20 | 26.01 | 26.12 | 26.24 | 26.35 | 26.46 | 26.57 | 26.68 | 26.79 | 26.90 | 27.01 | 27.12 | 27.23 |
| — | 0.66 | 0.73 | 0.80 | 0.88 | 0.95 | 1.03 | 1.10 | 1.18 | 1.25 | 1.31 | 1.37 | 1.43 |
| #21 | 27.34 | 27.45 | 27.55 | 27.66 | 27.77 | 27.88 | 27.99 | 28.10 | 28.21 | 28.31 | 28.42 | 28.53 |
| — | 1.47 | 1.51 | 1.55 | 1.57 | 1.58 | 1.58 | 1.58 | 1.56 | 1.54 | 1.51 | 1.47 | 1.43 |
| #22 | 28.64 | 28.75 | 28.86 | 28.97 | 29.08 | 29.19 | 29.30 | 29.41 | 29.52 | 29.64 | 29.75 | 29.86 |
| — | 1.38 | 1.33 | 1.27 | 1.21 | 1.15 | 1.08 | 1.02 | 0.96 | 0.90 | 0.84 | 0.78 | 0.73 |
| #23 | 29.98 | 30.09 | 30.20 | 30.32 | 30.43 | 30.55 | 30.66 | 30.78 | 30.89 | 31.01 | 31.13 | 31.24 |
| — | 0.68 | 0.63 | 0.59 | 0.55 | 0.51 | 0.47 | 0.44 | 0.41 | 0.39 | 0.37 | 0.35 | 0.33 |
| #24 | 31.36 | 31.48 | 31.59 | 31.71 | 31.83 | 31.94 | 32.06 | 32.18 | 32.30 | 32.41 | 32.53 | 32.65 |
| — | 0.32 | 0.31 | 0.30 | 0.29 | 0.29 | 0.28 | 0.28 | 0.29 | 0.29 | 0.29 | 0.30 | 0.31 |
| #25 | 32.76 | 32.88 | 33.00 | 33.11 | 33.23 | 33.34 | 33.46 | 33.58 | 33.69 | 33.81 | 33.92 | 34.03 |
| — | 0.32 | 0.33 | 0.34 | 0.36 | 0.37 | 0.39 | 0.41 | 0.43 | 0.45 | 0.47 | 0.50 | 0.52 |
| #26 | 34.15 | | | | | | | | | | | |
| — | 0.54 | | | | | | | | | | | |

FIG. 27 shows the shape of the microstrip line 5 in the reflection-type band pass filter 1 of the sixth embodiment. A non-reflecting terminator, or an R=50Ω resistance, is provided at the terminating side (the face at z=34.15 mm) of the reflection-type bandpass filter 1. The thickness of the metal films used in the conducting layer 3 and of the conductor constituting the microstrip line 5 should be adequately greater than the skin depth δs=√{2/(ωμ0σ)} at f=1 GHz. For example if copper is used, the thickness of the conducting layer 3 and of the conductor of the microstrip line 5 should be taken as 2.1 μm or greater. This reflection-type bandpass filter is used in a system where the characteristic impedance is 50Ω.

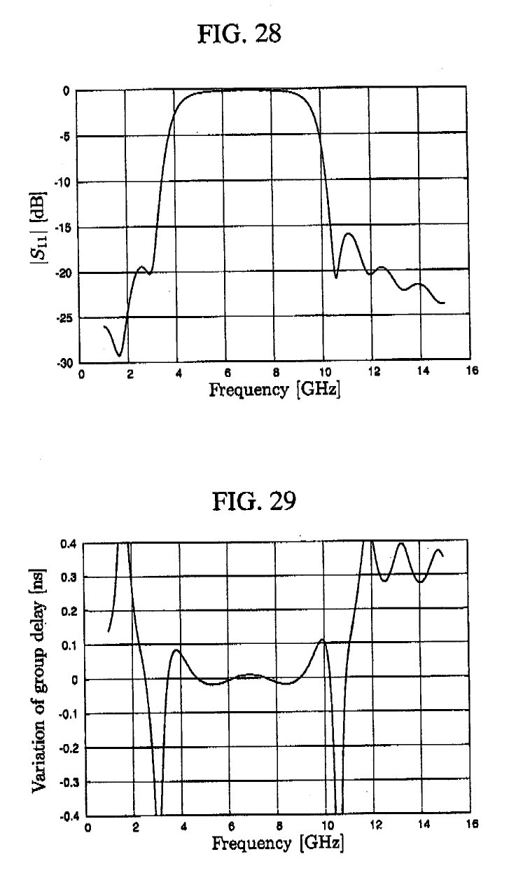

FIG. 28 and FIG. 29 express the amplitude characteristics and group delay frequency characteristics respectively of the reflective wave (S11) in the bandpass filter of the sixth embodiment. As shown in the figures, in the region of frequency f for which 4.2 GHz≦f≦9.6 GHz, the reflectivity is −2 dB or greater and the variation of the group delay is within ±0.15 ns. In the region f<3.1 GHz and f>10.6 GHz, the reflectivity is −15 dB or lower.

### Embodiment 7

A Kaiser window was used for which the reflectivity is 1 at the frequency f in the region 3.3 GHz≦f≦10.4 GHz, and is 0 elsewhere, and for which A=35. Taking one wavelength at frequency f=1 GHz of the signal transmitted within the microstrip line as the waveguide length, the system characteristic impedance was taken as 50Ω, and the design was carried out.

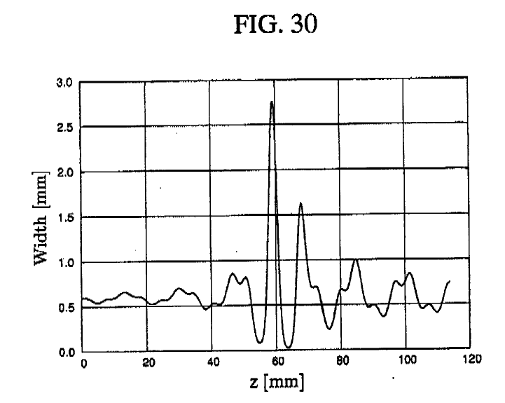

FIG. 30 shows the distribution of the width w of the microstrip line 5 in the z-axis direction when a dielectric layer 4 of thickness h=0.635 mm, and relative dielectric constant ∈ᵣ=10.2 (for example, RT/duroid (registered trademark) 6010LM) was used. Tables 17 through 19 list the widths w of the microstrip line 5.

TABLE 17
Widths of the microstrip line

| | z[mm] | | | | | | | | | | | |
|---|---|---|---|---|---|---|---|---|---|---|---|---|
| | 0.00 | 0.11 | 0.23 | 0.34 | 0.46 | 0.57 | 0.68 | 0.80 | 0.91 | 1.02 | 1.14 | 1.25 |
| | w[mm] | | | | | | | | | | | |
| | 0.60 | 0.60 | 0.60 | 0.59 | 0.59 | 0.59 | 0.59 | 0.59 | 0.59 | 0.59 | 0.59 | 0.59 |
| #2 | 1.37 | 1.48 | 1.59 | 1.71 | 1.82 | 1.94 | 2.05 | 2.16 | 2.28 | 2.39 | 2.50 | 2.62 |
| — | 0.59 | 0.59 | 0.59 | 0.59 | 0.59 | 0.59 | 0.59 | 0.59 | 0.59 | 0.59 | 0.58 | 0.58 |
| #3 | 2.73 | 2.85 | 2.96 | 3.07 | 3.19 | 3.30 | 3.42 | 3.53 | 3.65 | 3.76 | 3.87 | 3.99 |
| — | 0.58 | 0.58 | 0.57 | 0.57 | 0.57 | 0.57 | 0.56 | 0.56 | 0.56 | 0.56 | 0.55 | 0.55 |
| #4 | 4.10 | 4.22 | 4.33 | 4.44 | 4.56 | 4.67 | 4.79 | 4.90 | 5.02 | 5.13 | 5.24 | 5.36 |
| — | 0.55 | 0.55 | 0.55 | 0.55 | 0.54 | 0.54 | 0.54 | 0.54 | 0.54 | 0.54 | 0.54 | 0.54 |
| #5 | 5.47 | 5.59 | 5.70 | 5.82 | 5.93 | 6.04 | 6.16 | 6.27 | 6.39 | 6.50 | 6.61 | 6.73 |
| — | 0.54 | 0.55 | 0.55 | 0.55 | 0.55 | 0.55 | 0.55 | 0.56 | 0.56 | 0.56 | 0.56 | 0.57 |
| #6 | 6.84 | 6.96 | 7.07 | 7.19 | 7.30 | 7.41 | 7.53 | 7.64 | 7.75 | 7.87 | 7.98 | 8.10 |
| — | 0.57 | 0.57 | 0.57 | 0.58 | 0.58 | 0.58 | 0.58 | 0.58 | 0.58 | 0.59 | 0.59 | 0.59 |
| #7 | 8.21 | 8.32 | 8.44 | 8.55 | 8.67 | 8.78 | 8.89 | 9.01 | 9.12 | 9.24 | 9.35 | 9.46 |
| — | 0.59 | 0.59 | 0.59 | 0.59 | 0.59 | 0.59 | 0.59 | 0.59 | 0.59 | 0.59 | 0.59 | 0.59 |
| #8 | 9.58 | 9.69 | 9.80 | 9.92 | 10.03 | 10.15 | 10.26 | 10.37 | 10.49 | 10.60 | 10.72 | 10.83 |
| — | 0.59 | 0.59 | 0.59 | 0.59 | 0.59 | 0.59 | 0.60 | 0.60 | 0.60 | 0.60 | 0.60 | 0.61 |
| #9 | 10.94 | 11.06 | 11.17 | 11.28 | 11.40 | 11.51 | 11.62 | 11.74 | 11.85 | 11.96 | 12.08 | 12.19 |
| — | 0.61 | 0.61 | 0.61 | 0.62 | 0.62 | 0.62 | 0.63 | 0.63 | 0.63 | 0.64 | 0.64 | 0.64 |
| #10 | 12.31 | 12.42 | 12.53 | 12.65 | 12.76 | 12.87 | 12.98 | 13.10 | 13.21 | 13.32 | 13.44 | 13.55 |
| — | 0.65 | 0.65 | 0.65 | 0.66 | 0.66 | 0.66 | 0.66 | 0.66 | 0.66 | 0.66 | 0.66 | 0.66 |
| #11 | 13.66 | 13.78 | 13.89 | 14.00 | 14.12 | 14.23 | 14.34 | 14.46 | 14.57 | 14.69 | 14.80 | 14.91 |
| — | 0.66 | 0.66 | 0.66 | 0.66 | 0.65 | 0.65 | 0.65 | 0.65 | 0.64 | 0.64 | 0.64 | 0.63 |
| #12 | 15.03 | 15.14 | 15.25 | 15.37 | 15.48 | 15.59 | 15.71 | 15.82 | 15.93 | 16.05 | 16.16 | 16.28 |
| — | 0.63 | 0.63 | 0.63 | 0.62 | 0.62 | 0.62 | 0.62 | 0.62 | 0.61 | 0.61 | 0.61 | 0.61 |
| #13 | 16.39 | 16.50 | 16.62 | 16.73 | 16.84 | 16.96 | 17.07 | 17.19 | 17.30 | 17.41 | 17.53 | 17.64 |
| — | 0.61 | 0.61 | 0.61 | 0.61 | 0.61 | 0.61 | 0.61 | 0.61 | 0.61 | 0.61 | 0.61 | 0.61 |
| #14 | 17.75 | 17.87 | 17.98 | 18.09 | 18.21 | 18.32 | 18.44 | 18.55 | 18.66 | 18.78 | 18.89 | 19.01 |
| — | 0.61 | 0.61 | 0.61 | 0.61 | 0.61 | 0.60 | 0.60 | 0.60 | 0.60 | 0.60 | 0.59 | 0.59 |
| #15 | 19.12 | 19.23 | 19.35 | 19.46 | 19.58 | 19.69 | 19.80 | 19.92 | 20.03 | 20.15 | 20.26 | 20.37 |
| — | 0.59 | 0.58 | 0.58 | 0.57 | 0.57 | 0.57 | 0.56 | 0.56 | 0.55 | 0.55 | 0.55 | 0.54 |
| #16 | 20.49 | 20.60 | 20.72 | 20.83 | 20.95 | 21.06 | 21.18 | 21.29 | 21.40 | 21.52 | 21.63 | 21.75 |
| — | 0.54 | 0.54 | 0.53 | 0.53 | 0.53 | 0.52 | 0.52 | 0.52 | 0.52 | 0.52 | 0.52 | 0.52 |
| #17 | 21.86 | 21.98 | 22.09 | 22.21 | 22.32 | 22.43 | 22.55 | 22.66 | 22.78 | 22.89 | 23.01 | 23.12 |
| — | 0.52 | 0.52 | 0.52 | 0.52 | 0.53 | 0.53 | 0.53 | 0.53 | 0.54 | 0.54 | 0.54 | 0.55 |
| #18 | 23.23 | 23.35 | 23.46 | 23.58 | 23.69 | 23.81 | 23.92 | 24.03 | 24.15 | 24.26 | 24.38 | 24.49 |
| — | 0.55 | 0.55 | 0.55 | 0.56 | 0.56 | 0.56 | 0.56 | 0.56 | 0.57 | 0.57 | 0.57 | 0.57 |
| #19 | 24.60 | 24.72 | 24.83 | 24.95 | 25.06 | 25.17 | 25.29 | 25.40 | 25.52 | 25.63 | 25.74 | 25.86 |
| — | 0.57 | 0.57 | 0.57 | 0.57 | 0.57 | 0.57 | 0.57 | 0.57 | 0.57 | 0.57 | 0.57 | 0.57 |
| #20 | 25.97 | 26.09 | 26.20 | 26.31 | 26.43 | 26.54 | 26.66 | 26.77 | 26.88 | 27.00 | 27.11 | 27.23 |
| — | 0.57 | 0.57 | 0.57 | 0.57 | 0.57 | 0.57 | 0.58 | 0.58 | 0.58 | 0.58 | 0.59 | 0.59 |
| #21 | 27.34 | 27.45 | 27.57 | 27.68 | 27.79 | 27.91 | 28.02 | 28.14 | 28.25 | 28.36 | 28.48 | 28.59 |
| — | 0.60 | 0.60 | 0.61 | 0.61 | 0.62 | 0.62 | 0.63 | 0.64 | 0.64 | 0.65 | 0.65 | 0.66 |
| #22 | 28.70 | 28.82 | 28.93 | 29.04 | 29.15 | 29.27 | 29.38 | 29.49 | 29.61 | 29.72 | 29.83 | 29.95 |
| — | 0.67 | 0.67 | 0.68 | 0.68 | 0.69 | 0.69 | 0.69 | 0.69 | 0.70 | 0.70 | 0.70 | 0.70 |
| #23 | 30.06 | 30.17 | 30.28 | 30.40 | 30.51 | 30.62 | 30.74 | 30.85 | 30.96 | 31.08 | 31.19 | 31.30 |
| — | 0.70 | 0.70 | 0.70 | 0.69 | 0.69 | 0.69 | 0.69 | 0.68 | 0.68 | 0.68 | 0.67 | 0.67 |
| #24 | 31.42 | 31.53 | 31.64 | 31.76 | 31.87 | 31.98 | 32.10 | 32.21 | 32.32 | 32.44 | 32.55 | 32.66 |
| — | 0.66 | 0.66 | 0.66 | 0.65 | 0.65 | 0.65 | 0.65 | 0.64 | 0.64 | 0.64 | 0.64 | 0.64 |
| #25 | 32.78 | 32.89 | 33.00 | 33.12 | 33.23 | 33.34 | 33.46 | 33.57 | 33.68 | 33.80 | 33.91 | 34.02 |
| — | 0.64 | 0.64 | 0.64 | 0.64 | 0.64 | 0.64 | 0.64 | 0.64 | 0.64 | 0.64 | 0.64 | 0.64 |
| #26 | 34.14 | 34.25 | 34.37 | 34.48 | 34.59 | 34.71 | 34.82 | 34.93 | 35.05 | 35.16 | 35.27 | 35.39 |
| — | 0.64 | 0.64 | 0.64 | 0.64 | 0.64 | 0.64 | 0.63 | 0.63 | 0.63 | 0.62 | 0.62 | 0.61 |
| #27 | 35.50 | 35.61 | 35.73 | 35.84 | 35.96 | 36.07 | 36.18 | 36.30 | 36.41 | 36.53 | 36.64 | 36.76 |
| — | 0.60 | 0.60 | 0.59 | 0.58 | 0.58 | 0.57 | 0.56 | 0.55 | 0.54 | 0.54 | 0.53 | 0.52 |
| #28 | 36.87 | 36.99 | 37.10 | 37.22 | 37.33 | 37.44 | 37.56 | 37.67 | 37.79 | 37.90 | 38.02 | 38.13 |
| — | 0.51 | 0.51 | 0.50 | 0.49 | 0.49 | 0.48 | 0.48 | 0.48 | 0.47 | 0.47 | 0.47 | 0.47 |
| #29 | 38.25 | 38.36 | 38.48 | 38.59 | 38.71 | 38.82 | 38.94 | 39.05 | 39.17 | 39.28 | 39.40 | 39.51 |
| — | 0.47 | 0.47 | 0.47 | 0.47 | 0.47 | 0.48 | 0.48 | 0.48 | 0.49 | 0.49 | 0.49 | 0.50 |
| #30 | 39.63 | 39.74 | 39.86 | 39.97 | 40.09 | 40.20 | 40.32 | 40.43 | 40.54 | 40.66 | 40.77 | 40.89 |
| — | 0.50 | 0.50 | 0.51 | 0.51 | 0.51 | 0.52 | 0.52 | 0.52 | 0.52 | 0.53 | 0.53 | 0.53 |

TABLE 18
Widths of the microstrip line

| | | | | | | | | | | | | |
|---|---|---|---|---|---|---|---|---|---|---|---|---|
| #31 | 41.00 | 41.12 | 41.23 | 41.35 | 41.46 | 41.57 | 41.69 | 41.80 | 41.92 | 42.03 | 42.15 | 42.26 |
| — | 0.53 | 0.53 | 0.52 | 0.52 | 0.52 | 0.52 | 0.52 | 0.52 | 0.52 | 0.51 | 0.51 | 0.51 |
| #32 | 42.38 | 42.49 | 42.61 | 42.72 | 42.83 | 42.95 | 43.06 | 43.18 | 43.29 | 43.41 | 43.52 | 43.63 |
| — | 0.51 | 0.51 | 0.51 | 0.51 | 0.52 | 0.52 | 0.52 | 0.53 | 0.53 | 0.54 | 0.55 | 0.56 |
| #33 | 43.75 | 43.86 | 43.98 | 44.09 | 44.20 | 44.32 | 44.43 | 44.54 | 44.66 | 44.77 | 44.88 | 45.00 |
| — | 0.57 | 0.58 | 0.59 | 0.60 | 0.61 | 0.63 | 0.64 | 0.66 | 0.67 | 0.69 | 0.71 | 0.72 |
| #34 | 45.11 | 45.22 | 45.33 | 45.45 | 45.56 | 45.67 | 45.78 | 45.90 | 46.01 | 46.12 | 46.23 | 46.34 |
| — | 0.74 | 0.75 | 0.77 | 0.78 | 0.80 | 0.81 | 0.82 | 0.83 | 0.84 | 0.84 | 0.85 | 0.85 |
| #35 | 46.46 | 46.57 | 46.68 | 46.79 | 46.90 | 47.02 | 47.13 | 47.24 | 47.35 | 47.46 | 47.58 | 47.69 |
| — | 0.86 | 0.86 | 0.86 | 0.85 | 0.85 | 0.84 | 0.84 | 0.83 | 0.82 | 0.82 | 0.81 | 0.80 |
| #36 | 47.80 | 47.91 | 48.03 | 48.14 | 48.25 | 48.36 | 48.48 | 48.59 | 48.70 | 48.81 | 48.93 | 49.04 |
| — | 0.79 | 0.78 | 0.78 | 0.77 | 0.76 | 0.76 | 0.75 | 0.75 | 0.75 | 0.74 | 0.74 | 0.75 |
| #37 | 49.15 | 49.26 | 49.38 | 49.49 | 49.60 | 49.71 | 49.83 | 49.94 | 50.05 | 50.16 | 50.28 | 50.39 |
| — | 0.75 | 0.75 | 0.75 | 0.76 | 0.77 | 0.77 | 0.78 | 0.78 | 0.79 | 0.80 | 0.80 | 0.81 |
| #38 | 50.50 | 50.61 | 50.72 | 50.84 | 50.95 | 51.06 | 51.17 | 51.29 | 51.40 | 51.51 | 51.62 | 51.74 |
| — | 0.81 | 0.81 | 0.81 | 0.81 | 0.80 | 0.80 | 0.79 | 0.77 | 0.76 | 0.74 | 0.71 | 0.69 |
| #39 | 51.85 | 51.96 | 52.08 | 52.19 | 52.31 | 52.42 | 52.54 | 52.65 | 52.77 | 52.88 | 53.00 | 53.12 |
| — | 0.66 | 0.63 | 0.60 | 0.57 | 0.53 | 0.50 | 0.46 | 0.42 | 0.39 | 0.35 | 0.32 | 0.29 |
| #40 | 53.24 | 53.35 | 53.47 | 53.59 | 53.71 | 53.83 | 53.95 | 54.07 | 54.19 | 54.31 | 54.43 | 54.55 |
| — | 0.26 | 0.23 | 0.21 | 0.19 | 0.17 | 0.15 | 0.13 | 0.12 | 0.11 | 0.10 | 0.09 | 0.09 |
| #41 | 54.67 | 54.79 | 54.92 | 55.04 | 55.16 | 55.28 | 55.40 | 55.52 | 55.64 | 55.76 | 55.88 | 56.00 |
| — | 0.08 | 0.08 | 0.08 | 0.08 | 0.08 | 0.09 | 0.09 | 0.10 | 0.11 | 0.12 | 0.14 | 0.16 |
| #42 | 56.12 | 56.24 | 56.36 | 56.47 | 56.59 | 56.71 | 56.82 | 56.94 | 57.05 | 57.16 | 57.28 | 57.39 |
| — | 0.18 | 0.21 | 0.24 | 0.28 | 0.33 | 0.39 | 0.45 | 0.52 | 0.60 | 0.68 | 0.78 | 0.89 |
| #43 | 57.50 | 57.61 | 57.72 | 57.83 | 57.94 | 58.04 | 58.15 | 58.26 | 58.37 | 58.47 | 58.58 | 58.68 |
| — | 1.00 | 1.12 | 1.24 | 1.38 | 1.52 | 1.66 | 1.80 | 1.94 | 2.08 | 2.21 | 2.34 | 2.45 |
| #44 | 58.79 | 58.90 | 59.00 | 59.11 | 59.21 | 59.32 | 59.42 | 59.53 | 59.63 | 59.74 | 59.84 | 59.95 |
| — | 2.55 | 2.63 | 2.70 | 2.74 | 2.76 | 2.76 | 2.73 | 2.68 | 2.61 | 2.52 | 2.41 | 2.29 |
| #45 | 60.06 | 60.16 | 60.27 | 60.38 | 60.49 | 60.60 | 60.71 | 60.82 | 60.93 | 61.04 | 61.15 | 61.27 |
| — | 2.15 | 2.01 | 1.86 | 1.71 | 1.56 | 1.42 | 1.27 | 1.13 | 1.00 | 0.88 | 0.76 | 0.66 |
| #46 | 61.38 | 61.50 | 61.61 | 61.73 | 61.85 | 61.96 | 62.08 | 62.20 | 62.32 | 62.44 | 62.56 | 62.69 |
| — | 0.56 | 0.47 | 0.40 | 0.33 | 0.27 | 0.22 | 0.18 | 0.15 | 0.12 | 0.10 | 0.08 | 0.06 |
| #47 | 62.81 | 62.93 | 63.05 | 63.18 | 63.30 | 63.42 | 63.55 | 63.67 | 63.79 | 63.92 | 64.04 | 64.16 |
| — | 0.05 | 0.04 | 0.04 | 0.03 | 0.03 | 0.03 | 0.03 | 0.03 | 0.03 | 0.03 | 0.03 | 0.04 |
| #48 | 64.29 | 64.41 | 64.53 | 64.65 | 64.77 | 64.90 | 65.02 | 65.14 | 65.25 | 65.37 | 65.49 | 65.61 |
| — | 0.04 | 0.05 | 0.06 | 0.07 | 0.08 | 0.10 | 0.12 | 0.15 | 0.18 | 0.21 | 0.26 | 0.31 |
| #49 | 65.72 | 65.84 | 65.95 | 66.07 | 66.18 | 66.29 | 66.41 | 66.52 | 66.63 | 66.74 | 66.85 | 66.96 |
| — | 0.36 | 0.42 | 0.49 | 0.50 | 0.64 | 0.72 | 0.80 | 0.88 | 0.97 | 1.05 | 1.14 | 1.22 |
| #50 | 67.07 | 67.18 | 67.29 | 67.40 | 67.51 | 67.61 | 67.72 | 67.83 | 67.94 | 68.05 | 68.16 | 68.26 |
| — | 1.29 | 1.37 | 1.43 | 1.49 | 1.53 | 1.57 | 1.60 | 1.62 | 1.63 | 1.63 | 1.61 | 1.59 |
| #51 | 68.37 | 68.48 | 68.59 | 68.70 | 68.81 | 68.92 | 69.03 | 69.14 | 69.25 | 69.36 | 69.47 | 69.58 |
| — | 1.57 | 1.53 | 1.49 | 1.45 | 1.40 | 1.35 | 1.30 | 1.25 | 1.19 | 1.14 | 1.09 | 1.05 |
| #52 | 69.69 | 69.80 | 69.91 | 70.02 | 70.14 | 70.25 | 70.36 | 70.47 | 70.59 | 70.70 | 70.81 | 70.92 |
| — | 1.00 | 0.96 | 0.92 | 0.88 | 0.85 | 0.82 | 0.80 | 0.77 | 0.75 | 0.74 | 0.72 | 0.71 |
| #53 | 71.04 | 71.15 | 71.26 | 71.38 | 71.49 | 71.60 | 71.72 | 71.83 | 71.94 | 72.05 | 72.17 | 72.28 |
| — | 0.71 | 0.70 | 0.70 | 0.69 | 0.69 | 0.69 | 0.70 | 0.70 | 0.70 | 0.70 | 0.71 | 0.71 |
| #54 | 72.39 | 72.51 | 72.62 | 72.73 | 72.84 | 72.96 | 73.07 | 73.18 | 73.30 | 73.41 | 73.52 | 73.64 |
| — | 0.71 | 0.71 | 0.70 | 0.70 | 0.69 | 0.69 | 0.68 | 0.67 | 0.65 | 0.64 | 0.62 | 0.60 |
| #55 | 73.75 | 73.87 | 73.98 | 74.10 | 74.21 | 74.33 | 74.44 | 74.56 | 74.67 | 74.79 | 74.90 | 75.02 |
| — | 0.58 | 0.55 | 0.53 | 0.51 | 0.48 | 0.46 | 0.44 | 0.41 | 0.39 | 0.37 | 0.35 | 0.33 |
| #56 | 75.14 | 75.26 | 75.37 | 75.49 | 75.61 | 75.73 | 75.84 | 75.96 | 76.08 | 76.20 | 76.32 | 76.43 |
| — | 0.31 | 0.30 | 0.28 | 0.27 | 0.26 | 0.25 | 0.24 | 0.24 | 0.23 | 0.23 | 0.23 | 0.23 |
| #57 | 76.55 | 76.67 | 76.79 | 76.90 | 77.02 | 77.14 | 77.26 | 77.37 | 77.49 | 77.61 | 77.72 | 77.84 |
| — | 0.23 | 0.23 | 0.24 | 0.25 | 0.26 | 0.27 | 0.28 | 0.29 | 0.31 | 0.32 | 0.34 | 0.36 |
| #58 | 77.96 | 78.07 | 78.19 | 78.30 | 78.42 | 78.53 | 78.65 | 78.76 | 78.88 | 78.99 | 79.10 | 79.22 |
| — | 0.38 | 0.40 | 0.42 | 0.44 | 0.46 | 0.48 | 0.51 | 0.53 | 0.55 | 0.57 | 0.58 | 0.60 |
| #59 | 79.33 | 79.45 | 79.56 | 79.67 | 79.79 | 79.90 | 80.01 | 80.13 | 80.24 | 80.35 | 80.46 | 80.58 |
| — | 0.62 | 0.63 | 0.64 | 0.65 | 0.66 | 0.66 | 0.67 | 0.67 | 0.67 | 0.67 | 0.67 | 0.67 |
| #60 | 80.69 | 80.80 | 80.92 | 81.03 | 81.14 | 81.26 | 81.37 | 81.48 | 81.60 | 81.71 | 81.82 | 81.94 |
| — | 0.67 | 0.66 | 0.66 | 0.66 | 0.66 | 0.66 | 0.65 | 0.65 | 0.66 | 0.66 | 0.66 | 0.67 |

TABLE 19
Widths of the microstrip line

| | | | | | | | | | | | | |
|---|---|---|---|---|---|---|---|---|---|---|---|---|
| #61 | 82.05 | 82.16 | 82.28 | 82.39 | 82.50 | 82.62 | 82.73 | 82.84 | 82.95 | 83.07 | 83.18 | 83.29 |
| — | 0.67 | 0.68 | 0.69 | 0.70 | 0.71 | 0.73 | 0.74 | 0.76 | 0.77 | 0.79 | 0.81 | 0.83 |
| #62 | 83.40 | 83.51 | 83.63 | 83.74 | 83.85 | 83.96 | 84.07 | 84.18 | 84.29 | 84.40 | 84.52 | 84.63 |
| — | 0.85 | 0.87 | 0.89 | 0.91 | 0.93 | 0.94 | 0.96 | 0.97 | 0.98 | 0.99 | 1.00 | 1.00 |
| #63 | 84.74 | 84.85 | 84.96 | 85.07 | 85.18 | 85.29 | 85.41 | 85.52 | 85.63 | 85.74 | 85.85 | 85.96 |
| — | 1.00 | 1.00 | 1.00 | 0.99 | 0.98 | 0.96 | 0.95 | 0.93 | 0.91 | 0.88 | 0.86 | 0.84 |
| #64 | 86.08 | 86.19 | 86.30 | 86.41 | 86.53 | 86.64 | 86.75 | 86.87 | 86.98 | 87.09 | 87.21 | 87.32 |
| — | 0.81 | 0.79 | 0.76 | 0.73 | 0.71 | 0.68 | 0.66 | 0.64 | 0.62 | 0.60 | 0.58 | 0.56 |
| #65 | 87.44 | 87.55 | 87.67 | 87.78 | 87.89 | 88.01 | 88.12 | 88.24 | 88.35 | 88.47 | 88.58 | 88.70 |
| — | 0.54 | 0.53 | 0.52 | 0.51 | 0.50 | 0.49 | 0.48 | 0.48 | 0.48 | 0.47 | 0.47 | 0.47 |
| #66 | 88.81 | 88.93 | 89.04 | 89.16 | 89.27 | 89.39 | 89.50 | 89.62 | 89.73 | 89.85 | 89.96 | 90.08 |
| — | 0.47 | 0.48 | 0.48 | 0.48 | 0.48 | 0.49 | 0.49 | 0.49 | 0.50 | 0.50 | 0.50 | 0.50 |
| #67 | 90.19 | 90.31 | 90.42 | 90.54 | 90.65 | 90.76 | 90.88 | 90.99 | 91.11 | 91.22 | 91.34 | 91.46 |
| — | 0.50 | 0.50 | 0.50 | 0.50 | 0.49 | 0.49 | 0.48 | 0.48 | 0.47 | 0.46 | 0.46 | 0.45 |
| #68 | 91.57 | 91.69 | 91.80 | 91.92 | 92.03 | 92.15 | 92.26 | 92.38 | 92.50 | 92.61 | 92.73 | 92.84 |
| — | 0.44 | 0.43 | 0.42 | 0.41 | 0.41 | 0.40 | 0.39 | 0.38 | 0.38 | 0.37 | 0.37 | 0.37 |
| #69 | 92.96 | 93.08 | 93.19 | 93.31 | 93.42 | 93.54 | 93.66 | 93.77 | 93.89 | 94.00 | 94.12 | 94.24 |
| — | 0.36 | 0.36 | 0.36 | 0.36 | 0.37 | 0.37 | 0.38 | 0.38 | 0.39 | 0.40 | 0.41 | 0.42 |
| #70 | 94.35 | 94.47 | 94.58 | 94.70 | 94.81 | 94.92 | 95.04 | 95.15 | 95.27 | 95.38 | 95.49 | 95.61 |
| — | 0.44 | 0.45 | 0.47 | 0.48 | 0.50 | 0.52 | 0.54 | 0.56 | 0.57 | 0.59 | 0.61 | 0.63 |
| #71 | 95.72 | 95.84 | 95.95 | 96.06 | 96.17 | 96.29 | 96.40 | 96.51 | 96.63 | 96.74 | 96.85 | 96.96 |
| — | 0.65 | 0.66 | 0.68 | 0.69 | 0.71 | 0.72 | 0.73 | 0.74 | 0.74 | 0.75 | 0.75 | 0.75 |
| #72 | 97.08 | 97.19 | 97.30 | 97.41 | 97.53 | 97.64 | 97.75 | 97.86 | 97.98 | 98.09 | 98.20 | 98.32 |
| — | 0.75 | 0.75 | 0.75 | 0.75 | 0.75 | 0.74 | 0.74 | 0.73 | 0.73 | 0.72 | 0.72 | 0.71 |
| #73 | 98.43 | 98.54 | 98.65 | 98.77 | 98.88 | 98.99 | 99.11 | 99.22 | 99.33 | 99.45 | 99.56 | 99.67 |
| — | 0.71 | 0.71 | 0.70 | 0.70 | 0.70 | 0.70 | 0.71 | 0.71 | 0.71 | 0.72 | 0.72 | 0.73 |
| #74 | 99.78 | 99.90 | 100.01 | 100.12 | 100.23 | 100.35 | 100.46 | 100.57 | 100.68 | 100.80 | 100.91 | 101.02 |
| — | 0.74 | 0.75 | 0.75 | 0.76 | 0.77 | 0.78 | 0.79 | 0.80 | 0.81 | 0.82 | 0.83 | 0.83 |
| #75 | 101.13 | 101.24 | 101.36 | 101.47 | 101.58 | 101.69 | 101.80 | 101.92 | 102.03 | 102.14 | 102.25 | 102.36 |
| — | 0.84 | 0.84 | 0.84 | 0.84 | 0.84 | 0.84 | 0.83 | 0.83 | 0.82 | 0.81 | 0.79 | 0.78 |
| #76 | 102.48 | 102.59 | 102.70 | 102.82 | 102.93 | 103.04 | 103.16 | 103.27 | 103.38 | 103.50 | 103.61 | 103.72 |
| — | 0.76 | 0.75 | 0.73 | 0.71 | 0.69 | 0.68 | 0.66 | 0.64 | 0.62 | 0.60 | 0.58 | 0.57 |
| #77 | 103.84 | 103.95 | 104.07 | 104.18 | 104.30 | 104.41 | 104.53 | 104.64 | 104.76 | 104.87 | 104.99 | 105.10 |
| — | 0.55 | 0.54 | 0.52 | 0.51 | 0.50 | 0.49 | 0.48 | 047 | 0.46 | 0.46 | 0.46 | 0.45 |
| #78 | 105.22 | 105.33 | 105.45 | 105.56 | 105.68 | 105.79 | 105.91 | 106.02 | 106.14 | 106.25 | 106.37 | 106.48 |
| — | 0.45 | 0.45 | 0.45 | 0.45 | 0.45 | 0.46 | 0.46 | 0.46 | 0.47 | 0.47 | 0.47 | 0.48 |
| #79 | 106.60 | 106.71 | 106.83 | 106.94 | 107.06 | 107.17 | 107.29 | 107.40 | 107.52 | 107.63 | 107.75 | 107.86 |
| — | 0.48 | 0.48 | 0.49 | 0.49 | 0.49 | 0.49 | 0.49 | 0.49 | 0.49 | 0.49 | 0.49 | 0.48 |
| #80 | 107.97 | 108.09 | 108.20 | 108.32 | 108.43 | 108.55 | 108.67 | 108.78 | 108.90 | 109.01 | 109.13 | 109.24 |
| — | 0.48 | 0.48 | 0.47 | 0.46 | 0.46 | 0.45 | 0.45 | 0.44 | 0.43 | 0.43 | 0.42 | 0.42 |
| #81 | 109.36 | 109.47 | 109.59 | 109.70 | 109.82 | 109.94 | 110.05 | 110.17 | 110.28 | 110.40 | 110.51 | 110.63 |
| — | 0.41 | 0.41 | 0.41 | 0.41 | 0.41 | 0.41 | 0.41 | 0.41 | 0.42 | 0.42 | 0.43 | 0.43 |
| #82 | 110.74 | 110.86 | 110.97 | 111.09 | 111.20 | 111.32 | 111.43 | 111.55 | 111.66 | 111.78 | 111.89 | 112.00 |
| — | 0.44 | 0.45 | 0.46 | 0.47 | 0.49 | 0.50 | 0.52 | 0.53 | 0.55 | 0.56 | 0.58 | 0.59 |
| #83 | 112.12 | 112.23 | 112.34 | 112.46 | 112.57 | 112.68 | 112.80 | 112.91 | 113.02 | 113.14 | 113.25 | 113.36 |
| — | 0.61 | 0.63 | 0.64 | 0.66 | 0.67 | 0.68 | 0.69 | 0.70 | 0.71 | 0.72 | 0.73 | 0.73 |
| #84 | 113.47 | 113.59 | 113.70 | 113.81 | 113.93 | | | | | | | |
| — | 0.73 | 0.74 | 0.74 | 0.74 | 0.74 | | | | | | | |

FIG. 31 shows the shape of the microstrip line 5 in the reflection-type bandpass filter 1 of the seventh embodiment. A non-reflecting terminator, or an R=50Ω resistance, is provided at the terminating side (the face at z=113.93 mm) of the reflection-type bandpass filter 1. The thickness of the metal films used in the conducting layer 3 and of the conductor constituting the microstrip line 5 should be adequately greater than the skin depth δs=√{2/(ωμ0σ)} at f=1 GHz. For example if copper is used, the thickness of the conducting layer 3 and of the conductor of the microstrip line 5 should be taken as 2.1 μm or greater. This reflection-type bandpass filter is used in a system where the characteristic impedance is 50Ω.

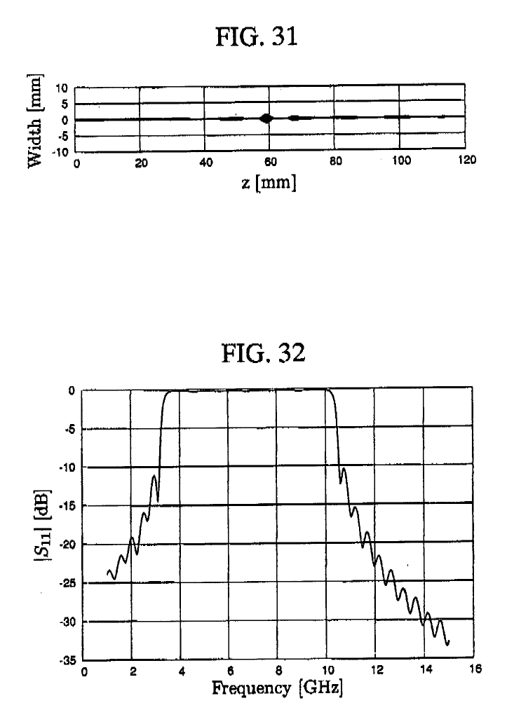

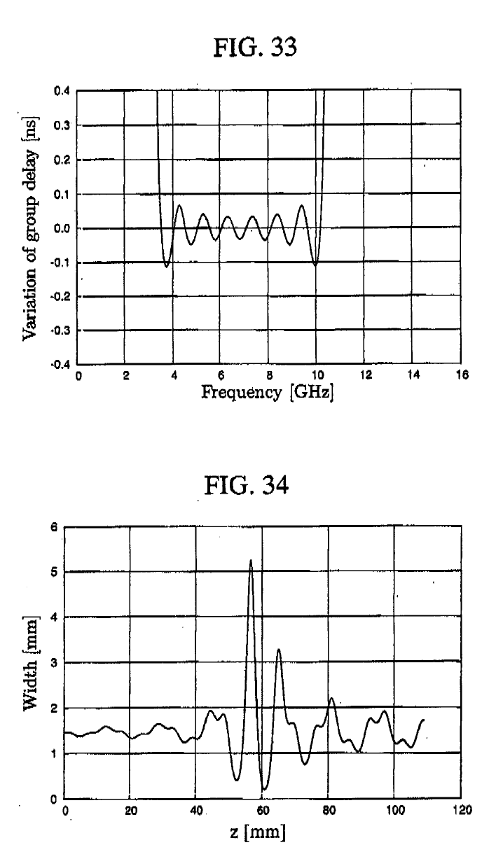

FIG. 32 and FIG. 33 express the amplitude characteristics and group delay frequency characteristics respectively of the reflective wave (S11) in the bandpass filter of the seventh embodiment. As shown in the figures, in the region of frequency f for which 3.4 GHz≦f≦10.3 GHz, the reflectivity is −0.5 dB or greater and the variation of the group delay is within ±0.1 ns. In the region f<3.1 GHz and f>10.6 GHz, the reflectivity is −10 dB or lower.

### Embodiment 8

A Kaiser window was used for which the reflectivity is 1 at the frequency f in the region 3.3 GHz≦f≦10.4 GHz, and is 0 elsewhere, and for which A=35. Taking one wavelength at frequency f=1 GHz of the signal transmitted within the microstrip line as the waveguide length, the system characteristic impedance was taken as 30Ω, and the design was carried out.

FIG. 34 shows the distribution of the width w of the microstrip line 5 in the z-axis direction when a dielectric layer 4 of thickness h=0.635 mm, and relative dielectric constant ∈ᵣ=10.2 (for example, RT/duroid (registered trademark) 6010LM) was used. Tables 20 through 22 list the widths w of the microstrip line 5.

TABLE 20
Widths of the microstrip line

| | z[mm] | | | | | | | | | | | |
|---|---|---|---|---|---|---|---|---|---|---|---|---|
| | 0.00 | 0.11 | 0.22 | 0.33 | 0.44 | 0.54 | 0.65 | 0.76 | 0.87 | 0.98 | 1.09 | 1.20 |
| | w[mm] | | | | | | | | | | | |
| | 1.47 | 1.47 | 1.47 | 1.47 | 1.47 | 1.47 | 1.47 | 1.47 | 1.47 | 1.47 | 1.47 | 1.47 |
| #2 | 1.31 | 1.42 | 1.52 | 1.63 | 1.74 | 1.85 | 1.96 | 2.07 | 2.18 | 2.29 | 2.40 | 2.50 |
| — | 1.47 | 1.47 | 1.47 | 1.47 | 1.46 | 1.46 | 1.46 | 1.46 | 1.46 | 1.45 | 1.45 | 1.45 |
| #3 | 2.61 | 2.72 | 2.83 | 2.94 | 3.05 | 3.16 | 3.27 | 3.38 | 3.49 | 3.59 | 3.70 | 3.81 |
| — | 1.44 | 1.44 | 1.43 | 1.43 | 1.42 | 1.42 | 1.41 | 1.41 | 1.40 | 1.40 | 1.40 | 1.39 |
| #4 | 3.92 | 4.03 | 4.14 | 4.25 | 4.36 | 4.47 | 4.58 | 4.69 | 4.80 | 4.91 | 5.01 | 5.12 |
| — | 1.39 | 1.38 | 1.38 | 1.38 | 1.38 | 1.38 | 1.37 | 1.37 | 1.37 | 1.37 | 1.37 | 1.38 |
| #5 | 5.23 | 5.34 | 5.45 | 5.56 | 5.67 | 5.78 | 5.89 | 6.00 | 6.11 | 6.22 | 6.32 | 6.43 |
| — | 1.38 | 1.38 | 1.38 | 1.39 | 1.39 | 1.39 | 1.40 | 1.40 | 1.40 | 1.41 | 1.41 | 1.42 |
| #6 | 6.54 | 6.65 | 6.76 | 6.87 | 6.98 | 7.09 | 7.20 | 7.31 | 7.41 | 7.52 | 7.63 | 7.74 |
| — | 1.42 | 1.43 | 1.43 | 1.43 | 1.44 | 1.44 | 1.45 | 1.45 | 1.45 | 1.45 | 1.45 | 1.46 |
| #7 | 7.85 | 7.96 | 8.07 | 8.18 | 8.29 | 8.40 | 8.50 | 8.61 | 8.72 | 8.83 | 8.94 | 9.05 |
| — | 1.46 | 1.46 | 1.46 | 1.46 | 1.46 | 1.46 | 1.46 | 1.46 | 1.46 | 1.46 | 1.46 | 1.46 |
| #8 | 9.16 | 9.27 | 9.38 | 9.48 | 9.59 | 9.70 | 9.81 | 9.92 | 10.03 | 10.14 | 10.25 | 10.35 |
| — | 1.46 | 1.46 | 1.46 | 1.46 | 1.47 | 1.47 | 1.47 | 1.47 | 1.48 | 1.48 | 1.48 | 1.49 |
| #9 | 10.46 | 10.57 | 10.68 | 10.79 | 10.90 | 11.01 | 11.12 | 11.22 | 11.33 | 11.44 | 11.55 | 11.66 |
| — | 1.49 | 1.50 | 1.50 | 1.51 | 1.52 | 1.52 | 1.53 | 1.54 | 1.54 | 1.55 | 1.55 | 1.56 |
| #10 | 11.77 | 11.88 | 11.98 | 12.09 | 12.20 | 12.31 | 12.42 | 12.53 | 12.63 | 12.74 | 12.85 | 12.96 |
| — | 1.57 | 1.57 | 1.57 | 1.58 | 1.58 | 1.59 | 1.59 | 1.59 | 1.59 | 1.59 | 1.59 | 1.59 |
| #11 | 13.07 | 13.18 | 13.29 | 13.39 | 13.50 | 13.61 | 13.72 | 13.83 | 13.94 | 14.04 | 14.15 | 14.26 |
| — | 1.59 | 1.58 | 1.58 | 1.58 | 1.57 | 1.57 | 1.57 | 1.56 | 1.56 | 1.55 | 1.55 | 1.54 |
| #12 | 14.37 | 14.48 | 14.59 | 14.70 | 14.80 | 14.91 | 15.02 | 15.13 | 15.24 | 15.35 | 15.46 | 15.57 |
| — | 1.54 | 1.53 | 1.53 | 1.52 | 1.52 | 1.51 | 1.51 | 1.51 | 1.50 | 1.50 | 1.50 | 1.50 |
| #13 | 15.67 | 15.78 | 15.89 | 16.00 | 16.11 | 16.22 | 16.33 | 16.44 | 16.54 | 16.65 | 16.76 | 16.87 |
| — | 1.50 | 1.50 | 1.50 | 1.50 | 1.50 | 1.50 | 1.50 | 1.50 | 1.50 | 1.50 | 1.50 | 1.50 |
| #14 | 16.98 | 17.09 | 17.20 | 17.31 | 17.41 | 17.52 | 17.63 | 17.74 | 17.85 | 17.96 | 18.07 | 18.18 |
| — | 1.50 | 1.49 | 1.49 | 1.49 | 1.49 | 1.49 | 1.48 | 1.48 | 1.48 | 1.47 | 1.47 | 1.46 |
| #15 | 18.29 | 18.39 | 18.50 | 18.61 | 18.72 | 18.83 | 18.94 | 19.05 | 19.16 | 19.27 | 19.38 | 19.49 |
| — | 1.45 | 1.45 | 1.44 | 1.43 | 1.43 | 1.42 | 1.41 | 1.40 | 1.40 | 1.39 | 1.38 | 1.37 |
| #16 | 19.60 | 19.70 | 19.81 | 19.92 | 20.03 | 20.14 | 20.25 | 20.36 | 20.47 | 20.58 | 20.69 | 20.80 |
| — | 1.37 | 1.36 | 1.36 | 1.35 | 1.35 | 1.34 | 1.34 | 1.34 | 1.33 | 1.33 | 1.33 | 1.33 |
| #17 | 20.91 | 21.02 | 21.13 | 21.24 | 21.35 | 21.45 | 21.56 | 21.67 | 21.78 | 21.89 | 22.00 | 22.11 |
| — | 1.33 | 1.34 | 1.34 | 1.34 | 1.35 | 1.35 | 1.35 | 1.36 | 1.36 | 1.37 | 1.37 | 1.38 |
| #18 | 22.22 | 22.33 | 22.44 | 22.55 | 22.66 | 22.77 | 22.87 | 22.98 | 23.09 | 23.20 | 23.31 | 23.42 |
| — | 1.38 | 1.39 | 1.39 | 1.40 | 1.40 | 1.41 | 1.41 | 1.41 | 1.42 | 1.42 | 1.42 | 1.42 |
| #19 | 23.53 | 23.64 | 23.75 | 23.86 | 23.97 | 24.07 | 24.18 | 24.29 | 24.40 | 24.51 | 24.62 | 24.73 |
| — | 1.42 | 1.42 | 1.42 | 1.42 | 1.42 | 1.42 | 1.42 | 1.42 | 1.42 | 1.42 | 1.42 | 1.42 |
| #20 | 24.84 | 24.95 | 25.06 | 25.16 | 25.27 | 25.38 | 25.49 | 25.60 | 25.71 | 25.82 | 25.93 | 26.04 |
| — | 1.42 | 1.42 | 1.42 | 1.43 | 1.43 | 1.43 | 1.44 | 1.44 | 1.45 | 1.45 | 1.46 | 1.47 |
| #21 | 26.15 | 26.25 | 26.36 | 26.47 | 26.58 | 26.69 | 26.80 | 26.91 | 27.01 | 27.12 | 27.23 | 27.34 |
| — | 1.47 | 1.48 | 1.49 | 1.50 | 1.51 | 1.52 | 1.53 | 1.54 | 1.56 | 1.57 | 1.58 | 1.59 |
| #22 | 27.45 | 27.56 | 27.67 | 27.77 | 27.88 | 27.99 | 28.10 | 28.21 | 28.31 | 28.42 | 28.53 | 28.64 |
| — | 1.60 | 1.61 | 1.62 | 1.62 | 1.63 | 1.64 | 1.64 | 1.65 | 1.65 | 1.65 | 1.66 | 1.66 |
| #23 | 28.75 | 28.86 | 28.96 | 29.07 | 29.18 | 29.29 | 29.40 | 29.50 | 29.61 | 29.72 | 29.83 | 29.94 |
| — | 1.66 | 1.65 | 1.65 | 1.65 | 1.64 | 1.64 | 1.63 | 1.63 | 1.62 | 1.61 | 1.61 | 1.60 |
| #24 | 30.05 | 30.15 | 30.26 | 30.37 | 30.48 | 30.59 | 30.70 | 30.81 | 30.91 | 31.02 | 31.13 | 31.24 |
| — | 1.59 | 1.59 | 1.58 | 1.58 | 1.57 | 1.57 | 1.56 | 1.56 | 1.55 | 1.55 | 1.55 | 1.55 |
| #25 | 31.35 | 31.46 | 31.57 | 31.67 | 31.78 | 31.89 | 32.00 | 32.11 | 32.22 | 32.33 | 32.43 | 32.54 |
| — | 1.55 | 1.55 | 1.55 | 1.55 | 1.55 | 1.55 | 1.55 | 1.55 | 1.56 | 1.56 | 1.56 | 1.56 |
| #26 | 32.65 | 32.76 | 32.87 | 32.98 | 33.08 | 33.19 | 33.30 | 33.41 | 33.52 | 33.63 | 33.74 | 33.85 |
| — | 1.56 | 1.56 | 1.56 | 1.55 | 1.55 | 1.55 | 1.54 | 1.53 | 1.53 | 1.52 | 1.51 | 1.50 |
| #27 | 33.95 | 34.06 | 34.17 | 34.28 | 34.39 | 34.50 | 34.61 | 34.72 | 34.83 | 34.94 | 35.05 | 35.15 |
| — | 1.49 | 1.48 | 1.46 | 1.45 | 1.43 | 1.42 | 1.41 | 1.39 | 1.38 | 1.36 | 1.35 | 1.33 |
| #28 | 35.26 | 35.37 | 35.48 | 35.59 | 35.70 | 35.81 | 35.92 | 36.03 | 36.14 | 36.25 | 36.36 | 36.47 |
| — | 1.32 | 1.31 | 1.29 | 1.28 | 1.27 | 1.27 | 1.26 | 1.25 | 1.25 | 1.24 | 1.24 | 1.24 |
| #29 | 36.58 | 36.69 | 36.80 | 36.91 | 37.02 | 37.13 | 37.24 | 37.35 | 37.46 | 37.57 | 37.68 | 37.79 |
| — | 1.24 | 1.24 | 1.24 | 1.24 | 1.25 | 1.25 | 1.26 | 1.26 | 1.27 | 1.28 | 1.28 | 1.29 |
| #30 | 37.90 | 38.01 | 38.12 | 38.23 | 38.34 | 38.45 | 38.55 | 38.66 | 38.77 | 38.88 | 38.99 | 39.10 |
| — | 1.30 | 1.30 | 1.31 | 1.32 | 1.32 | 1.33 | 1.33 | 1.34 | 1.34 | 1.34 | 1.34 | 1.34 |

TABLE 21
Widths of the microstrip line

| | | | | | | | | | | | | |
|---|---|---|---|---|---|---|---|---|---|---|---|---|
| #31 | 39.21 | 39.32 | 39.43 | 39.54 | 39.65 | 39.76 | 39.87 | 39.98 | 40.09 | 40.20 | 40.31 | 40.42 |
| — | 1.34 | 1.34 | 1.34 | 1.34 | 1.34 | 1.33 | 1.33 | 1.33 | 1.32 | 1.32 | 1.32 | 1.32 |
| #32 | 40.52 | 40.63 | 40.74 | 40.85 | 40.96 | 41.07 | 41.18 | 41.29 | 41.40 | 41.51 | 41.62 | 41.73 |
| — | 1.32 | 1.32 | 1.32 | 1.32 | 1.33 | 1.33 | 1.34 | 1.35 | 1.36 | 1.37 | 1.38 | 1.40 |
| #33 | 41.84 | 41.95 | 42.05 | 42.16 | 42.27 | 42.38 | 42.49 | 42.60 | 42.71 | 42.81 | 42.92 | 43.03 |
| — | 1.42 | 1.44 | 1.46 | 1.48 | 1.50 | 1.53 | 1.55 | 1.58 | 1.61 | 1.64 | 1.67 | 1.70 |
| #34 | 43.14 | 43.25 | 43.35 | 43.46 | 43.57 | 43.68 | 43.78 | 43.89 | 44.00 | 44.11 | 44.21 | 44.32 |
| — | 1.72 | 1.75 | 1.78 | 1.80 | 1.83 | 1.85 | 1.87 | 1.89 | 1.90 | 1.92 | 1.92 | 1.93 |
| #35 | 44.43 | 44.54 | 44.64 | 44.75 | 44.86 | 44.96 | 45.07 | 45.18 | 45.29 | 45.39 | 45.50 | 45.61 |
| — | 1.93 | 1.94 | 1.93 | 1.93 | 1.92 | 1.92 | 1.90 | 1.89 | 1.88 | 1.87 | 1.85 | 1.84 |
| #36 | 45.72 | 45.82 | 45.93 | 46.04 | 46.15 | 46.26 | 46.36 | 46.47 | 46.58 | 46.69 | 46.80 | 46.90 |
| — | 1.82 | 1.81 | 1.79 | 1.78 | 1.77 | 1.76 | 1.75 | 1.74 | 1.74 | 1.74 | 1.74 | 1.74 |
| #37 | 47.01 | 47.12 | 47.23 | 47.33 | 47.44 | 47.55 | 47.66 | 47.77 | 47.87 | 47.98 | 48.09 | 48.20 |
| — | 1.74 | 1.75 | 1.76 | 1.76 | 1.77 | 1.79 | 1.80 | 1.81 | 1.82 | 1.83 | 1.84 | 1.85 |
| #38 | 48.30 | 48.41 | 48.52 | 48.63 | 48.73 | 48.84 | 48.95 | 49.06 | 49.10 | 49.27 | 49.38 | 49.49 |
| — | 1.85 | 1.86 | 1.86 | 1.85 | 1.84 | 1.83 | 1.81 | 1.79 | 1.76 | 1.72 | 1.68 | 1.64 |
| #39 | 49.60 | 49.70 | 49.81 | 49.92 | 50.03 | 50.14 | 50.25 | 50.36 | 50.47 | 50.58 | 50.69 | 50.81 |
| — | 1.59 | 1.54 | 1.48 | 1.42 | 1.35 | 1.29 | 1.22 | 1.15 | 1.09 | 1.02 | 0.96 | 0.89 |
| #40 | 50.92 | 51.03 | 51.14 | 51.26 | 51.37 | 51.48 | 51.60 | 51.71 | 51.83 | 51.94 | 52.06 | 52.17 |
| — | 0.83 | 0.78 | 0.72 | 0.67 | 0.62 | 0.58 | 0.54 | 0.51 | 0.48 | 0.46 | 0.43 | 0.42 |
| #41 | 52.29 | 52.41 | 52.52 | 52.64 | 52.75 | 52.87 | 52.98 | 53.10 | 53.21 | 53.33 | 53.44 | 53.56 |
| — | 0.41 | 0.40 | 0.39 | 0.40 | 0.40 | 0.41 | 0.43 | 0.45 | 0.48 | 0.51 | 0.55 | 0.60 |
| #42 | 53.67 | 53.78 | 53.90 | 54.01 | 54.12 | 54.23 | 54.34 | 54.45 | 54.56 | 54.67 | 54.77 | 54.88 |
| — | 0.65 | 0.72 | 0.79 | 0.88 | 0.97 | 1.08 | 1.20 | 1.33 | 1.47 | 1.63 | 1.80 | 1.99 |
| #43 | 54.99 | 55.09 | 55.20 | 55.30 | 55.41 | 55.51 | 55.62 | 55.72 | 55.82 | 55.92 | 56.03 | 56.13 |
| — | 2.18 | 2.39 | 2.62 | 2.85 | 3.09 | 3.33 | 3.58 | 3.83 | 4.07 | 4.30 | 4.52 | 4.71 |
| #44 | 56.23 | 56.33 | 56.44 | 56.54 | 56.64 | 56.74 | 56.84 | 56.94 | 57.05 | 57.15 | 57.25 | 57.35 |
| — | 4.88 | 5.03 | 5.14 | 5.21 | 5.24 | 5.24 | 5.19 | 5.10 | 4.98 | 4.82 | 4.64 | 4.43 |
| #45 | 57.46 | 57.56 | 57.66 | 57.77 | 57.87 | 57.98 | 58.08 | 58.19 | 58.29 | 58.40 | 58.51 | 58.62 |
| — | 4.19 | 3.95 | 3.69 | 3.43 | 3.17 | 2.91 | 2.66 | 2.42 | 2.19 | 1.97 | 1.77 | 1.58 |
| #46 | 58.73 | 58.84 | 58.95 | 59.06 | 59.17 | 59.28 | 59.40 | 59.51 | 59.63 | 59.74 | 59.86 | 59.97 |
| — | 1.41 | 1.25 | 1.10 | 0.97 | 0.85 | 0.75 | 0.66 | 0.57 | 0.50 | 0.44 | 0.39 | 0.34 |
| #47 | 60.09 | 60.21 | 60.32 | 60.44 | 60.56 | 60.68 | 60.80 | 60.92 | 61.03 | 61.15 | 61.27 | 61.39 |
| — | 0.31 | 0.28 | 0.25 | 0.23 | 0.22 | 0.21 | 0.21 | 0.20 | 0.21 | 0.21 | 0.22 | 0.24 |
| #48 | 61.51 | 61.62 | 61.74 | 61.86 | 61.97 | 62.09 | 62.20 | 62.32 | 62.43 | 62.54 | 62.65 | 62.77 |
| — | 0.26 | 0.29 | 0.32 | 0.35 | 0.40 | 0.45 | 0.51 | 0.57 | 0.65 | 0.73 | 0.82 | 0.92 |
| #49 | 62.88 | 62.99 | 63.10 | 63.21 | 63.31 | 63.42 | 63.53 | 63.64 | 63.74 | 63.85 | 63.96 | 64.06 |
| — | 1.03 | 1.15 | 1.27 | 1.40 | 1.54 | 1.69 | 1.83 | 1.98 | 2.13 | 2.28 | 2.43 | 2.57 |
| #50 | 64.17 | 64.27 | 64.38 | 64.48 | 64.59 | 64.69 | 64.79 | 64.90 | 65.00 | 65.11 | 65.21 | 65.32 |
| — | 2.70 | 2.83 | 2.94 | 3.04 | 3.12 | 3.19 | 3.24 | 3.27 | 3.28 | 3.28 | 3.26 | 3.23 |
| #51 | 65.42 | 65.53 | 65.63 | 65.73 | 65.84 | 65.94 | 66.05 | 66.16 | 66.26 | 66.37 | 66.47 | 66.58 |
| — | 3.18 | 3.12 | 3.05 | 2.97 | 2.89 | 2.80 | 2.71 | 2.62 | 2.53 | 2.44 | 2.35 | 2.27 |
| #52 | 66.69 | 66.79 | 66.90 | 67.01 | 67.11 | 67.22 | 67.33 | 67.44 | 67.54 | 67.65 | 67.76 | 67.87 |
| — | 2.19 | 2.12 | 2.05 | 1.98 | 1.93 | 1.87 | 1.83 | 1.79 | 1.75 | 1.73 | 1.70 | 1.68 |
| #53 | 67.98 | 68.08 | 68.19 | 68.30 | 68.41 | 68.52 | 68.63 | 68.73 | 68.84 | 68.95 | 69.06 | 69.17 |
| — | 1.67 | 1.66 | 1.65 | 1.65 | 1.65 | 1.65 | 1.65 | 1.65 | 1.66 | 1.66 | 1.67 | 1.67 |
| #54 | 69.27 | 59.38 | 69.49 | 69.60 | 69.71 | 69.82 | 69.92 | 70.03 | 70.14 | 70.25 | 70.36 | 70.47 |
| — | 1.67 | 1.67 | 1.67 | 1.66 | 1.65 | 1.64 | 1.62 | 1.60 | 1.57 | 1.54 | 1.51 | 1.47 |
| #55 | 70.58 | 70.68 | 70.79 | 70.90 | 71.01 | 71.12 | 71.23 | 71.34 | 71.45 | 71.57 | 71.68 | 71.79 |
| — | 1.44 | 1.40 | 1.35 | 1.31 | 1.27 | 1.22 | 1.18 | 1.13 | 1.09 | 1.05 | 1.01 | 0.97 |
| #56 | 71.90 | 72.01 | 72.12 | 72.23 | 72.35 | 72.46 | 72.57 | 72.68 | 72.80 | 72.91 | 73.02 | 73.13 |
| — | 0.94 | 0.90 | 0.88 | 0.85 | 0.83 | 0.81 | 0.79 | 0.78 | 0.77 | 0.76 | 0.76 | 0.76 |
| #57 | 73.25 | 73.36 | 73.47 | 73.58 | 73.70 | 73.81 | 73.92 | 74.03 | 74.14 | 74.25 | 74.36 | 74.48 |
| — | 0.77 | 0.78 | 0.79 | 0.80 | 0.82 | 0.84 | 0.87 | 0.89 | 0.92 | 0.96 | 0.99 | 1.03 |
| #58 | 74.59 | 74.70 | 74.81 | 74.92 | 75.03 | 75.14 | 75.25 | 75.36 | 75.47 | 75.57 | 75.68 | 75.79 |
| — | 1.06 | 1.10 | 1.14 | 1.19 | 1.23 | 1.27 | 1.31 | 1.35 | 1.38 | 1.42 | 1.45 | 1.48 |
| #59 | 75.90 | 76.01 | 76.12 | 76.23 | 76.33 | 76.44 | 76.55 | 76.66 | 76.77 | 76.88 | 76.98 | 77.09 |
| — | 1.51 | 1.53 | 1.55 | 1.57 | 1.58 | 1.59 | 1.60 | 1.60 | 1.61 | 1.61 | 1.61 | 1.60 |
| #60 | 77.20 | 77.31 | 77.42 | 77.53 | 77.64 | 77.74 | 77.85 | 77.96 | 78.07 | 78.18 | 78.29 | 78.39 |
| — | 1.60 | 1.59 | 1.59 | 1.59 | 1.58 | 1.58 | 1.58 | 1.58 | 1.58 | 1.58 | 1.59 | 1.60 |

TABLE 22
Widths of the microstrip line

| | | | | | | | | | | | | |
|---|---|---|---|---|---|---|---|---|---|---|---|---|
| #61 | 78.50 | 78.61 | 78.72 | 78.83 | 78.94 | 79.04 | 79.15 | 79.26 | 79.37 | 79.47 | 79.58 | 79.69 |
| — | 1.61 | 1.62 | 1.64 | 1.66 | 1.68 | 1.70 | 1.73 | 1.76 | 1.79 | 1.82 | 1.86 | 1.89 |
| #62 | 79.80 | 79.90 | 80.01 | 80.12 | 80.22 | 80.33 | 80.44 | 80.54 | 80.65 | 80.76 | 80.86 | 80.97 |
| — | 1.93 | 1.96 | 2.00 | 2.03 | 2.06 | 2.09 | 2.12 | 2.14 | 2.16 | 2.18 | 2.19 | 2.19 |
| #63 | 81.08 | 81.18 | 81.29 | 81.40 | 81.50 | 81.61 | 81.72 | 81.82 | 81.93 | 82.04 | 82.15 | 82.25 |
| — | 2.19 | 2.19 | 2.18 | 2.17 | 2.15 | 2.12 | 2.09 | 2.06 | 2.02 | 1.99 | 1.94 | 1.90 |
| #64 | 82.36 | 82.47 | 82.58 | 82.68 | 82.79 | 82.90 | 83.01 | 83.12 | 83.23 | 83.34 | 83.44 | 83.55 |
| — | 1.86 | 1.81 | 1.76 | 1.72 | 1.67 | 1.63 | 1.59 | 1.55 | 1.51 | 1.47 | 1.44 | 1.41 |
| #65 | 83.66 | 83.77 | 83.88 | 83.99 | 84.10 | 84.21 | 84.32 | 84.43 | 84.54 | 84.65 | 84.76 | 84.87 |
| — | 1.38 | 1.35 | 1.33 | 1.31 | 1.29 | 1.28 | 1.27 | 1.26 | 1.25 | 1.25 | 1.25 | 1.25 |
| #66 | 84.98 | 85.09 | 85.20 | 85.31 | 85.42 | 85.53 | 85.64 | 85.75 | 85.86 | 85.97 | 86.08 | 86.19 |
| — | 1.25 | 1.25 | 1.25 | 1.26 | 1.27 | 1.27 | 1.28 | 1.28 | 1.29 | 1.29 | 1.29 | 1.30 |
| #67 | 86.29 | 86.40 | 86.51 | 86.62 | 86.73 | 86.84 | 86.95 | 87.06 | 87.17 | 87.28 | 87.39 | 87.50 |
| — | 1.30 | 1.30 | 1.29 | 1.29 | 1.28 | 1.28 | 1.27 | 1.26 | 1.24 | 1.23 | 1.21 | 1.20 |
| #68 | 87.61 | 87.72 | 87.83 | 87.94 | 88.05 | 88.16 | 88.27 | 88.39 | 88.50 | 88.61 | 88.72 | 88.83 |
| — | 1.18 | 1.17 | 1.15 | 1.13 | 1.12 | 1.10 | 1.09 | 1.08 | 1.07 | 1.06 | 1.05 | 1.04 |
| #69 | 88.94 | 89.05 | 89.16 | 89.27 | 89.38 | 89.49 | 89.60 | 89.71 | 89.83 | 89.94 | 90.05 | 90.16 |
| — | 1.04 | 1.04 | 1.04 | 1.04 | 1.05 | 1.05 | 1.07 | 1.08 | 1.09 | 1.11 | 1.13 | 1.16 |
| #70 | 90.27 | 90.38 | 90.49 | 90.60 | 90.71 | 90.81 | 90.92 | 91.03 | 91.14 | 91.25 | 91.36 | 91.47 |
| — | 1.18 | 1.21 | 1.24 | 1.27 | 1.30 | 1.33 | 1.36 | 1.40 | 1.43 | 1.47 | 1.50 | 1.53 |
| #71 | 91.58 | 91.69 | 91.79 | 91.90 | 92.01 | 92.12 | 92.23 | 92.33 | 92.44 | 92.55 | 92.66 | 92.77 |
| — | 1.56 | 1.59 | 1.62 | 1.65 | 1.67 | 1.69 | 1.71 | 1.72 | 1.73 | 1.74 | 1.75 | 1.75 |
| #72 | 92.87 | 92.98 | 93.09 | 93.20 | 93.30 | 93.41 | 93.52 | 93.63 | 93.74 | 93.84 | 93.95 | 94.06 |
| — | 1.75 | 1.75 | 1.75 | 1.75 | 1.74 | 1.73 | 1.72 | 1.71 | 1.71 | 1.70 | 1.69 | 1.68 |
| #73 | 94.17 | 94.28 | 94.39 | 94.49 | 94.60 | 94.71 | 94.82 | 94.93 | 95.03 | 95.14 | 95.25 | 95.36 |
| — | 1.68 | 1.67 | 1.67 | 1.66 | 1.66 | 1.67 | 1.67 | 1.67 | 1.68 | 1.69 | 1.70 | 1.71 |
| #74 | 95.47 | 95.57 | 95.68 | 95.79 | 95.90 | 96.00 | 96.11 | 96.22 | 96.33 | 96.43 | 96.54 | 96.65 |
| — | 1.73 | 1.74 | 1.76 | 1.77 | 1.79 | 1.81 | 1.82 | 1.84 | 1.86 | 1.87 | 1.88 | 1.89 |
| #75 | 96.76 | 96.86 | 96.97 | 97.08 | 97.19 | 97.29 | 97.40 | 97.51 | 97.62 | 97.72 | 97.83 | 97.94 |
| — | 1.90 | 1.91 | 1.91 | 1.91 | 1.91 | 1.90 | 1.89 | 1.88 | 1.87 | 1.85 | 1.83 | 1.80 |
| #76 | 98.05 | 98.15 | 98.26 | 98.37 | 98.48 | 98.59 | 98.70 | 98.80 | 98.91 | 99.02 | 99.13 | 99.24 |
| — | 1.77 | 1.75 | 1.71 | 1.68 | 1.65 | 1.62 | 1.58 | 1.55 | 1.51 | 1.48 | 1.45 | 1.42 |
| #77 | 99.35 | 99.46 | 99.57 | 99.68 | 99.79 | 99.90 | 100.01 | 100.12 | 100.23 | 100.34 | 100.45 | 100.56 |
| — | 1.39 | 1.36 | 1.34 | 1.31 | 1.29 | 1.27 | 1.26 | 1.24 | 1.23 | 1.22 | 1.21 | 1.21 |
| #78 | 100.67 | 100.78 | 100.89 | 101.00 | 101.11 | 101.22 | 101.33 | 101.44 | 101.55 | 101.66 | 101.76 | 101.87 |
| — | 1.20 | 1.20 | 1.20 | 1.20 | 1.21 | 1.21 | 1.22 | 1.23 | 1.23 | 1.24 | 1.25 | 1.25 |
| #79 | 101.98 | 102.09 | 102.20 | 102.31 | 102.42 | 102.53 | 102.64 | 102.75 | 102.86 | 102.97 | 103.08 | 103.19 |
| — | 1.26 | 1.27 | 1.27 | 1.28 | 1.28 | 1.28 | 1.28 | 1.28 | 1.28 | 1.28 | 1.27 | 1.27 |
| #80 | 103.30 | 103.41 | 103.52 | 103.63 | 103.74 | 103.85 | 103.96 | 104.07 | 104.18 | 104.29 | 104.40 | 104.51 |
| — | 1.26 | 1.25 | 1.24 | 1.23 | 1.22 | 1.21 | 1.20 | 1.18 | 1.17 | 1.16 | 1.15 | 1.14 |
| #81 | 104.62 | 104.73 | 104.84 | 104.95 | 105.06 | 105.17 | 105.28 | 105.39 | 105.50 | 105.61 | 105.73 | 105.84 |
| — | 1.14 | 1.13 | 1.13 | 1.12 | 1.12 | 1.12 | 1.13 | 1.13 | 1.14 | 1.15 | 1.16 | 1.17 |
| #82 | 105.95 | 106.06 | 106.17 | 106.27 | 106.38 | 106.49 | 106.60 | 106.71 | 106.82 | 106.93 | 107.04 | 107.15 |
| — | 1.19 | 1.21 | 1.23 | 1.25 | 1.27 | 1.30 | 1.33 | 1.35 | 1.38 | 1.41 | 1.44 | 1.47 |
| #83 | 107.26 | 107.37 | 107.48 | 107.58 | 107.69 | 107.80 | 107.91 | 108.02 | 108.12 | 108.23 | 108.34 | 108.45 |
| — | 1.50 | 1.53 | 1.55 | 1.58 | 1.60 | 1.62 | 1.65 | 1.66 | 1.68 | 1.69 | 1.70 | 1.71 |
| #84 | 108.56 | 108.66 | 108.77 | 108.88 | 108.99 | | | | | | | |
| — | 1.72 | 1.72 | 1.72 | 1.72 | 1.72 | | | | | | | |

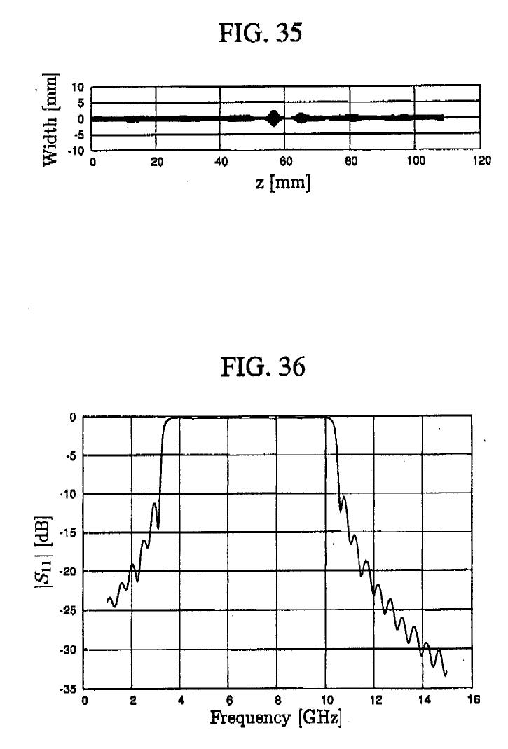

FIG. 35 shows the shape of the microstrip line 5 in the reflection-type bandpass filter 1 of the eighth embodiment. A non-reflecting terminator, or an R=30Ω resistance, is provided at the terminating side (the face at z=108.99 mm) of the reflection-type bandpass filter 1. The thickness of the metal films used in the conducting layer 3 and of the conductor constituting the microstrip line 5 should be adequately greater than the skin depth δs=√{2/(ωμ0σ)} at f=1 GHz. For example if copper is used, the thickness of the conducting layer 3 and of the conductor of the microstrip line 5 should be taken as 2.1 μm or greater. This reflection-type bandpass filter is used in a system where the characteristic impedance is 30Ω.

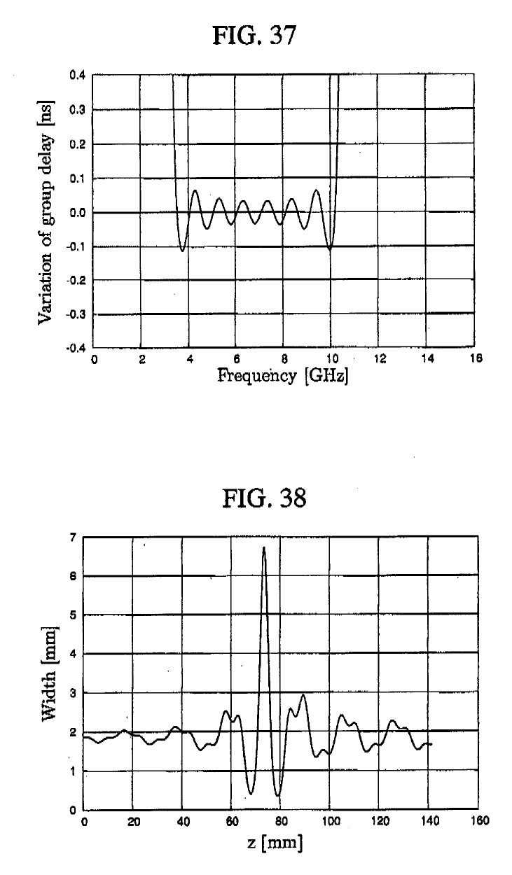

FIG. 36 and FIG. 37 express the amplitude characteristics and group delay frequency characteristics respectively of the reflective wave (S11) in the bandpass filter of the eighth embodiment. As shown in the figures, in the region of frequency f for which 3.4 GHz≦f≦10.3 GHz, the reflectivity is −0.5 dB or greater and the variation of the group delay is within ±0.1 ns. In the region f<3.1 GHz and f>10.6 GHz, the reflectivity is −10 dB or lower.

### Embodiment 9

A Kaiser window was used for which the reflectivity is 0.95 at the frequency f in the region 3.3 GHz≦f≦10.4 GHz, and is 0 elsewhere, and for which A=35. Taking one wavelength at frequency f=1 GHz of the signal transmitted within the microstrip line as the waveguide length, the system characteristic impedance was taken as 50Ω, and the design was carried out.

FIG. 38 shows the distribution of the width w of the microstrip line 5 in the z-axis direction when a dielectric layer 4 of thickness h=1.27 mm, and relative dielectric constant ∈ᵣ=6.15 (for example, RT/duroid (registered trademark) 6006) was used. Tables 23 through 25 list the widths w of the microstrip line 5.

TABLE 23
Widths of the microstrip line

| | z[mm] | | | | | | | | | | | |
|---|---|---|---|---|---|---|---|---|---|---|---|---|
| | 0.00 | 0.14 | 0.28 | 0.42 | 0.57 | 0.71 | 0.85 | 0.99 | 1.13 | 1.27 | 1.41 | 1.56 |
| | w[mm] | | | | | | | | | | | |
| | 1.87 | 1.87 | 1.87 | 1.87 | 1.87 | 1.87 | 1.87 | 1.87 | 1.87 | 1.87 | 1.87 | 1.87 |
| #2 | 1.70 | 1.84 | 1.98 | 2.12 | 2.26 | 2.41 | 2.55 | 2.69 | 2.83 | 2.97 | 3.11 | 3.25 |
| — | 1.87 | 1.86 | 1.86 | 1.86 | 1.86 | 1.86 | 1.85 | 1.85 | 1.85 | 1.84 | 1.84 | 1.83 |
| #3 | 3.40 | 3.54 | 3.68 | 3.82 | 3.96 | 4.10 | 4.25 | 4.39 | 4.53 | 4.67 | 4.81 | 4.96 |
| — | 1.83 | 1.82 | 1.82 | 1.81 | 1.80 | 1.80 | 1.79 | 1.78 | 1.78 | 1.77 | 1.76 | 1.76 |
| #4 | 5.10 | 5.24 | 5.38 | 5.52 | 5.66 | 5.81 | 5.95 | 6.09 | 6.23 | 6.37 | 6.52 | 6.66 |
| — | 1.75 | 1.75 | 1.74 | 1.74 | 1.74 | 1.73 | 1.73 | 1.73 | 1.73 | 1.73 | 1.73 | 1.73 |
| #5 | 6.80 | 6.94 | 7.08 | 7.23 | 7.37 | 7.51 | 7.65 | 7.79 | 7.93 | 8.08 | 8.22 | 8.36 |
| — | 1.74 | 1.74 | 1.74 | 1.75 | 1.75 | 1.76 | 1.76 | 1.77 | 1.78 | 1.78 | 1.79 | 1.79 |
| #6 | 8.50 | 8.64 | 8.79 | 8.93 | 9.07 | 9.21 | 9.35 | 9.49 | 9.63 | 9.78 | 9.92 | 10.06 |
| — | 1.80 | 1.81 | 1.81 | 1.82 | 1.82 | 1.83 | 1.83 | 1.84 | 1.84 | 1.84 | 1.85 | 1.85 |
| #7 | 10.20 | 10.34 | 10.48 | 10.63 | 10.77 | 10.91 | 11.05 | 11.19 | 11.33 | 11.47 | 11.62 | 11.76 |
| — | 1.85 | 1.85 | 1.85 | 1.85 | 1.85 | 1.85 | 1.85 | 1.85 | 1.85 | 1.85 | 1.85 | 1.85 |
| #8 | 11.90 | 12.04 | 12.18 | 12.32 | 12.47 | 12.61 | 12.75 | 12.89 | 13.03 | 13.17 | 13.31 | 13.46 |
| — | 1.85 | 1.86 | 1.86 | 1.86 | 1.86 | 1.86 | 1.87 | 1.87 | 1.88 | 1.88 | 1.89 | 1.89 |
| #9 | 13.60 | 13.74 | 13.88 | 14.02 | 14.16 | 14.30 | 14.44 | 14.59 | 14.73 | 14.87 | 15.01 | 15.15 |
| — | 1.90 | 1.91 | 1.92 | 1.93 | 1.93 | 1.94 | 1.95 | 1.96 | 1.97 | 1.98 | 1.99 | 1.99 |
| #10 | 15.29 | 15.43 | 15.57 | 15.71 | 15.85 | 16.00 | 16.14 | 16.28 | 16.42 | 16.56 | 16.70 | 16.84 |
| — | 2.00 | 2.01 | 2.02 | 2.02 | 2.03 | 2.03 | 2.03 | 2.04 | 2.04 | 2.04 | 2.04 | 2.04 |
| #11 | 16.98 | 17.12 | 17.26 | 17.40 | 17.55 | 17.69 | 17.83 | 17.97 | 18.11 | 18.25 | 18.39 | 18.53 |
| — | 2.03 | 2.03 | 2.03 | 2.02 | 2.02 | 2.01 | 2.00 | 2.00 | 1.99 | 1.98 | 1.97 | 1.97 |
| #12 | 18.67 | 18.82 | 18.96 | 19.10 | 19.24 | 19.38 | 19.52 | 19.66 | 19.80 | 19.95 | 20.09 | 20.23 |
| — | 1.96 | 1.95 | 1.95 | 1.94 | 1.93 | 1.93 | 1.92 | 1.92 | 1.92 | 1.91 | 1.91 | 1.91 |
| #13 | 20.37 | 20.51 | 20.65 | 20.79 | 20.94 | 21.08 | 21.22 | 21.36 | 21.50 | 21.64 | 21.78 | 21.92 |
| — | 1.91 | 1.91 | 1.90 | 1.90 | 1.90 | 1.90 | 1.90 | 1.90 | 1.90 | 1.91 | 1.91 | 1.90 |
| #14 | 22.07 | 22.21 | 22.35 | 22.49 | 22.63 | 22.77 | 22.91 | 23.06 | 23.20 | 23.34 | 23.48 | 23.62 |
| — | 1.90 | 1.90 | 1.90 | 1.90 | 1.90 | 1.89 | 1.89 | 1.88 | 1.88 | 1.87 | 1.86 | 1.85 |
| #15 | 23.76 | 23.90 | 24.05 | 24.19 | 24.33 | 24.47 | 24.61 | 24.75 | 24.90 | 25.04 | 25.18 | 25.32 |
| — | 1.85 | 1.84 | 1.83 | 1.82 | 1.81 | 1.80 | 1.78 | 1.77 | 1.76 | 1.75 | 1.74 | 1.73 |
| #16 | 25.46 | 25.61 | 25.75 | 25.89 | 26.03 | 26.17 | 26.32 | 26.46 | 26.60 | 26.74 | 26.89 | 27.03 |
| — | 1.72 | 1.71 | 1.71 | 1.70 | 1.69 | 1.69 | 1.68 | 1.68 | 1.68 | 1.68 | 1.68 | 1.68 |
| #17 | 27.17 | 27.31 | 27.45 | 27.60 | 27.74 | 27.88 | 28.02 | 28.16 | 28.31 | 28.45 | 28.59 | 28.73 |
| — | 1.68 | 1.68 | 1.68 | 1.69 | 1.69 | 1.70 | 1.70 | 1.71 | 1.72 | 1.73 | 1.73 | 1.74 |
| #18 | 28.87 | 29.02 | 29.16 | 29.30 | 29.44 | 29.58 | 29.72 | 29.87 | 30.01 | 30.15 | 30.29 | 30.43 |
| — | 1.75 | 1.75 | 1.76 | 1.77 | 1.77 | 1.78 | 1.79 | 1.79 | 1.79 | 1.80 | 1.80 | 1.80 |
| #19 | 30.57 | 30.72 | 30.86 | 31.00 | 31.14 | 31.28 | 31.43 | 31.57 | 31.71 | 31.85 | 31.99 | 32.13 |
| — | 1.80 | 1.80 | 1.80 | 1.80 | 1.80 | 1.80 | 1.80 | 1.80 | 1.80 | 1.80 | 1.80 | 1.80 |
| #20 | 32.28 | 32.42 | 32.56 | 32.70 | 32.84 | 32.98 | 33.13 | 33.27 | 33.41 | 33.55 | 33.69 | 33.83 |
| — | 1.80 | 1.80 | 1.80 | 1.81 | 1.81 | 1.81 | 1.82 | 1.83 | 1.83 | 1.84 | 1.85 | 1.86 |
| #21 | 33.97 | 34.12 | 34.26 | 34.40 | 34.54 | 34.68 | 34.82 | 34.96 | 35.10 | 35.25 | 35.39 | 35.53 |
| — | 1.87 | 1.88 | 1.90 | 1.91 | 1.93 | 1.94 | 1.96 | 1.97 | 1.99 | 2.00 | 2.02 | 2.03 |
| #22 | 35.67 | 35.81 | 35.95 | 36.09 | 36.23 | 36.37 | 35.51 | 36.65 | 36.79 | 36.93 | 37.08 | 37.22 |
| — | 2.05 | 2.06 | 2.07 | 2.09 | 2.10 | 2.11 | 2.11 | 2.12 | 2.12 | 2.13 | 2.13 | 2.13 |
| #23 | 37.36 | 37.50 | 37.64 | 37.78 | 37.92 | 38.06 | 38.20 | 38.34 | 38.48 | 38.62 | 38.76 | 38.90 |
| — | 2.13 | 2.13 | 2.12 | 2.12 | 2.11 | 2.11 | 2.10 | 2.09 | 2.08 | 2.07 | 2.06 | 2.05 |
| #24 | 39.05 | 39.19 | 39.33 | 39.47 | 39.61 | 39.75 | 39.89 | 40.03 | 40.17 | 40.31 | 40.46 | 40.60 |
| — | 2.04 | 2.03 | 2.03 | 2.02 | 2.01 | 2.00 | 2.00 | 1.99 | 1.99 | 1.98 | 1.98 | 1.98 |
| #25 | 40.74 | 40.88 | 41.02 | 41.16 | 41.30 | 41.44 | 41.58 | 41.73 | 41.87 | 42.01 | 42.15 | 42.29 |
| — | 1.98 | 1.98 | 1.98 | 1.98 | 1.98 | 1.98 | 1.98 | 1.99 | 1.99 | 1.99 | 1.99 | 1.99 |
| #26 | 42.43 | 42.57 | 42.71 | 42.85 | 43.00 | 43.14 | 43.28 | 43.42 | 43.56 | 43.70 | 43.84 | 43.98 |
| — | 1.99 | 1.99 | 1.99 | 1.99 | 1.98 | 1.98 | 1.97 | 1.96 | 1.95 | 1.94 | 1.92 | 1.91 |
| #27 | 44.13 | 44.27 | 44.41 | 44.55 | 44.69 | 44.83 | 44.97 | 45.12 | 45.26 | 45.40 | 45.54 | 45.68 |
| — | 1.89 | 1.87 | 1.86 | 1.84 | 1.82 | 1.80 | 1.78 | 1.76 | 1.73 | 1.71 | 1.69 | 1.67 |
| #28 | 45.83 | 45.97 | 46.11 | 46.25 | 46.40 | 46.54 | 46.68 | 46.82 | 46.97 | 47.11 | 47.25 | 47.39 |
| — | 1.66 | 1.64 | 1.62 | 1.61 | 1.59 | 1.58 | 1.57 | 1.56 | 1.55 | 1.55 | 1.54 | 1.54 |
| #29 | 47.54 | 47.68 | 47.82 | 47.97 | 48.11 | 48.25 | 48.39 | 48.54 | 48.68 | 48.82 | 48.96 | 49.11 |
| — | 1.54 | 1.54 | 1.54 | 1.55 | 1.55 | 1.56 | 1.57 | 1.58 | 1.59 | 1.59 | 1.60 | 1.62 |
| #30 | 49.25 | 49.39 | 49.53 | 49.67 | 49.82 | 49.96 | 50.10 | 50.24 | 50.39 | 50.53 | 50.67 | 50.81 |
| — | 1.63 | 1.64 | 1.64 | 1.65 | 1.66 | 1.67 | 1.68 | 1.68 | 1.69 | 1.69 | 1.69 | 1.69 |

TABLE 24
Widths of the microstrip line

| | | | | | | | | | | | | |
|---|---|---|---|---|---|---|---|---|---|---|---|---|
| #31 | 50.95 | 51.10 | 51.24 | 51.38 | 51.52 | 51.66 | 51.81 | 51.95 | 52.09 | 52.23 | 52.38 | 52.52 |
| — | 1.69 | 1.69 | 1.69 | 1.68 | 1.68 | 1.68 | 1.67 | 1.67 | 1.66 | 1.66 | 1.66 | 1.65 |
| #32 | 52.66 | 52.80 | 52.94 | 53.09 | 53.23 | 53.37 | 53.51 | 53.65 | 53.80 | 53.94 | 54.08 | 54.22 |
| — | 1.65 | 1.65 | 1.66 | 1.66 | 1.66 | 1.67 | 1.68 | 1.69 | 1.71 | 1.73 | 1.75 | 1.77 |
| #33 | 54.36 | 54.51 | 54.65 | 54.79 | 54.93 | 55.07 | 55.21 | 55.35 | 55.49 | 55.63 | 55.78 | 55.92 |
| — | 1.79 | 1.82 | 1.85 | 1.88 | 1.91 | 1.95 | 1.99 | 2.03 | 2.07 | 2.11 | 2.15 | 2.19 |
| #34 | 56.06 | 56.20 | 56.34 | 56.48 | 56.62 | 56.76 | 56.90 | 57.04 | 57.18 | 57.32 | 57.45 | 57.59 |
| — | 2.23 | 2.27 | 2.30 | 2.34 | 2.37 | 2.40 | 2.43 | 2.45 | 2.48 | 2.49 | 2.51 | 2.52 |
| #35 | 57.73 | 57.87 | 58.01 | 58.15 | 58.29 | 58.43 | 58.57 | 58.71 | 58.85 | 58.99 | 59.13 | 59.27 |
| — | 2.52 | 2.52 | 2.52 | 2.51 | 2.50 | 2.49 | 2.48 | 2.46 | 2.44 | 2.42 | 2.40 | 2.38 |
| #36 | 59.41 | 59.55 | 59.69 | 59.83 | 59.97 | 60.11 | 60.25 | 60.39 | 60.53 | 60.67 | 60.81 | 60.95 |
| — | 2.36 | 2.34 | 2.32 | 2.30 | 2.29 | 2.27 | 2.26 | 2.25 | 2.25 | 2.24 | 2.24 | 2.25 |
| #37 | 61.09 | 61.23 | 61.37 | 61.51 | 61.65 | 61.79 | 61.93 | 62.07 | 62.21 | 62.35 | 62.49 | 62.63 |
| — | 2.25 | 2.26 | 2.27 | 2.28 | 2.30 | 2.31 | 2.33 | 2.34 | 2.36 | 2.38 | 2.39 | 2.40 |
| #38 | 62.77 | 62.91 | 63.05 | 63.19 | 63.33 | 63.47 | 63.61 | 63.75 | 63.89 | 64.03 | 64.17 | 64.31 |
| — | 2.41 | 2.41 | 2.41 | 2.40 | 2.39 | 2.37 | 2.35 | 2.31 | 2.27 | 2.22 | 2.17 | 2.11 |
| #39 | 64.46 | 64.60 | 64.74 | 64.88 | 65.02 | 65.16 | 65.31 | 65.45 | 65.59 | 65.74 | 65.88 | 66.03 |
| — | 2.04 | 1.96 | 1.88 | 1.79 | 1.70 | 1.61 | 1.52 | 1.43 | 1.33 | 1.24 | 1.15 | 1.06 |
| #40 | 66.17 | 66.32 | 66.46 | 66.61 | 66.76 | 66.90 | 67.05 | 67.20 | 67.35 | 67.50 | 67.65 | 67.80 |
| — | 0.98 | 0.90 | 0.83 | 0.76 | 0.70 | 0.65 | 0.60 | 0.55 | 0.52 | 0.48 | 0.46 | 0.44 |
| #41 | 67.95 | 68.09 | 68.24 | 68.39 | 68.54 | 68.69 | 68.84 | 68.99 | 69.14 | 69.29 | 69.43 | 69.58 |
| — | 0.42 | 0.41 | 0.41 | 0.41 | 0.42 | 0.43 | 0.45 | 0.48 | 0.51 | 0.56 | 0.61 | 0.67 |
| #42 | 69.73 | 69.87 | 70.02 | 70.16 | 70.31 | 70.45 | 70.60 | 70.74 | 70.88 | 71.02 | 71.16 | 71.30 |
| — | 0.75 | 0.83 | 0.93 | 1.05 | 1.18 | 1.33 | 1.49 | 1.67 | 1.87 | 2.09 | 2.32 | 2.58 |
| #43 | 71.44 | 71.58 | 71.71 | 71.85 | 71.99 | 72.12 | 72.26 | 72.39 | 72.53 | 72.66 | 72.80 | 72.93 |
| — | 2.85 | 3.13 | 3.43 | 3.74 | 4.05 | 4.38 | 4.70 | 5.02 | 5.32 | 5.61 | 5.88 | 6.12 |
| #44 | 73.06 | 73.20 | 73.33 | 73.46 | 73.59 | 73.73 | 73.86 | 73.99 | 74.13 | 74.26 | 74.39 | 74.53 |
| — | 6.33 | 6.50 | 6.62 | 6.70 | 6.73 | 6.71 | 6.64 | 6.52 | 6.35 | 6.15 | 5.91 | 5.64 |
| #45 | 74.66 | 74.80 | 74.93 | 75.07 | 75.21 | 75.34 | 75.48 | 75.62 | 75.76 | 75.90 | 76.04 | 76.18 |
| — | 5.34 | 5.03 | 4.71 | 4.38 | 4.05 | 3.73 | 3.41 | 3.11 | 2.82 | 2.55 | 2.29 | 2.05 |
| #46 | 76.32 | 76.46 | 76.60 | 76.75 | 76.89 | 77.04 | 77.18 | 77.33 | 77.48 | 77.62 | 77.77 | 77.92 |
| — | 1.83 | 1.62 | 1.44 | 1.27 | 1.12 | 0.99 | 0.87 | 0.77 | 0.68 | 0.61 | 0.55 | 0.49 |
| #47 | 78.07 | 78.22 | 78.37 | 78.52 | 78.67 | 78.82 | 78.97 | 79.12 | 79.27 | 79.42 | 79.57 | 79.72 |
| — | 0.45 | 0.42 | 0.39 | 0.37 | 0.36 | 0.35 | 0.35 | 0.35 | 0.36 | 0.37 | 0.39 | 0.41 |
| #48 | 79.87 | 80.02 | 80.17 | 80.31 | 80.46 | 80.61 | 80.75 | 80.90 | 81.05 | 81.19 | 81.34 | 81.48 |
| — | 0.44 | 0.48 | 0.52 | 0.57 | 0.63 | 0.69 | 0.76 | 0.84 | 0.92 | 1.01 | 1.10 | 1.20 |
| #49 | 81.62 | 81.77 | 81.91 | 82.05 | 82.19 | 82.34 | 82.48 | 82.62 | 82.76 | 82.90 | 83.04 | 83.18 |
| — | 1.30 | 1.41 | 1.52 | 1.62 | 1.73 | 1.83 | 1.93 | 2.03 | 2.12 | 2.20 | 2.28 | 2.34 |
| #50 | 83.32 | 83.46 | 83.60 | 83.74 | 83.88 | 84.02 | 84.16 | 84.30 | 84.43 | 84.57 | 84.71 | 84.85 |
| — | 2.40 | 2.45 | 2.49 | 2.52 | 2.55 | 2.56 | 2.57 | 2.57 | 2.57 | 2.56 | 2.54 | 2.53 |
| #51 | 84.99 | 85.13 | 85.27 | 85.41 | 85.55 | 85.69 | 85.83 | 85.97 | 86.11 | 86.25 | 86.39 | 86.53 |
| — | 2.51 | 2.49 | 2.47 | 2.45 | 2.43 | 2.41 | 2.40 | 2.39 | 2.38 | 2.38 | 2.38 | 2.39 |
| #52 | 86.67 | 86.81 | 86.95 | 87.09 | 87.23 | 87.37 | 87.51 | 87.65 | 87.79 | 87.93 | 88.07 | 88.20 |
| — | 2.39 | 2.41 | 2.43 | 2.45 | 2.47 | 2.50 | 2.54 | 2.57 | 2.61 | 2.64 | 2.68 | 2.72 |
| #53 | 88.34 | 88.48 | 88.62 | 88.76 | 88.90 | 89.04 | 89.18 | 89.31 | 89.45 | 89.59 | 89.73 | 89.87 |
| — | 2.76 | 2.79 | 2.83 | 2.85 | 2.88 | 2.90 | 2.91 | 2.92 | 2.92 | 2.92 | 2.90 | 2.88 |
| #54 | 90.01 | 90.15 | 90.28 | 90.42 | 90.56 | 90.70 | 90.84 | 90.98 | 91.12 | 91.26 | 91.40 | 91.54 |
| — | 2.86 | 2.82 | 2.78 | 2.73 | 2.68 | 2.62 | 2.55 | 2.49 | 2.42 | 2.34 | 2.27 | 2.20 |
| #55 | 91.68 | 91.82 | 91.96 | 92.11 | 92.25 | 92.39 | 92.53 | 92.67 | 92.82 | 92.96 | 93.10 | 93.24 |
| — | 2.12 | 2.05 | 1.98 | 1.91 | 1.84 | 1.78 | 1.72 | 1.67 | 1.61 | 1.57 | 1.52 | 1.49 |
| #56 | 93.39 | 93.53 | 93.67 | 93.82 | 93.96 | 94.10 | 94.25 | 94.39 | 94.53 | 94.68 | 94.82 | 94.96 |
| — | 1.45 | 1.42 | 1.40 | 1.38 | 1.36 | 1.35 | 1.34 | 1.34 | 1.33 | 1.34 | 1.34 | 1.35 |
| #57 | 95.11 | 95.25 | 95.39 | 95.54 | 95.68 | 95.82 | 95.97 | 96.11 | 96.25 | 96.40 | 96.54 | 96.68 |
| — | 1.36 | 1.37 | 1.38 | 1.39 | 1.41 | 1.42 | 1.44 | 1.45 | 1.47 | 1.48 | 1.49 | 1.50 |
| #58 | 96.82 | 96.97 | 97.11 | 97.25 | 97.40 | 97.54 | 97.68 | 97.82 | 97.97 | 98.11 | 98.25 | 98.40 |
| — | 1.51 | 1.52 | 1.52 | 1.53 | 1.53 | 1.53 | 1.52 | 1.52 | 1.51 | 1.51 | 1.50 | 1.49 |
| #59 | 98.54 | 98.68 | 98.82 | 98.97 | 99.11 | 99.25 | 99.40 | 99.54 | 99.68 | 99.83 | 99.97 | 100.11 |
| — | 1.48 | 1.47 | 1.46 | 1.45 | 1.44 | 1.43 | 1.42 | 1.42 | 1.42 | 1.42 | 1.42 | 1.42 |
| #60 | 100.26 | 100.40 | 100.54 | 100.68 | 100.83 | 100.97 | 101.11 | 101.26 | 101.40 | 101.54 | 101.68 | 101.82 |
| — | 1.43 | 1.44 | 1.45 | 1.46 | 1.48 | 1.50 | 1.53 | 1.56 | 1.59 | 1.62 | 1.66 | 1.69 |

TABLE 25
Widths of the microstrip line

| | | | | | | | | | | | | |
|---|---|---|---|---|---|---|---|---|---|---|---|---|
| #61 | 101.97 | 102.11 | 102.25 | 102.39 | 102.53 | 102.67 | 102.81 | 102.96 | 103.10 | 103.24 | 103.38 | 103.52 |
| — | 1.73 | 1.78 | 1.82 | 1.87 | 1.91 | 1.96 | 2.00 | 2.05 | 2.09 | 2.14 | 2.18 | 2.22 |
| #62 | 103.66 | 103.80 | 103.94 | 104.08 | 104.22 | 104.36 | 104.50 | 104.64 | 104.78 | 104.92 | 105.06 | 105.20 |
| — | 2.25 | 2.29 | 2.32 | 2.34 | 2.37 | 2.38 | 2.40 | 2.41 | 2.41 | 2.42 | 2.41 | 2.41 |
| #63 | 105.34 | 105.48 | 105.62 | 105.76 | 105.90 | 106.04 | 106.18 | 106.32 | 106.46 | 106.60 | 106.74 | 106.88 |
| — | 2.40 | 2.39 | 2.38 | 2.36 | 2.35 | 2.33 | 2.31 | 2.29 | 2.27 | 2.26 | 2.24 | 2.22 |
| #64 | 107.02 | 107.16 | 107.30 | 107.44 | 107.58 | 107.72 | 107.86 | 108.00 | 108.14 | 108.28 | 108.42 | 108.56 |
| — | 2.21 | 2.19 | 2.18 | 2.17 | 2.16 | 2.16 | 2.15 | 2.15 | 2.15 | 2.15 | 2.15 | 2.16 |
| #65 | 108.71 | 108.85 | 108.99 | 109.13 | 109.27 | 109.41 | 109.55 | 109.69 | 109.83 | 109.97 | 110.11 | 110.25 |
| — | 2.16 | 2.17 | 2.17 | 2.18 | 2.19 | 2.20 | 2.20 | 2.21 | 2.21 | 2.21 | 2.22 | 2.21 |
| #66 | 110.39 | 110.53 | 110.67 | 110.81 | 110.95 | 111.09 | 111.23 | 111.37 | 111.51 | 111.66 | 111.80 | 111.94 |
| — | 2.21 | 2.21 | 2.20 | 2.19 | 2.17 | 2.16 | 2.14 | 2.12 | 2.09 | 2.07 | 2.04 | 2.01 |
| #67 | 112.08 | 112.22 | 112.36 | 112.50 | 112.64 | 112.79 | 112.93 | 113.07 | 113.21 | 113.35 | 113.50 | 113.64 |
| — | 1.98 | 1.94 | 1.91 | 1.87 | 1.84 | 1.81 | 1.77 | 1.74 | 1.71 | 1.68 | 1.65 | 1.62 |
| #68 | 113.78 | 113.92 | 114.07 | 114.21 | 114.35 | 114.49 | 114.64 | 114.78 | 114.92 | 115.07 | 115.21 | 115.35 |
| — | 1.60 | 1.57 | 1.55 | 1.53 | 1.52 | 1.50 | 1.49 | 1.48 | 1.48 | 1.47 | 1.47 | 1.47 |
| #69 | 115.49 | 115.64 | 115.78 | 115.92 | 116.07 | 116.21 | 116.35 | 116.49 | 116.64 | 116.78 | 116.92 | 117.06 |
| — | 1.47 | 1.48 | 1.49 | 1.49 | 1.50 | 1.51 | 1.53 | 1.54 | 1.55 | 1.56 | 1.58 | 1.59 |
| #70 | 117.21 | 117.35 | 117.49 | 117.63 | 117.78 | 117.92 | 118.06 | 118.20 | 118.34 | 118.49 | 118.63 | 118.77 |
| — | 1.60 | 1.61 | 1.63 | 1.64 | 1.64 | 1.65 | 1.66 | 1.66 | 1.67 | 1.67 | 1.67 | 1.67 |
| #71 | 118.91 | 119.06 | 119.20 | 119.34 | 119.48 | 119.62 | 119.77 | 119.91 | 120.05 | 120.19 | 120.34 | 120.48 |
| — | 1.67 | 1.67 | 1.67 | 1.66 | 1.66 | 1.65 | 1.65 | 1.65 | 1.64 | 1.64 | 1.64 | 1.64 |
| #72 | 120.62 | 120.76 | 120.90 | 121.05 | 121.19 | 121.33 | 121.47 | 121.62 | 121.76 | 121.90 | 122.04 | 122.18 |
| — | 1.64 | 1.64 | 1.64 | 1.65 | 1.66 | 1.66 | 1.68 | 1.69 | 1.70 | 1.72 | 1.74 | 1.76 |
| #73 | 122.33 | 122.47 | 122.61 | 122.75 | 122.89 | 123.03 | 123.17 | 123.32 | 123.46 | 123.60 | 123.74 | 123.88 |
| — | 1.78 | 1.81 | 1.83 | 1.86 | 1.89 | 1.92 | 1.94 | 1.97 | 2.00 | 2.03 | 2.06 | 2.09 |
| #74 | 124.02 | 124.16 | 124.30 | 124.44 | 124.58 | 124.72 | 124.86 | 125.00 | 125.14 | 125.28 | 125.42 | 125.56 |
| — | 2.12 | 2.14 | 2.17 | 2.19 | 2.21 | 2.23 | 2.24 | 2.26 | 2.27 | 2.27 | 2.28 | 2.28 |
| #75 | 125.70 | 125.84 | 125.98 | 126.12 | 126.26 | 126.40 | 126.54 | 126.68 | 126.83 | 126.97 | 127.11 | 127.25 |
| — | 2.28 | 2.28 | 2.27 | 2.26 | 2.26 | 2.24 | 2.23 | 2.22 | 2.20 | 2.19 | 2.18 | 2.16 |
| #76 | 127.39 | 127.53 | 127.67 | 127.81 | 127.95 | 128.09 | 128.23 | 128.37 | 128.51 | 128.65 | 128.79 | 128.94 |
| — | 2.15 | 2.13 | 2.12 | 2.11 | 2.09 | 2.08 | 2.07 | 2.07 | 2.06 | 2.06 | 2.05 | 2.05 |
| #77 | 129.08 | 129.22 | 129.36 | 129.50 | 129.64 | 129.78 | 129.92 | 130.06 | 130.20 | 130.34 | 130.49 | 130.63 |
| — | 2.05 | 2.05 | 2.05 | 2.05 | 2.06 | 2.06 | 2.06 | 2.07 | 2.07 | 2.07 | 2.08 | 2.08 |
| #78 | 130.77 | 130.91 | 131.05 | 131.19 | 131.33 | 131.47 | 131.61 | 131.75 | 131.89 | 132.03 | 132.18 | 132.32 |
| — | 2.08 | 2.08 | 2.08 | 2.07 | 2.07 | 2.06 | 2.05 | 2.04 | 2.03 | 2.01 | 2.00 | 1.98 |
| #79 | 132.46 | 132.60 | 132.74 | 132.88 | 133.02 | 133.16 | 133.31 | 133.45 | 133.59 | 133.73 | 133.87 | 134.02 |
| — | 1.96 | 1.94 | 1.92 | 1.89 | 1.87 | 1.84 | 1.82 | 1.79 | 1.77 | 1.74 | 1.72 | 1.69 |
| #80 | 134.16 | 134.30 | 134.44 | 134.58 | 134.73 | 134.87 | 135.01 | 135.16 | 135.30 | 135.44 | 135.58 | 135.73 |
| — | 1.67 | 1.65 | 1.63 | 1.61 | 1.59 | 1.58 | 1.57 | 1.55 | 1.54 | 1.54 | 1.53 | 1.53 |
| #81 | 135.87 | 136.01 | 136.15 | 136.30 | 136.44 | 136.58 | 136.72 | 136.87 | 137.01 | 137.15 | 137.29 | 137.44 |
| — | 1.53 | 1.53 | 1.53 | 1.53 | 1.54 | 1.54 | 1.55 | 1.56 | 1.57 | 1.58 | 1.59 | 1.60 |
| #82 | 137.58 | 137.72 | 137.86 | 138.01 | 138.15 | 138.29 | 138.43 | 138.58 | 138.72 | 138.86 | 139.00 | 139.14 |
| — | 1.61 | 1.62 | 1.64 | 1.65 | 1.65 | 1.66 | 1.67 | 1.68 | 1.68 | 1.69 | 1.69 | 1.69 |
| #83 | 139.29 | 139.43 | 139.57 | 139.71 | 139.85 | 140.00 | 140.14 | 140.28 | 140.42 | 140.57 | 140.71 | 140.85 |
| — | 1.69 | 1.69 | 1.69 | 1.68 | 1.68 | 1.68 | 1.67 | 1.67 | 1.66 | 1.66 | 1.66 | 1.65 |
| #84 | 140.99 | 141.13 | 141.28 | 141.42 | 141.56 | | | | | | | |
| — | 1.65 | 1.65 | 1.65 | 1.65 | 1.66 | | | | | | | |

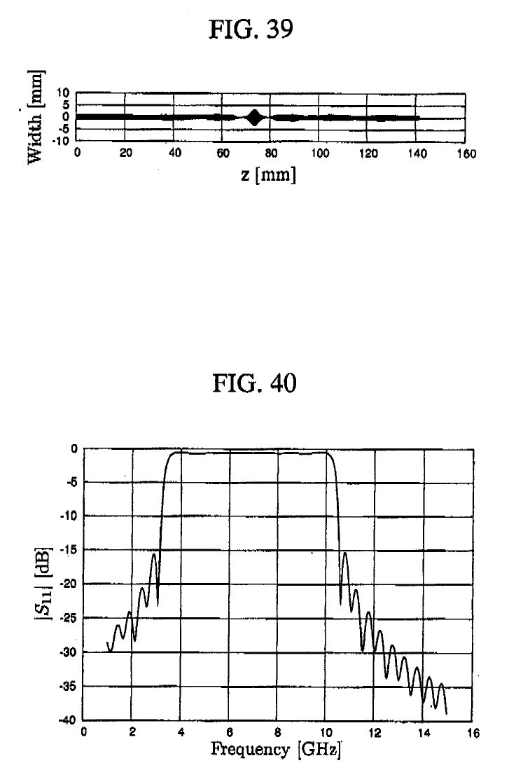

FIG. 39 shows the shape of the microstrip line 5 in the reflection-type bandpass filter 1 of the ninth embodiment. A non-reflecting terminator, or an R=50Ω resistance, is provided at the terminating side (the face at z=141.56 mm) of the reflection-type bandpass filter 1. The thickness of the metal films used in the conducting layer 3 and of the conductor constituting the microstrip line 5 should be adequately greater than the skin depth δs=√{2/(ωμ0σ)} at f=1 GHz. For example if copper is used, the thickness of the conducting layer 3 and of the conductor of the microstrip line 5 should be taken as 2.1 μm or greater. This reflection-type bandpass filter is used in a system where the characteristic impedance is 50Ω.

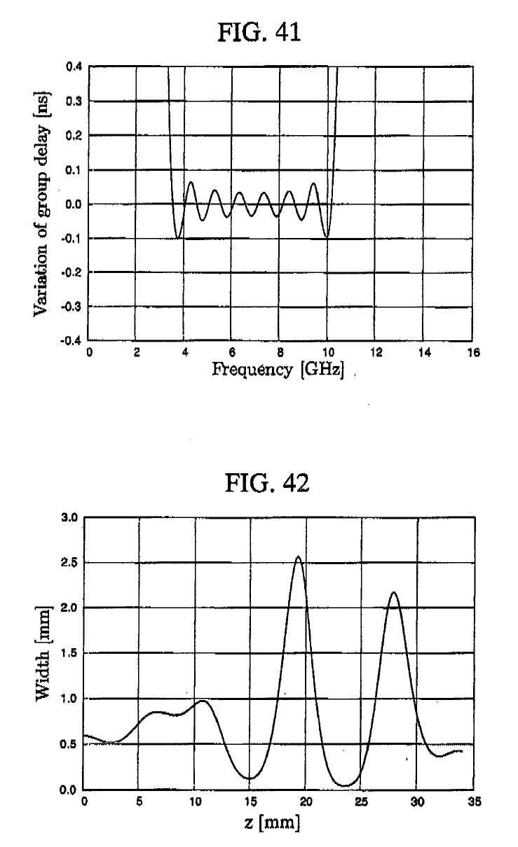

FIG. 40 and FIG. 41 express the amplitude characteristics and group delay frequency characteristics respectively of the reflective wave (S11) in the bandpass filter of the ninth embodiment. As shown in the figures, in the region of frequency f for which 3.6 GHz≦f≦10.1 GHz, the reflectivity is −1 dB or greater and the variation of the group delay is within ±0.1 ns. In the region f<3.1 GHz and f>10.6 GHz, the reflectivity is −15 dB or lower.

### Embodiment 10

A Kaiser window was used for which the reflectivity is 1 at the frequency f in the region 3.6 GHz≦f≦10.1 GHz, and is 0 elsewhere, and for which A=35. Taking one wavelength at frequency f=1 GHz of the signal transmitted within the microstrip line as the waveguide length, the system characteristic impedance was taken as 50Ω, and the design was carried out.

FIG. 42 shows the distribution of the width w of the microstrip line 5 in the z-axis direction when a dielectric layer 4 of thickness h=0.635 mm, and relative dielectric constant ∈ᵣ=0.2 (for example, RT/duroid (registered trademark) 6010LM) was used. Table 26 lists the widths w of the microstrip line 5.

TABLE 26
Widths of the microstrip line

| | z[mm] | | | | | | | | | | | |
|---|---|---|---|---|---|---|---|---|---|---|---|---|
| | 0.00 | 0.11 | 0.23 | 0.34 | 0.46 | 0.57 | 0.68 | 0.80 | 0.91 | 1.03 | 1.14 | 1.25 |
| | w[mm] | | | | | | | | | | | |
| | 0.60 | 0.59 | 0.59 | 0.59 | 0.59 | 0.58 | 0.58 | 0.57 | 0.57 | 0.57 | 0.56 | 0.56 |
| #2 | 1.37 | 1.48 | 1.60 | 1.71 | 1.83 | 1.94 | 2.05 | 2.17 | 2.28 | 2.40 | 2.51 | 2.63 |
| — | 0.55 | 0.55 | 0.54 | 0.54 | 0.53 | 0.53 | 0.52 | 0.52 | 0.52 | 0.52 | 0.52 | 0.52 |
| #3 | 2.74 | 2.86 | 2.97 | 3.08 | 3.20 | 3.31 | 3.43 | 3.54 | 3.66 | 3.77 | 3.88 | 4.00 |
| — | 0.52 | 0.52 | 0.52 | 0.53 | 0.53 | 0.54 | 0.55 | 0.55 | 0.56 | 0.57 | 0.58 | 0.60 |
| #4 | 4.11 | 4.22 | 4.34 | 4.45 | 4.56 | 4.68 | 4.79 | 4.90 | 5.02 | 5.13 | 5.24 | 5.35 |
| — | 0.61 | 0.62 | 0.64 | 0.65 | 0.66 | 0.68 | 0.70 | 0.71 | 0.73 | 0.74 | 0.76 | 0.77 |
| #5 | 5.47 | 5.58 | 5.69 | 5.80 | 5.92 | 6.03 | 6.14 | 6.25 | 6.36 | 6.48 | 6.59 | 6.70 |
| — | 0.78 | 0.79 | 0.81 | 0.82 | 0.83 | 0.83 | 0.84 | 0.84 | 0.85 | 0.85 | 0.85 | 0.85 |
| #6 | 6.81 | 6.92 | 7.04 | 7.15 | 7.26 | 7.37 | 7.48 | 7.60 | 7.71 | 7.82 | 7.93 | 8.04 |
| — | 0.85 | 0.85 | 0.85 | 0.85 | 0.84 | 0.84 | 0.83 | 0.83 | 0.83 | 0.82 | 0.82 | 0.82 |
| #7 | 8.16 | 8.27 | 8.38 | 8.49 | 8.61 | 8.72 | 8.83 | 8.94 | 9.05 | 9.17 | 9.28 | 9.39 |
| — | 0.82 | 0.82 | 0.82 | 0.82 | 0.82 | 0.82 | 0.83 | 0.83 | 0.84 | 0.85 | 0.86 | 0.87 |
| #8 | 9.50 | 9.61 | 9.72 | 9.84 | 9.95 | 10.06 | 10.17 | 10.28 | 10.39 | 10.50 | 10.62 | 10.73 |
| — | 0.88 | 0.89 | 0.90 | 0.91 | 0.92 | 0.93 | 0.95 | 0.95 | 0.96 | 0.97 | 0.97 | 0.98 |
| #9 | 10.84 | 10.95 | 11.06 | 11.17 | 11.28 | 11.39 | 11.51 | 11.62 | 11.73 | 11.84 | 11.95 | 12.07 |
| — | 0.97 | 0.97 | 0.96 | 0.96 | 0.94 | 0.93 | 0.91 | 0.88 | 0.86 | 0.83 | 0.79 | 0.76 |
| #10 | 12.18 | 12.29 | 12.41 | 12.52 | 12.63 | 12.75 | 12.86 | 12.98 | 13.09 | 13.21 | 13.33 | 13.44 |
| — | 0.72 | 0.68 | 0.64 | 0.60 | 0.56 | 0.52 | 0.48 | 0.44 | 0.41 | 0.37 | 0.34 | 0.31 |
| #11 | 13.56 | 13.68 | 13.80 | 13.91 | 14.03 | 14.15 | 14.27 | 14.39 | 14.51 | 14.63 | 14.75 | 14.87 |
| — | 0.28 | 0.25 | 0.23 | 0.21 | 0.19 | 0.17 | 0.16 | 0.15 | 0.14 | 0.13 | 0.13 | 0.13 |
| #12 | 14.99 | 15.11 | 15.23 | 15.35 | 15.47 | 15.59 | 15.71 | 15.83 | 15.95 | 16.07 | 16.18 | 16.30 |
| — | 0.12 | 0.12 | 0.13 | 0.13 | 0.14 | 0.15 | 0.16 | 0.18 | 0.19 | 0.22 | 0.24 | 0.28 |
| #13 | 16.42 | 16.53 | 16.65 | 16.76 | 16.88 | 16.99 | 17.11 | 17.22 | 17.33 | 17.44 | 17.55 | 17.66 |
| — | 0.31 | 0.36 | 0.41 | 0.46 | 0.53 | 0.60 | 0.67 | 0.76 | 0.85 | 0.95 | 1.06 | 1.17 |
| #14 | 17.77 | 17.88 | 17.99 | 18.10 | 18.21 | 18.31 | 18.42 | 18.53 | 18.63 | 18.74 | 18.85 | 18.95 |
| — | 1.28 | 1.41 | 1.53 | 1.66 | 1.78 | 1.91 | 2.02 | 2.14 | 2.24 | 2.34 | 2.42 | 2.48 |
| #15 | 19.06 | 19.16 | 19.27 | 19.37 | 19.48 | 19.59 | 19.69 | 19.80 | 19.90 | 20.01 | 20.12 | 20.23 |
| — | 2.53 | 2.56 | 2.57 | 2.55 | 2.52 | 2.47 | 2.41 | 2.32 | 2.22 | 2.11 | 1.99 | 1.87 |
| #16 | 20.33 | 20.44 | 20.55 | 20.66 | 20.77 | 20.88 | 20.99 | 21.10 | 21.22 | 21.33 | 21.44 | 21.56 |
| — | 1.74 | 1.60 | 1.47 | 1.34 | 1.21 | 1.08 | 0.96 | 0.85 | 0.75 | 0.65 | 0.56 | 0.48 |
| #17 | 21.67 | 21.79 | 21.91 | 22.03 | 22.14 | 22.26 | 22.38 | 22.50 | 22.62 | 22.75 | 22.87 | 22.99 |
| — | 0.41 | 0.35 | 0.29 | 0.24 | 0.20 | 0.17 | 0.14 | 0.12 | 0.10 | 0.09 | 0.07 | 0.06 |
| #18 | 23.11 | 23.23 | 23.36 | 23.48 | 23.60 | 23.72 | 23.85 | 23.97 | 24.09 | 24.21 | 24.33 | 24.46 |
| — | 0.06 | 0.05 | 0.05 | 0.05 | 0.05 | 0.05 | 0.05 | 0.05 | 0.06 | 0.06 | 0.07 | 0.08 |
| #19 | 24.58 | 24.70 | 24.82 | 24.94 | 25.05 | 25.17 | 25.29 | 25.41 | 25.52 | 25.64 | 25.75 | 25.87 |
| — | 0.10 | 0.11 | 0.14 | 0.16 | 0.19 | 0.23 | 0.28 | 0.33 | 0.38 | 0.45 | 0.52 | 0.60 |
| #20 | 25.98 | 26.09 | 26.20 | 26.31 | 26.42 | 26.53 | 26.64 | 26.75 | 26.86 | 26.97 | 27.08 | 27.19 |
| — | 0.69 | 0.78 | 0.88 | 0.98 | 1.09 | 1.20 | 1.31 | 1.42 | 1.53 | 1.64 | 1.74 | 1.83 |
| #21 | 27.29 | 27.40 | 27.51 | 27.61 | 27.72 | 27.83 | 27.93 | 28.04 | 28.15 | 28.25 | 28.36 | 28.47 |
| — | 1.92 | 2.00 | 2.06 | 2.11 | 2.14 | 2.16 | 2.17 | 2.16 | 2.14 | 2.10 | 2.05 | 1.99 |
| #22 | 28.57 | 28.68 | 28.79 | 28.90 | 29.01 | 29.12 | 29.22 | 29.33 | 29.44 | 29.55 | 29.67 | 29.78 |
| — | 1.92 | 1.84 | 1.76 | 1.67 | 1.58 | 1.49 | 1.40 | 1.31 | 1.22 | 1.13 | 1.05 | 0.98 |
| #23 | 29.89 | 30.00 | 30.11 | 30.23 | 30.34 | 30.45 | 30.57 | 30.68 | 30.80 | 30.91 | 31.03 | 31.14 |
| — | 0.90 | 0.84 | 0.78 | 0.72 | 0.67 | 0.62 | 0.58 | 0.54 | 0.51 | 0.48 | 0.46 | 0.43 |
| #24 | 31.26 | 31.37 | 31.49 | 31.60 | 31.72 | 31.84 | 31.95 | 32.07 | 32.18 | 32.30 | 32.42 | 32.53 |
| — | 0.42 | 0.40 | 0.39 | 0.38 | 0.38 | 0.37 | 0.37 | 0.37 | 0.37 | 0.38 | 0.38 | 0.39 |
| #25 | 32.65 | 32.76 | 32.88 | 32.99 | 33.11 | 33.23 | 33.34 | 33.46 | 33.57 | 33.69 | 33.80 | 33.92 |
| — | 0.39 | 0.40 | 0.40 | 0.41 | 0.42 | 0.42 | 0.43 | 0.43 | 0.43 | 0.43 | 0.43 | 0.43 |
| #26 | 34.03 | | | | | | | | | | | |
| — | 0.42 | | | | | | | | | | | |

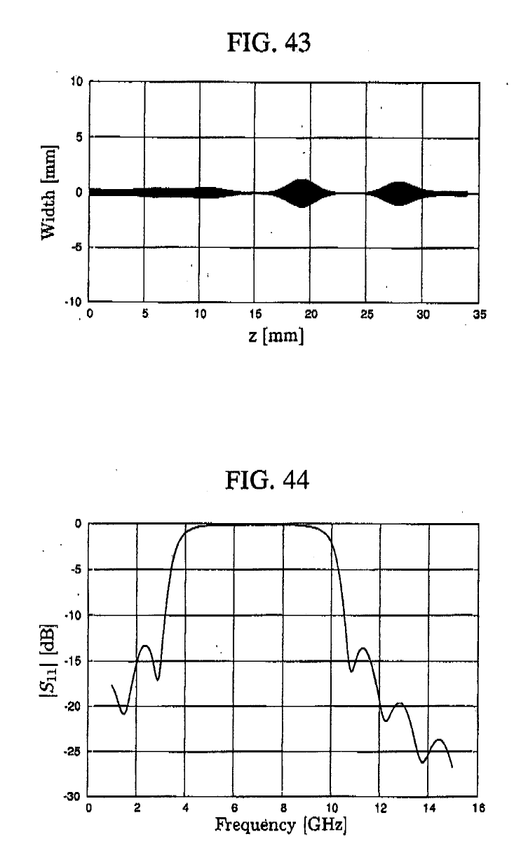

FIG. 43 shows the shape of the microstrip line 5 in the reflection-type bandpass filter 1 of the tenth embodiment. A non-reflecting terminator, or an R=50Ω resistance, is provided at the terminating side (the face at z=34.03 mm) of the reflection-type bandpass filter 1. The thickness of the metal films used in the conducting layer 3 and of the conductor constituting the microstrip line 5 should be adequately greater than the skin depth δs=√{2/(ωμ0σ)} at f=1 GHz. For example if copper is used, the thickness of the conducting layer 3 and of the conductor of the microstrip line 5 should be taken as 2.1 μm or greater. This reflection-type bandpass filter is used in a system where the characteristic impedance is 50Ω.

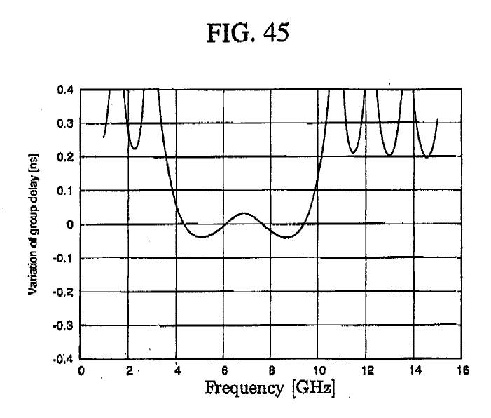

FIG. 44 and FIG. 45 express the amplitude characteristics and group delay frequency characteristics respectively of the reflective wave (S11) in the bandpass filter of the tenth embodiment. As shown in the figures, in the region of frequency f for which 3.9 GHz≦f≦9.8 GHz, the reflectivity is −2 dB or greater and the variation of the group delay is within ±0.15 ns. In the region f<3.1 GHz and f>10.6 GHz, the reflectivity is −13 dB or lower.

Exemplary embodiments related to the present invention have been described above; however, the present invention is not restricted to the examples given herein. Additions to the configuration, omissions, replacements and other changes may be effected to the present invention without departing from the spirit and scope of the present invention. It is to be understood that the present invention is not to be limited to the explanations given above, but is limited only by the scope of the appended claims and their legal equivalents.

What is claimed is:

1. A reflection-type bandpass filter for ultra-wideband radio data communications, the reflection-type bandpass filter comprising:
a substrate formed by laminating a conducting layer and a dielectric layer; and
a microstrip line comprising a conductor of a non-uniform width and provided on the dielectric layer, wherein
a width distribution of the microstrip line in a lengthwise direction is set such that an absolute value of a difference in reflectivity at a frequency f in regions f<3.1 GHz and f>10.6 GHz and a reflectivity in a region 3.7 GHz≦f≦10.0 GHz is not less than 10 dB, and a variation of a group delay in the region 3.7 GHz≦f≦10.0 GHz is between −0.2 ns and 0.2 ns.

2. A reflection-type bandpass filter for ultra-wideband radio data communications, the reflection-type bandpass filter comprising:
a substrate formed by laminating a conducting layer and a dielectric layer; and
a microstrip line comprising a conductor of a non-uniform width and provided on the dielectric layer, wherein
a width distribution of the microstrip line in a lengthwise direction is set such that an absolute value of a difference in reflectivity at a frequency f in regions f<3.1 GHz and f>10.6 GHz and a reflectivity in a region 4.0 GHz≦f≦9.8 GHz is not less than 10 dB, and a variation of a group delay in the region 4.0 GHz≦f≦9.8 GHz is between −0.1 ns and 0.1 ns.

3. A reflection-type bandpass filter for ultra-wideband radio data communications, the reflection-type bandpass filter comprising:
a substrate formed by laminating a conducting layer and a dielectric layer; and
a microstrip line comprising a conductor of a non-uniform width and provided on the dielectric layer, wherein
a width distribution of the microstrip line in a lengthwise direction is set such that an absolute value of a difference in reflectivity at a frequency f in regions f<3.1 GHz and f>10.6 GHz and a reflectivity in a region 3.5 GHz≦f≦10.1 GHz is not less than 10 dB, and a variation of a group delay in the region 3.5 GHz≦f≦10.1 GHz is between −0.2 ns and 0.2 ns.

4. A reflection-type bandpass filter for ultra-wideband radio data communications, the reflection-type bandpass filter comprising:
a substrate formed by laminating a conducting layer and a dielectric layer; and
a microstrip line comprising a conductor of a non-uniform width and provided on the dielectric layer, wherein
a width distribution of the microstrip line in a lengthwise direction is set such that an absolute value of a difference in reflectivity at a frequency f in regions f<3.1 GHz and f>10.6 GHz and a reflectivity in a region 4.0 GHz≦f≦9.6 GHz is not less than 10 dB, and a variation of a group delay in the region 4.0 GHz≦f≦9.6 GHz is between −0.07 ns and 0.07 ns.

5. A reflection-type bandpass filter for ultra-wideband radio data communications, the reflection-type bandpass filter comprising:
a substrate formed by laminating a conducting layer and a dielectric layer; and
a microstrip line comprising a conductor of a non-uniform width and provided on the dielectric layer, wherein
a width distribution of the microstrip line in a lengthwise direction is set such that an absolute value of a difference in reflectivity at a frequency f in regions f<3.1 GHz and f>10.6 GHz and a reflectivity in a region 4.2 GHz≦f≦9.5 GHz is not less than 10 dB, and a variation of a group delay in the region 4.2 GHz≦f≦9.5 GHz is between −0.2 ns and 0.2 ns.

6. The reflection-type bandpass filter according to claim 1, wherein a characteristic impedance of an input terminal transmission line is not less than 10Ω and not greater than 200Ω.

7. The reflection-type bandpass filter according to claim 6, wherein a resistance having the same impedance as the characteristic impedance, or a non-reflecting terminator, is provided on a terminating side.

8. The reflection-type bandpass filter according to claim 1, wherein the conducting layer of the substrate and the conductor of the microstrip line are made of a metal plate of a thickness not less than a skin depth at a frequency f of 1 GHz.

9. The reflection-type bandpass filter according to claim 1, wherein the dielectric layer of the substrate has a thickness that is not less than 0.5 mm and not greater than 5 mm, a relative dielectric constant that is not less than 1 and not greater than 200, a width that is not less than 2 mm and not greater than 100 mm, and a length that is not less than 2 mm and not greater than 300 mm.

10. The reflection-type bandpass filter according to claim 1, wherein the width distribution of the microstrip line is set using a design method based on an inverse problem leading to a potential from spectral data in the Zakharov-Shabat equation.

11. The reflection-type bandpass filter according to claim 1, wherein the width distribution of the microstrip line is set using a window function method.

12. The reflection-type bandpass filter according to claim 1, wherein the width distribution of the microstrip line is set using a Kaiser window function method.
